(19) United States
(12) Patent Application Publication
(10) Pub. No.: US 2023/0047569 A1
(43) Pub. Date: Feb. 16, 2023

(54) PESTICIDAL COMPLEX COMPOSITIONS FOR SYNERGISTIC DELIVERY OF PESTICIDAL ACTIVE INGREDIENTS AND METHODS OF SELECTION THEREOF

(71) Applicant: 0903608 B.C. Ltd., Vancouver (CA)

(72) Inventors: Annett ROZEK, Vancouver (CA); Sadegh SHOKATIAN, Vancouver (CA); Karan MANHAS, Vancouver (CA); Vinod PARMAR, Vancouver (CA)

(21) Appl. No.: 17/789,486

(22) PCT Filed: Dec. 21, 2020
(86) PCT No.: PCT/CA2020/051783

§ 371 Date: Jun. 27, 2022

Related U.S. Application Data
(60) Provisional application No. 63/104,394, filed on Oct. 22, 2020.
(60) Provisional application No. 62/956,108, filed on Dec. 31, 2019.

(51) Int. Cl. A01N 37/06; A01N 37/02; A01N 37/36; A01N 37/44

(52) U.S. Cl. CPC A01N 37/06; A01N 37/02; A01N 37/36; A01N 37/44

(57) ABSTRACT

Compositions and methods for increasing the efficacy of pesticidal compositions are described herein, including synergistic pesticidal complex compositions and methods for delivery of pesticidal active ingredients. Some pesticidal compositions and methods as described are directed to compositions and methods for increasing the efficacy of fungicides. Some pesticidal compositions and methods as described are directed to compositions and methods for increasing the efficacy of nematicides. Some pesticidal compositions and methods as described are directed to compositions and methods for increasing the efficacy of insecticides. Methods for enhancing the activity pesticidal active ingredients in pesticidal complex compositions in use are also described.

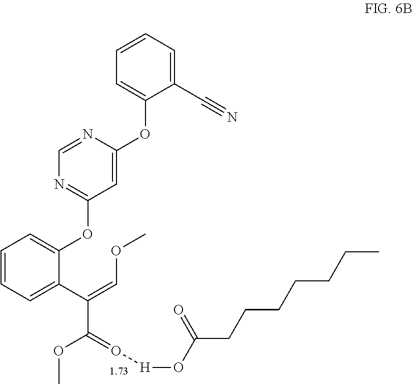

### CROSS-REFERENCE TO RELATED APPLICATIONS

This application claims priority to and the benefit of United States provisional application No. 62/956,108 filed 31 Dec. 2019 and 63/104,394 filed 22 Oct. 2020, both of which are incorporated by reference herein in their entireties.

### TECHNICAL FIELD

An embodiment of the present invention is related to compositions and methods for increasing the efficacy of pesticidal compositions. More particularly, some embodiments are related to pesticidal complex compositions for synergistic delivery of pesticidal active ingredients, and methods for selection of such synergistic pesticidal complex compositions. Some embodiments of the present invention are directed to compositions and methods for increasing the efficacy of fungicides. Some embodiments of the present invention are directed to compositions and methods for increasing the efficacy of nematicides. Some embodiments of the present invention are directed to compositions and methods for increasing the efficacy of insecticides. Further embodiments of the present invention are directed to methods for enhancing the activity of pesticidal active ingredients in synergistic pesticidal complex compositions.

### BACKGROUND

Pesticides, including fungicides, herbicides, nematicides and insecticides, are important compositions for use in domestic, agricultural, industrial and commercial settings, such as to provide for control of unwanted pests and/or pathogens. Providing for effective pest control is of high importance in many such settings, since pests and/or other pathogens if not controlled can cause loss and or destruction of crops or other plants, or harm to animals, humans or other beneficial or desired organisms. There remains a need for environmentally safe and effective pesticides, including fungicides, nematicides and insecticides, or compounds that enhance the efficacy of pesticides, including fungicides, nematicides and insecticides, and for methods of enhancing the efficacy of pesticides including fungicides, nematicides and insecticides, so that pesticides can be used in a more environmentally safe and effective manner.

In agricultural settings, for example, a variety of plant pests, such as insects, worms, nematodes, fungi, and plant pathogens such as viruses and bacteria, are known to cause significant damage to seeds and ornamental and crop plants. Chemical pesticides have generally been used, but many of these are expensive and potentially toxic to humans, animals, and/or the environment and may persist long after they are applied. Therefore it is typically beneficial to farmers, consumers and the surrounding environment to use the least amount of chemical pesticides as possible, while continuing to control pest growth in order to maximize crop yield. In a growing number of cases, chemical pesticide use has also resulted in growing resistance to certain chemical pesticides by pest organisms, leading to reduced effectiveness, requiring greater doses of pesticidal chemicals, or even failure of certain types of pesticides as viable control agents. As a result, many chemical pesticides are being phased out or otherwise restricted from use.

Natural or biologically-derived pesticidal compounds have been proposed for use in place of some chemical pesticides, in order to attempt to reduce the toxicity, health and environmental risks associated with chemical pesticide use. However, some natural or biologically-derived pesticides have proven less efficacious or consistent in their performance in comparison with competing chemical pesticides, which has limited their adoption as control agents in pesticide markets.

Therefore, there remains a need to provide improved pesticides and pesticidal compositions to allow for effective, economical and environmentally and ecologically safe control of insect, plant, fungal, nematode, mollusk, mite, viral and bacterial pests. In particular, there remains a need to provide for pesticidal compositions that desirably minimize the amount of pesticidal agents or pesticidal active ingredients required to obtain desired or acceptable levels of control of pests in use.

Accordingly, there remains a need to provide synergistic pesticidal compositions that desirably minimize the use of pesticidal agents or pesticidal active ingredients through synergistic efficacy, to provide for desired pest control performance in use. However, large-scale experimental drug combination studies in non-agricultural fields have found that synergistic combinations of drug pairs are extremely complex and rare, with only a 4-10% probability of finding synergistic drug pairs [Yin et al., PLOS 9: e93960 (2014); Cokol et al., Mol. Systems Biol. 7:544 (2011)]. In fact, a systematic screening of about 120,000 two-component drug combinations based on reference-listed drugs found fewer than 10% synergistic pairs, as well as only 5% synergistic two-component pairs for fluconazole, a triazole fungicidal compound related to certain azole agricultural fungicide compounds [Borisy et al., Proc. Natl Acad. Sci. 100:7977-7982 (2003)].

The foregoing examples of the related art and limitations related thereto are intended to be illustrative and not exclusive. Other limitations of the related art will become apparent to those of skill in the art upon consideration of the present disclosure.

### BRIEF SUMMARY

In one embodiment according to the present disclosure, a pesticidal composition comprising a synergistic pesticidal complex is provided, the complex comprising a pesticidal active ingredient; and a C4-C10 unsaturated aliphatic acid (including an unsaturated C6, C7, C8, C9 or C10 aliphatic acid) or an agriculturally compatible salt thereof, wherein the aliphatic acid is adapted to form a hydrogen bond with the pesticidal active ingredient to form a synergistic pesticidal complex. In one embodiment, the C4-C10 unsaturated aliphatic acid comprises at least one unsaturated C—C bond and wherein a ratio of the concentrations by weight of said pesticidal active ingredient and said C4-C10 unsaturated aliphatic acid or an agriculturally compatible salt thereof is between about 1:15,000 and 15,000:1, and more particularly between about 1:5000 and 5000:1, and further more particularly between about 1:2000 and 2000:1. In another embodiment, a synergistic pesticidal composition is provided, comprising a synergistic pesticidal complex comprising a pesticidal active ingredient; and a C4-C10 saturated aliphatic acid (including a saturated C4, C5, C6, C7, C8, C9 or C10 aliphatic acid) or an agriculturally compatible salt thereof, wherein a ratio of the concentrations by weight of said pesticidal active ingredient and said C4-C10 saturated aliphatic acid or an agriculturally compatible salt thereof is between about 1:15,000 and 15,000:1, and more particularly between about 1:5000 and 5000:1, and further particularly between about 1:2000 and 2000:1.

In another embodiment, a pesticidal composition comprising a pesticidal complex is provided, said complex comprising: a pesticidal active ingredient; and a C4-C10 saturated or unsaturated aliphatic acid or an agriculturally compatible salt thereof, wherein a hydrogen bond exists between the pesticidal active ingredient and the C4-C10 saturated or unsaturated aliphatic acid to form the complex; and wherein a ratio of the concentrations of said pesticidal active ingredient and said C4-C10 saturated or unsaturated aliphatic acid or an agriculturally compatible salt thereof is between about 1:15000 and 15000:1.

In one such embodiment, the pesticidal composition comprises a synergistic pesticidal composition, and the pesticidal complex comprises a synergistic pesticidal complex. In some embodiments, the pesticidal active ingredient comprises a strobilurin fungicide, and the hydrogen bond exists between a carboxyl group of the aliphatic acid, and a carbonyl group of the strobilurin fungicide. In other embodiments, the pesticidal active ingredient comprises an azole fungicide, and the hydrogen bond exists between the carboxyl group of the aliphatic acid, and a carbonyl or hydroxy group of the azole fungicide.

In further embodiments, the pesticidal active ingredient comprises a pyrrole insecticide, and the hydrogen bond exists between a carboxyl group of the aliphatic acid, and a N atom of the pyrrole insecticide. In further embodiments, the pesticidal active ingredient comprises a diamide insecticide, and the hydrogen bond exists between a carboxyl group of the aliphatic acid and at least one of: an O atom and an amine H atom of the diamide insecticide. In further embodiments, the pesticidal active ingredient comprises a synthase inhibitor, and the hydrogen bond exists between a carboxyl group of the aliphatic acid and at least one of: an O atom and a hydroxyl group of the synthase inhibitor.

In further embodiments the pesticidal active ingredient comprises a spinosyn insecticide, and the hydrogen bond exists between a carboxyl group of the aliphatic acid, and at least one of an O and an N atom of the spinosyn insecticide. In some embodiments, the pesticidal active ingredient comprises least one nicotinic acetylcholine receptor disruptor or allosteric modulator, and in some such embodiments, the at least one nicotinic acetylcholine receptor disruptor or allosteric modulator comprises at least one of: a spinosyn and derivatives or substituents thereof, spinosad, a tetracyclic substituted spinosyn, a pentacyclic substituted spinosyn, an aziridine spinosyn derivative, a C-5,6 substituted spinosyn, a C-13,14 substituted spinosyn, a spinetoram, a butenyl-spinosyn, an isolate from Saccharopolyspora spinosa culture, and an isolate from Saccharopolyspora pogona culture.

In some embodiments, the synergistic pesticidal composition comprising the synergistic pesticidal complex has an FIC Index value of less than 1; or preferably less than 0.75, or more preferably less than 0.5, or in other embodiments has a synergistic efficacy factor, according to the Colby formula, of at least 1.1.

In another embodiment according to the present disclosure, a pesticidal composition comprising a synergistic pesticidal complex is provided, said complex comprising: one or more pesticidal agents; and one or more saturated or unsaturated C4-C10 aliphatic acids or agriculturally compatible salts thereof which is adapted to form a hydrogen bond with said at least one pesticidal agent to form the synergistic pesticidal complex, wherein said synergistic pesticidal complex produces a synergistic effect on the pesticidal activity of the pesticidal composition in comparison to the pesticidal activity of the pesticidal agent alone and are present in a respective synergistically active concentration ratio between about 1:15000 and 15000:1.

In a further embodiment, a method of synergistically enhancing the pesticidal activity of at least one pesticidal active ingredient adapted to control at least one target pest organism is provided, comprising: providing at least one pesticidal active ingredient active for said at least one target pest organism, selecting a synergistically effective concentration of at least one C4-C10 saturated or unsaturated aliphatic acid, or an agriculturally acceptable salt thereof, which is adapted to form a hydrogen bond with said at least one pesticidal active ingredient to form a synergistic pesticidal complex; preparing a synergistic pesticidal composition comprising said synergistic pesticidal complex; and applying said synergistic pesticidal composition in a pesticidally effective concentration to control said at least one target pest organism.

In a further embodiment, a method of synergistically enhancing the pesticidal activity of at least one pesticidal active ingredient adapted to control at least one target pest organism is provided, comprising: providing at least one pesticidal active ingredient active for said at least one target pest organism; adding a synergistically effective concentration of at least one C4-C10 unsaturated aliphatic acid comprising at least one unsaturated C—C bond, or an agriculturally acceptable salt thereof, to said pesticidal active ingredient to provide a synergistic pesticidal composition; and applying said synergistic pesticidal composition in a pesticidally effective concentration to control said at least one target pest organism. In another embodiment, instead of a C4-C10 unsaturated aliphatic acid, a C4-C10 saturated aliphatic acid or agriculturally compatible salts thereof may be provided to provide the synergistic pesticidal composition. In yet another embodiment, a C11 unsaturated or saturated aliphatic acid or agriculturally compatible salts thereof may be provided to provide the synergistic pesticidal composition. In yet a further embodiment, a C12 unsaturated or saturated aliphatic acid or agriculturally compatible salts thereof may be provided to provide the synergistic pesticidal composition. In some embodiments, the synergistic pesticidal composition may comprise a C4-C10 unsaturated or saturated aliphatic acid or a biologically compatible salt thereof, wherein said salt comprises at least one of an agriculturally, aquatic life, or mammal-compatible salt, for example. In other embodiments, a C11 unsaturated or saturated aliphatic acid or biologically compatible salt thereof, or a C12 unsaturated or saturated aliphatic acid or biologically compatible salt may be provided.

In another embodiment according to the present disclosure, a pesticidal composition is provided, comprising: one or more pesticidal agents; and one or more unsaturated C4-C10 aliphatic acids or agriculturally compatible salts thereof having at least one unsaturated C—C bond. In some other embodiments, a pesticidal composition comprising one or more pesticidal agents at one or more saturated C4-C10 aliphatic acids or agriculturally compatible salts thereof are provided. In some embodiments, the one or more saturated or unsaturated C4-C10 aliphatic acids produce a synergistic effect on the pesticidal activity of the pesticidal composition in comparison to the pesticidal activity of the pesticidal agent alone and are present in a respective synergistically active concentration ratio between about 1:15000 and 15000:1, more particularly between about 1:5000 and 5000:1, and further particularly between about 1:2000 and 2000:1. In some such embodiments, a C11 unsaturated or saturated aliphatic acid or agriculturally compatible salts thereof may be provided. In some further such embodiments, a C12 unsaturated or saturated aliphatic acid or agriculturally compatible salts thereof may be provided.

In a further embodiment, a method of synergistically enhancing the pesticidal activity of at least one pesticidal active ingredient adapted to control at least one target pest organism is provided, comprising: providing at least one pesticidal active ingredient active for said at least one target pest organism; adding a synergistically effective concentration of at least one unsaturated or saturated C4-C10 aliphatic acid or an agriculturally acceptable salt thereof to provide a synergistic pesticidal composition; mixing said synergistic pesticidal composition with at least one formulation component comprising a surfactant to form a synergistic pesticidal concentrate; diluting said synergistic pesticidal concentrate with water to form a synergistic pesticidal emulsion; and applying said synergistic pesticidal emulsion at a pesticidally effective concentration and rate to control said at least one target pest organism. In some such embodiments, a C11 unsaturated or saturated aliphatic acid or agriculturally compatible salt thereof may be provided. In some further such embodiments, a C12 unsaturated or saturated aliphatic acid or agriculturally compatible salt thereof may be provided.

In some embodiments, the synergistic pesticidal composition may comprise a ratio of the concentrations by weight of said pesticidal active ingredient and said at least one saturated or unsaturated C4-C10 aliphatic acid or agriculturally compatible salts thereof is between about at least one of: 1:20,000 and 20,000:1, 1:15000 and 15000:1, 1:10,000 and 10,000:1, 1:5000 and 5000:1, 1:2500 and 2500:1, 1:2000 and 2000:1, 1:1500 and 1500:1, 1:1000 and 1000:1, 1:750 and 750:1, 1:500 and 500:1, 1:400 and 400:1, 1:300 and 300:1, 1:250 and 250:1, 1:200 and 200:1, 1:150 and 150:1, 1:100 and 100:1, 1:90 and 90:1, 1:80 and 80:1, 1:70 and 70:1, 1:60 and 60:1, 1:50 and 50:1, 1:40 and 40:1, 1:30 and 30:1, 1:25 and 25:1, 1:20 and 20:1, 1:15 and 15:1, 1:10 and 10:1, 1:9 and 9:1, 1:8 and 8:1, 1:7 and 7:1, 1:6 and 6:1, 1:5 and 5:1, 1:4 and 4:1, 1:3 and 3:1, 1:2 and 2:1, 1:1.5 and 1.5:1, and 1.25 and 1.25:1. In a particular such embodiment, the concentration ratios of the pesticidal active ingredient and said at least one C4-C10 saturated or unsaturated aliphatic acid or an agriculturally compatible salt thereof in the synergistic pesticidal composition are advantageously chosen so as to produce a synergistic effect against at least one target pest or pathogen. In some embodiments, the concentration ratios of the pesticidal active ingredient(s) and at least one C11 unsaturated or saturated aliphatic acid or agriculturally compatible salts thereof in the synergistic pesticidal composition may be advantageously chosen so as to produce a synergistic effect against at least one target pest or pathogen. In some further embodiments, the concentration ratios of the pesticidal active ingredient(s) and at least one C11 unsaturated or saturated aliphatic acid or agriculturally compatible salt thereof in the synergistic pesticidal composition may be advantageously chosen so as to produce a synergistic effect against at least one target pest or pathogen.

In some embodiments, the synergistic pesticidal composition comprises a pesticidal active ingredient, and a C4-C10 unsaturated aliphatic acid which comprises at least one of: a trans-unsaturated C—C bond and a cis-unsaturated C—C bond. In a further such embodiment, the C4-C10 unsaturated aliphatic acid comprises at least one of: a trans-2, trans-3, trans-4, trans-5, trans-6, trans-7, trans-8, and trans-9 unsaturated bond. In yet another embodiment, a synergistic pesticidal composition is provided comprising a pesticidal active ingredient and a C4-C10 unsaturated aliphatic acid comprising at least one of: a cis-2, cis-3, cis-4, cis-5, cis-6, cis-7, cis-8, and cis-9 unsaturated bond. In some such embodiments, the pesticidal composition comprises a C11 unsaturated aliphatic acid or agriculturally compatible salt thereof, comprising at least one of: a trans-2, trans-3, trans-4, trans-5, trans-6, trans-7, trans-8, trans-9, trans-10, a cis-2, cis-3, cis-4, cis-5, cis-6, cis-7, cis-8, cis-9, and cis-10 unsaturated bond. In some further such embodiments, the pesticidal composition comprises a C12 unsaturated aliphatic acid or agriculturally compatible salt thereof, comprising at least one of: a trans-2, trans-3, trans-4, trans-5, trans-6, trans-7, trans-8, trans-9, trans-10, trans-11, a cis-2, cis-3, cis-4, cis-5, cis-6, cis-7, cis-8, cis-9, cis-10, and cis-11 unsaturated bond. In some embodiments, the synergistic pesticidal composition may comprise at least one C4-C10 saturated aliphatic acid, such as one or more of hexanoic, heptanoic, octanoic, nonanoic and decanoic acid, for example. In some further embodiments, the synergistic pesticidal composition may additionally comprise at least one second C4-C10 saturated or unsaturated aliphatic acid. In some further embodiments, the pesticidal composition may additionally comprise at least one second C11 or C12 unsaturated or saturated aliphatic acid, or agriculturally compatible salt thereof.

In some embodiments, the at least one C4-C10 saturated or unsaturated aliphatic acid may comprise a naturally occurring aliphatic acid, such as may be present in, or extracted, fractionated or derived from a natural plant or animal material, for example. In one such embodiment, the at least one C4-C10 saturated or unsaturated aliphatic acid may comprise one or more naturally occurring aliphatic acids provided in a plant extract or fraction thereof. In another such embodiment, the at least one C4-C10 saturated or unsaturated aliphatic acid may comprise one or more naturally occurring aliphatic acids provided in an animal extract or product, or fraction thereof. In one such embodiment, the at least one C4-C10 saturated or unsaturated alphatic acid may comprise a naturally occurring aliphatic acid comprised in a plant oil extract, such as one or more of coconut oil, palm oil, palm kernel oil, corn oil, or fractions or extracts therefrom. In another such embodiment, the at least one C4-C10 saturated or unsaturated aliphatic acid may comprise a naturally occurring aliphatic acid comprised in an animal extract or product, such as one or more of cow's milk, goat's milk, beef tallow, and/or cow or goat butter, or fractions or extracts thereof for example. In a particular embodiment, at least one C4-C10 saturated aliphatic acid may be provided in an extract or fraction of one or more plant oil extract, such as one or more of coconut oil, palm oil, palm kernel oil, corn oil, or fractions or extracts therefrom. In some further embodiments, the pesticidal composition may comprise at least one C11 or C12 saturated or unsaturated aliphatic acid provided in an extract or fraction of one or more plant or animal materials.

In some embodiments, the synergistic pesticidal composition exhibits a synergistic inhibition of growth of at least one target pest organism. In some embodiments, the synergistic pesticidal composition comprises a pesticidally effective concentration of the pesticidal active ingredient, and the one or more C4-C10 saturated or unsaturated aliphatic acid. In some further embodiments, the synergistic pesticidal composition comprises a pesticidal active ingredient, and a synergistic concentration of the one or more C4-C10 saturated or unsaturated aliphatic acid. In some embodiments, the synergistic pesticidal composition has a FIC Index (fractional inhibitory concentration index value) of less than 1 according to a growth inhibition assay for inhibition of growth of at least one target pest or pathogen organism. In some embodiments, the synergistic pesticidal composition has a FIC Index value of less than 0.75. In a further embodiment, the synergistic pesticidal composition has a FIC Index value of 0.5 or less. In some embodiments, the synergistic pesticidal composition has a synergistic efficacy factor, or Synergy Factor (comparing synergistic efficacy relative to expected additive (non-synergistic) efficacy according to the Colby Formula, or Loewe's Formula, or other accepted synergy determination method) of: at least 1.01, and more particularly at least 1.1, and further more particularly at least 1.5, and yet further more particularly at least 2, and more particularly at least 5, and yet more particularly at least 10, for example.

In some such embodiments, the one or more saturated or unsaturated aliphatic acid may comprise a C11 unsaturated or saturated aliphatic acid or agriculturally compatible salt thereof. In some further such embodiments, the one or more saturated or unsaturated aliphatic acid may comprise a C12 unsaturated or saturated aliphatic acid or agriculturally compatible salt thereof.

In some embodiments, the pesticidal active ingredient may comprise at least one of a chemical pesticide and a naturally-derived pesticidal oil or extract. In a further aspect, the pesticidal active ingredient may comprise at least one of: a fungicide, nematicide, insecticide, acaricide, herbicide, and bactericide.

In any such embodiments, the synergistic pesticidal composition may comprise one or more C4-C10 saturated or unsaturated aliphatic acid having at least one carboxylic group, and which may be linear or branched. In some embodiments, the one or more C4-C10 saturated or unsaturated aliphatic acid may comprise a linear monocarboxylic acid. In some embodiments, the C4-C10 unsaturated aliphatic acid may comprise one or more of cis and trans isomers. In an embodiment, the one or more C4-C10 saturated or unsaturated aliphatic acid may be unsubstituted or substituted. In some embodiments, the one or more C4-C10 saturated or unsaturated aliphatic acid may comprise a substituent, such as a hydroxy, amino, carbonyl, aldehyde, acetyl, phosphate, or methyl substituent, for example. In one such embodiment, the one or more C4-C10 saturated or unsaturated aliphatic acid may comprise at least one of a 2-, 3-, 4-, 8-, or 10-substituted aliphatic acid. In one such embodiment, the one or more C4-C10 saturated or unsaturated aliphatic acid may comprise a hydroxy aliphatic acid. In one particular such embodiment, the one or more C4-C10 saturated or unsaturated aliphatic acid may comprise a 2-hydroxy, 3-hydroxy, or 4-hydroxy aliphatic acid. In one embodiment, the one or more C4-C10 saturated or unsaturated aliphatic acid may comprise an amino aliphatic acid. In one particular such embodiment, the one or more C4-C10 saturated or unsaturated aliphatic acid may comprise a 3-amino aliphatic acid. In a further embodiment, the one or more C4-C10 saturated or unsaturated aliphatic acid may comprise a methyl and/or ethyl substituted aliphatic acid. In a particular such embodiment, the one or more C4-C10 saturated or unsaturated aliphatic acid may comprise at least one of a 2-methyl, 3-methyl, 4-methyl, 2-ethyl, or 2,2-diethyl substituted aliphatic acid, for example. In some embodiments, the one or more C4-C10 saturated or unsaturated aliphatic acid may comprise an unsaturated aliphatic acid which may be mono-unsaturated or polyunsaturated, i.e. containing one, two or more unsaturated carbon-carbon (C—C) bonds respectively. In some embodiments, the one or more C4-C10 saturated or unsaturated aliphatic acid may comprise an unsaturated aliphatic acid with at least one of: a trans-unsaturated C—C bond, a cis-unsaturated C—C bond, and a plurality of conjugated unsaturated C—C bonds. In some such embodiments, the one or more saturated or unsaturated aliphatic acid may comprise a C11 unsaturated or saturated aliphatic acid. In some further such embodiments, the one or more saturated or unsaturated aliphatic acid may comprise a C12 unsaturated or saturated aliphatic acid.

In some further embodiments, the one or more C4-C10 (including C4, C5, C6, C7, C8, C9 or C10) saturated or unsaturated aliphatic acid may comprise at least one of: a trans-hexenoic acid, a cis-hexenoic acid, a hexa-dienoic acid, a hexynoic acid, a trans-heptenoic acid, a cis-heptenoic acid, a hepta-dienoic acid, a heptynoic acid, a trans-octenoic acid, a cis-octenoic acid, an octa-dienoic acid, an octynoic acid, a trans-nonenoic acid, a cis-nonenoic acid, a nona-dienoic acid, a nonynoic acid, a trans-decenoic acid, a cis-decenoic acid, a deca-dienoic acid, and a decynoic acid. In another embodiment, the one or more C4-C10 saturated or unsaturated aliphatic acid may comprise at least one of: a trans-hexenoic acid, a cis-hexenoic acid, a hexa-dienoic acid other than 2,4-hexadienoic acid, a hexynoic acid, a trans-heptenoic acid, a cis-heptenoic acid, a hepta-dienoic acid, a heptynoic acid, a trans-octenoic acid, a cis-octenoic acid, an octa-dienoic acid, an octynoic acid, a trans-nonenoic acid, a cis-nonenoic acid, a nona-dienoic acid, a nonynoic acid, a trans-decenoic acid, a cis-decenoic acid, a deca-dienoic acid, and a decynoic acid. In some embodiments, the one or more unsaturated aliphatic acid may comprise at least one of a C11 or C12 unsaturated aliphatic acid, such as a cis-undecenoic, trans-undecanoic, cis-dodecenoic, trans-dodecenoic, undeca-dienoic, dodeca-dienoic, undecynoic, or dodecynoic acid, for example.

In some further embodiments, the one or more C4-C10 (including C4, C5, C6, C7, C8, C9 or C10) saturated or unsaturated aliphatic acid may comprise at least one of: hexanoic, heptanoic, octanoic, nonanoic and decanoic acid. In some embodiments, the one or more saturated or unsaturated aliphatic acid may comprise at least one of undecanoic or dodecanoic acid.

In some embodiments, the synergistic pesticidal composition may comprise one or more agriculturally compatible or acceptable salts of a one or more C4-C10 saturated or unsaturated aliphatic acid. In one such embodiment, such agriculturally compatible or acceptable salts may comprise one or more of potassium, sodium, calcium, aluminum, other suitable metal salts, ammonium, and other agriculturally acceptable salts of one or more C4-C10 saturated or unsaturated aliphatic acids, for example. In another embodiment, the synergistic pesticidal composition may comprise one or more C4-C10 saturated or unsaturated aliphatic acid or a biologically compatible salt thereof, wherein said salt comprises at least one of an agriculturally, aquatic life, or mammal-compatible salt, for example. In some embodiments, the pesticidal composition may comprise one or more agriculturally compatible or acceptable salts of one or one or more C11 or C12 saturated or unsaturated aliphatic acid.

However, in some other embodiments, the synergistic pesticidal composition may comprise a pesticidal active ingredient and a one or more C4-C10 saturated or unsaturated aliphatic acid, wherein the C4-C10 unsaturated aliphatic acid comprises at least one unsaturated C—C bond and wherein a ratio of the concentrations of said pesticidal active ingredient and said C4-C10 unsaturated aliphatic acid is between about 1:15000 and 15000:1, more particularly between about 1:5000 and 5000:1, and further particularly between about 1:2000 and 2000:1. In one such embodiment, the one or more C4-C10 saturated or unsaturated aliphatic acid may exclude agriculturally acceptable salts or other salt forms of the one or more C4-C10 saturated or unsaturated aliphatic acids. In a particular such embodiment, the synergistic pesticidal composition may exclude such salts for desired applications for which the acid forms of the one or more C4-C10 saturated or unsaturated aliphatic acids may be preferred. In one such application, it is known that accumulation of an undesirably high concentration of salts in some soils can be detrimental to the productivity or fertility of the soil, such as in particular salt sensitive soil applications, for example.

Accordingly, in some embodiments, specifically excluding salt forms of the one or more C4-C10 saturated or unsaturated aliphatic acids may be particularly desirable. In some such embodiments, the pesticidal composition may comprise one or more C11 or C12 saturated or unsaturated aliphatic acid.

In another embodiment, the synergistic pesticidal composition may comprise a pesticidal active ingredient and at least one C4-C10 saturated aliphatic acid, such as at least one of hexanoic, heptanoic, octanoic, nonanoic and decanoic acid, for example. In an alternative embodiment, the synergistic pesticidal composition may comprise a pesticidal active ingredient and at least one C4-C10 unsaturated aliphatic acid but explicitly excluding 2,4-hexadienoic acid. In some such embodiments, the one or more saturated or unsaturated aliphatic acid may comprise a C11 unsaturated or saturated aliphatic acid. In some further such embodiments, the one or more saturated or unsaturated aliphatic acid may comprise a C12 unsaturated or saturated aliphatic acid.

In some embodiments of the present disclosure, a synergistic pesticidal complex composition may comprise at least one C4-C10 saturated or unsaturated aliphatic acid and at least one pesticidal active ingredient selected from the list comprising:
A) Respiration inhibitors selected from:
   inhibitors of complex III at Qₒ site: azoxystrobin (11-1), coumethoxy-strobin, coumoxystrobin, dimoxystrobin (II-2), enestroburin, fenamin-strobin, fenoxystrobin/flufenoxystrobin, fluoxastrobin (11-3), kresoxim-methyl (II-4), metominostrobin, orysastrobin (II-5), picoxystrobin (11-6), pyraclostrobin (II-7), pyrame-tostrobin, pyraoxystrobin, trifloxystrobin (II-8), 2-[2-(2,5-dimethyl-phenoxymethyl)-phenyl]-3-methoxy-acrylic acid methyl ester and 2-(2-(3-(2,6-dichlorophenyl)-1-methyl-allylideneamino-oxymethyl)-phenyl)-2-methoxyimino-N-methyl-acetamide, pyribencarb, triclopyricarb/chlorodincarb, famoxadone, fenamidone;
   Inhibitors of complex III at Qᵢ site: cyazofamid, amisulbrom, [(3S,6S,7R,8R)-8-benzyl-3-[(3-acetoxy-4-methoxy-pyridine-2-carbonyl)-amino]-6-methyl-4,9-dioxo-1,5-dioxonan-7-yl] 2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl] 2-methylpropanoate, [(3S,6S,7R,8R)-8-benzyl-3-[(3-isobutoxycarbony-loxy-4-methoxy-pyridine-2-carbonyl)amino]-6-methyl-4,9-dioxo-1,5-dioxonan-7-yl] 2-methylpro-panoate, [(3S,6S,7R,8R)-8-benzyl-3-[[3-(1,3-benzodioxol5-ylmethoxy)-4-methoxy-pyridine-2-carbon-yl]amino]-6-methyl-4,9-dioxo1,5-dioxonan-7-yl] 2-methylpropanoate; (3S,6S,7R,8R)-3-[[(3-hydroxy-4-methoxy-2-pyridinyl)carbonyl]amino]-6-methyl-4,9-dioxo-8-(phenyl-methyl)-1,5-dioxonan-7-yl 2-methylpropanoate;
   Inhibitors of complex II: benodanil, benzovindiflupyr (11-9), bixafen (11-10), boscalid (II-11), carboxin, fenfuram, fluopyram (II-12), flutolanil, fluxapyroxad (II-13), furametpyr, isofetamid, isopyrazam (II-14), mepronil, oxycarboxin, penflufen (II-15), penthiopyrad (11-16), sedaxane (11-17), tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, 3-(difluorome-thyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 1,3,5-trimethyl-N-(1,1,3-trimethylindan-4-yl)pyrazole-4-carboxamide, N-(7-fluoro-1,1,3-trimethyl-indan-4-yl)-1,3-dimethyl-pyrazole-4-carboxamide, N-[2-(2,4-dichlorophenyl)-2-methoxy-1-methyl-ethyl]-3-(difluoromethyl)-1-methyl-pyrazole-4-carboxamide; Other respiration inhibitors: diflumetorim, (5,8-difluoroquinazolin-4-yl)-{2-[2-fluoro-4-(4-trifluorometh-ylpyridin-2-yloxy)-phenyl]-ethyl}-amine; binapacryl, dinobuton, dinocap, fluazinam (II-18); ferimzone; fentin salts such as fentin-acetate, fentin chloride or fentin hydroxide; ametoctradin (II-19); and silthiofam;
B) Sterol biosynthesis inhibitors (SBI fungicides) selected from:
   C14 demethylase inhibitors (DMI fungicides): azaconazole, bitertanol, bromuconazole, cyproconazole (II-20), difenoconazole (II-21), diniconazole, diniconazole-M, epoxiconazole (II-22), fenbuconazole, fluquinconazole (II-23), flusilazole, flutriafol, hexaconazole, imibenconazole, ipconazole, metconazole (II-24), myclobutanil, oxpoconazole, paclobutrazole, penconazole, propiconazole (II-25), prothioconazole (II-26), simeconazole, tebuconazole (II-27), tetraconazole, triadimefon, triadimenol, triticonazole, uniconazole; imazalil, pefurazoate, prochloraz, triflumizol; fenarimol, nuarimol, pyrifenox, triforine, [3-(4-chloro-2-fluorophenyl)-5-(2,4-difluorophenyl)isoxazol-4-yl]-(3-pyridyl)methanol;
   Delta14-reductase inhibitors: aldimorph, dodemorph, dodemorphacetate, fenpropimorph, tridemorph, fenpropidin, piperalin, spiroxamine;
   Inhibitors of 3-keto reductase: fenhexamid;
C) Nucleic acid synthesis inhibitors selected from:
   phenylamides or acyl amino acid fungicides: benalaxyl, benalaxyl-M, kiralaxyl, metalaxyl, metalaxyl-M (mefenoxam) (11-38), ofurace, oxadixyl;
others nucleic acid inhibitors: hymexazole, octhilinone, oxolinic acid, bupirimate, 5-fluorocytosine, 5-fluoro-2-(p-tolylmethoxy)pyrimidin-4-amine, 5-fluoro-2-(4-fluorophenylmethoxy)pyrimidin-4-amine;
D) Inhibitors of cell division and cytoskeleton selected from:
   tubulin inhibitors: benomyl, carbendazim, fuberidazole, thiabendazole, thiophanate-methyl (11-39); 5-chloro-7-(4-methylpiperidin-1-yl)-6-(2,4,6-trifluorophenyl)-[1,2,4]triazolo[1,5-a]pyrimidine
   other cell division inhibitors: diethofencarb, ethaboxam, pencycuron, fluopicolide, zoxamide, metrafenone (II-40), pyriofenone;
E) Inhibitors of amino acid and protein synthesis selected from:
   methionine synthesis inhibitors (anilino-pyrimidines): cyprodinil, mepanipyrim, Pyrimethanil (II-41);
   protein synthesis inhibitors: blasticidin-S, kasugamycin, kasugamycin hydrochloride-hydrate, mildiomycin, streptomycin, oxytetracyclin, polyoxine, validamycin A;
F) Signal transduction inhibitors selected from:
   MAP/histidine kinase inhibitors: fluoroimid, iprodione, procymidone, vinclozolin, fenpiclonil, fludioxonil;
   G protein inhibitors: quinoxyfen;
G) Lipid and membrane synthesis inhibitors selected from:
   Phospholipid biosynthesis inhibitors: edifenphos, iprobenfos, pyrazophos, isoprothiolane; propamocarb, propamocarb-hydrochloride;
   lipid peroxidation inhibitors: dicloran, quintozene, tecnazene, tolclofos-methyl, biphenyl, chloroneb, etridiazole;
   phospholipid biosynthesis and cell wall deposition: dimethomorph (II-42), flumorph, mandipropamid (II-43), pyrimorph, benthiavalicarb, iprovalicarb, valifenalate, N-(1-(1-(4-cyano-phenyl)ethanesulfonyl)-but-2-yl) carbamic acid-(4-fluorophenyl) ester;
   acid amide hydrolase inhibitors: oxathiapiprolin;
H) Inhibitors with Multi Site Action selected from:
   inorganic active substances: Bordeaux mixture, copper acetate, copper hydroxide, copper oxychloride (II-44), basic copper sulfate, sulfur;
   thio- and dithiocarbamates: ferbam, mancozeb (II-45), maneb, metam, metiram (II-46), propineb, thiram, zineb, ziram;
   organochlorine compounds: anilazine, Chlorothalonil (II-47), captafol, captan, folpet, dichlofluanid, dichlorophen, hexachlorobenzene, pentachlorophenole and its salts, phthalide, tolylfluanid, N-(4-chloro-2-nitro-phenyl)-N-ethyl-4-methyl-benzenesulfonamide;
   guanidines and others: guanidine, dodine, dodine free base, guazatine, guazatine-acetate, iminoctadine, iminoctadine-triacetate, iminoctadine-tris(albesilate), dithianon, 2,6-dimethyl-1H,5H-[1,4]dithii-no[2,3-c:5,6-c′]dipyrrole-1,3,5,7(2H,6H)-tetraone (II-48);
I) Cell wall synthesis inhibitors selected from:
   inhibitors of glucan synthesis: validamycin, polyoxin B;
   melanin synthesis inhibitors: pyroquilon, tricyclazole, carpropamid, dicyclomet, fenoxanil;
J) Plant defence inducers selected from:
   acibenzolar-S-methyl, probenazole, isotianil, tiadinil, prohexadione-calcium; fosetyl, fosetyl-aluminum, phosphorous acid and its salts (II-49);
K) Unknown mode of action selected from: bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxathiapiprolin, tolprocarb, 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, 2-[3,5-bis-(difluoromethyl)-1H-pyrazol-1-yl]-1-[4-(4-{5-[2-fluoro-6-(prop-2-yn-1-yl-oxy)phenyl]-4,5-dihydro-1,2-oxazol-3-yl}-1,3-thiazol-2-yl)piperidin-1-yl]-ethanone, 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, oxin-copper, proquinazid, tebufloquin, tecloftalam, triazoxide, 2-butoxy-6-iodo-3-propylchromen-4-one, N-(cyclo-propylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethylphenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, methoxyacetic acid 6-tert-butyl-8-fluoro-2,3-dimethyl-quinolin-4-yl ester, 3-[5-(4-meth-ylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl) cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phe-nyl)-isoxazol-5-yl]-2-prop2-ynyloxy-acetamide, ethyl (Z)-3-amino-2-cyano-3-phenyl-prop-2-enoate, tertbutyl N-[6-[[(Z)-[(1-methyltetrazol-5-yl)-phenyl-methylene]-amino]oxymethyl]-2-pyridyl]carbamate, pentyl N-[6-[[(Z)-[(1-methyltetrazol-5-yl)-phenyl-methylene]amino]oxymethyl]-2-pyridyl]carbamate, 2-[2-[(7,8-dif-luoro-2-methyl-3-quinolyl)oxy]-6-fluoro-phenyl]propan-2-ol, 2-[2-fluoro-6-[(8-fluoro-2-methyl-3-qui-nolyl)oxy]phenyl]propan-2-ol, 3-(5-fluoro-3,3,4,4-tetramethyl-3,4-dihydroisoquinolin-1-yl)quinoline, 3-(4,4-difluoro-3,3-dimethyl-3,4-dihydroisoquinolin-1-yl)quinoline, 3-(4,4,5-trifluoro-3,3-dimethyl-3,4-dihydroisoquinolin-1-yl)quinoline;
   Fenpicoxamid, florylpicoxamid;
L) Antifungal biopesticides selected from: Ampelomyces quisqualis, Aspergillus flavus, Aureobasidium pullulans, Bacillus pumilus (II-50), Bacillus subtilis (II-51), Bacillus subtilis var. amyloliquefaciens (II-52), Candida oleophila 1-82, Candida saitoana, Clonostachys rosea F. catenulata, also named Gliocladium catenulatum, Coniothyrium minitans, Cryphonectria parasitica, Cryptococcus albidus, Metschnikowia fructicola, Microdochium dimerum, Phlebiopsis gigantea, Pseudozyma flocculosa, Pythium oligandrum DV74, Reynoutria sachlinensis, Talaromyces flavus V117b, Trichoderma asperellum SKT-1, T. atroviride LC52, T. harzianum T-22, T. harzianum TH 35, T. harzianum T-39; T. harzianum and T. viride, T. harzianum ICC012 and T. viride ICC080; T. polysporum and T. harzianum; T. stromaticum, T. virens GL-21, T. viride, T. viride TV1, Ulocladium oudemansii HRU3;
M) Growth regulators selected from: abscisic acid, amidochlor, ancymidol, 6-benzylaminopurine, brassino-lide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride) (II-54), naphthaleneacetic acid, N-6-benzyladenine, paclobutrazol, prohexadione (prohexadione-calcium, II-55), prohydrojasmon, thidiazuron, triapenthenol, tributyl phosphorotrithioate, 2,3,5-tri-iodobenzoic acid, trinex-apac-ethyl and uniconazole;
N) Herbicides selected from:
   acetamides: acetochlor, alachlor, butachlor, dimethachlor, dimethenamid, flufenacet, mefenacet, me-tolachlor, metazachlor, napropamide, naproanilide, pethoxamid, pretilachlor, propachlor, thenylchlor;
   amino acid derivatives: bilanafos, glyphosate, glufosinate, sulfosate;
   aryloxyphenoxypropionates: clodinafop, cyhalofop-butyl, fenoxaprop, fluazifop, haloxyfop, metamifop, propaquizafop, quizalofop, quizalofop-P-tefuryl;
   Bipyridyls: diquat, paraquat;
   (thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
   cyclohexanediones: butroxydim, clethodim, cycloxydim, profoxydim, sethoxydim, tepraloxydim, tralkoxydim;
   dinitroanilines: benfluralin, ethalfluralin, oryzalin, pendimethalin, prodiamine, trifluralin; diphenyl ethers: acifluorfen, aclonifen, bifenox, diclofop, ethoxyfen, fomesafen, lactofen, oxyfluorfen; -hydroxybenzonitriles: bomoxynil, dichlobenil, ioxynil;
   imidazolinones: imazamethabenz, imazamox, imazapic, imazapyr, imazaquin, imazethapyr;
   phenoxy acetic acids: clomeprop, 2,4-dichlorophenoxyacetic acid (2,4-D), 2,4-DB, dichlorprop, MCPA, MCPA-thioethyl, MCPB, Mecoprop;
   pyrazines: chloridazon, flufenpyr-ethyl, fluthiacet, norflurazon, pyridate;
   pyridines: aminopyralid, clopyralid, diflufenican, dithiopyr, fluridone, fluroxypyr, picloram, picolinafen, thiazopyr;
   sulfonyl ureas: amidosulfuron, azimsulfuron, bensulfuron, chlorimuronethyl, chlorsulfuron, cinosul-furon, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nico-sulfuron, oxasulfuron, primisulfuron, prosulfuron, pyrazosulfuron, rimsulfuron, sulfometuron, sulfosul-furon, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
   triazines: ametryn, atrazine, cyanazine, dimethametryn, ethiozin, hexazinone, metamitron, metribuzin, prometryn, simazine, terbuthylazine, terbutryn, triaziflam;
   ureas: chlorotoluron, daimuron, diuron, fluometuron, isoproturon, linuron, methabenzthiazuron, tebuthiuron;
   other acetolactate synthase inhibitors: bispyribac-sodium, cloransulammethyl, diclosulam, florasulam, flucarbazone, flumetsulam, metosulam, ortho-sulfamuron, penoxsulam, propoxycarbazone, pyribam-benz-propyl, pyribenzoxim, pyriftalid, pyriminobac-methyl, pyrimisulfan, pyrithiobac, pyroxasulfone, py-roxsulam;
   other herbicides: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethyl, chlorthal, cinmethylin, clomazone, cumyluron, cyprosulfa-mide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-3,6-dihydro-2H-pyrimidin-1-yl)-phenoxy]-pyri-din-2-yloxy)-acetic acid ethyl ester, 6-amino-5-chloro-2-cyclopropyl-pyrimidine-4-carboxylic acid methyl ester, 6-chloro-3-(2-cyclopropyl-6-methyl-phenoxy)-pyridazin-4-ol, 4-amino-3-chloro-6-(4-chlorophenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester;
O) Insecticides selected from:
   organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phos-phamidon, phorate, phoxim, pirimiphos-methyl, profenofos, prothiofos, sulprophos, tetrachlorvinphos, terbufos, triazophos, trichlorfon;
   carbamates: alanycarb, aldicarb, bendiocarb, benfuracarb, carbaryl, carbofuran, carbosulfan, fenox-ycarb, furathiocarb, methiocarb, methomyl, oxamyl, pirimicarb, propoxur, thiodicarb, triazamate;
   pyrethroids: allethrin, bifenthrin, cyfluthrin, cyhalothrin, cyphenothrin, cypermethrin, alpha-cypermethrin, beta-cypermethrin, zetacypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
   insect growth regulators: a) chitin synthesis inhibitors: benzoylureas: chlorfluazuron, cyramazin, dif-lubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
   nicotinic receptor agonists/antagonists compounds: clothianidin, dinotefuran, flupyradifurone, imidacloprid, thiamethoxam, nitenpyram, acetamiprid, thiacloprid, 1-2-chloro-thiazol-5-ylmethyl)-2-nitrimino-3,5-dimethyl-[1,3,5]triazinane;
   nicotinic acetylcholine receptor disruptors or allosteric modulators (IRAC Goup 5): spinosyn (including but not limited to spinosyns A, D, B, C, E, F, G, H, J, and other spinosyn isolates from Saccharopolyspora spinosa culture), spinosad (comprising primarily spinsyns A and D), and derivatives or substituents thereof (including but not limited to tetracyclic and pentacyclic spinosyn derivatives, aziridine spinosyn derivatives, C-5,6 and/or C-13,14 substituted spinosyn derivatives); spinetoram (including but not limited to XDE-175-J, XDE-175-L or other O-ethyl substituted spinosyn derivatives); butenyl-spinosyn and derivatives or substituents thereof (such as isolates from Saccharopolyspora pogona culture);
   bioinsecticides including but not limited to Bacillus thuriengiensis, Burkholderia spp, Beauveria bassiana, Metarhizium anisoptiae, Paecilomyces fumosoroseus, and baculoviruses (including but not limited to granuloviruses and nucleopolyhedroviruses);
   GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
   mitochondrial electron transport inhibitor (METI) I acaricides: fenazaquin, pyridaben, tebufenpyrad, tolfenpyrad, flufenerim;
   METI II and III compounds: acequinocyl, fluacyprim, hydramethylnon;
   Uncouplers: chlorfenapyr;
   oxidative phosphorylation inhibitors: cyhexatin, diafenthiuron, fenbutatin oxide, propargite;
   moulting disruptor compounds: cryomazine;
   mixed function oxidase inhibitors: piperonyl butoxide;
   sodium channel blockers: indoxacarb, metaflumizone;
ryanodine receptor inhibitors: chlorantraniliprole, cyantraniliprole, fluben-diamide, N-[4,6-dichloro-2-[(diethyl-lambda-4-sulfanylidene)carbamoyl]-phenyl]-2-(3-chloro-2-pyridyl)-5-(trifluoromethyl)pyra-zole-3-carboxamide; N-[4-chloro-2-[(diethyl-lambda-4-sulfanylidene)carbamoyl]-6-methyl-phenyl]-2-(3-chloro-2-pyridyl)-5-trifluoromethyl)pyrazole-3-carboxamide; N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-car-boxamide; N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide; N-[4,6-dichloro-2-[(diethyl-lambda-4-sulfanyli-dene)carbamoyl]-phenyl]-2-(3-chloro-2-pyridyl)-5-(difluoromethyl)pyrazole-3-carboxamide; N-[4,6-di-bromo-2-[(di-2-propyl-lambda-4-sulfanyl-idene)carbamoyl]-phenyl]-2-(3-chloro-2-pyridyl)-5-(trifluoromethyl)pyrazole-3-carboxamide; N-[4-chloro-2-[(di-2-propyl-lambda-4-sulfanylidene)carbamoyl]-6-cyano-phenyl]-2-(3-chloro-2-pyridyl)-5-(trifluoromethyl)pyrazole-3-carboxamide; N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide; others: benclothiaz, bifenazate, cartap, flonicamid, pyridalyl, pymetrozine, sulfur, thiocyclam, cyenopyrafen, flupyrazofos, cyflumetofen, amidoflumet, imicyafos, bistrifluron, pyrifluquinazon, 1,1′-[(3S,4R,4aR,6S,6aS,12R,12aS,12bS)-4-[[(2-cyclopropylacetyl)oxy]-methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl] cyclopropaneacetic acid ester; fluensulfone, fluoroalkenyl thioethers; and
P) ribonucleic acid (RNA) and associated compounds including double-stranded RNA (dsRNA), microRNA (miRNA) and small interfering RNA (siRNA); bacteriophages.

In some such embodiments, the synergistic pesticidal composition may comprise one or more pesticidal active ingredient, such as selected from the list above, and one or more C11 unsaturated or saturated aliphatic acid or agriculturally acceptable salt thereof. In some further such embodiments, the synergistic pesticidal composition may comprise one or more pesticidal active ingredient, such as selected from the list above, and one or more C12 unsaturated or saturated aliphatic acid or agriculturally acceptable salt thereof.

In some embodiments, synergistic pesticidal compositions may be provided, where the pesticidal active ingredient comprises at least one pesticidal natural oil selected from: neem oil, karanja oil, clove oil, clove leaf oil, peppermint oil, spearmint oil, mint oil, cinnamon oil, thyme oil, oregano oil, rosemary oil, geranium oil, lime oil, lavender oil, anise oil, lemongrass oil, tea tree oil, apricot kernel oil, bergamot oil, carrot seed oil, cedar leaf oil, citronella oil, clove bud oil, coriander oil, coconut oil, eucalyptus oil, evening primrose oil, fennel oil, ginger oil, grapefruit oil, nootkatone(+), grapeseed oil, lavender oil, marjoram oil, pine oil, scotch pine oil, and/or garlic oil and/or components, derivatives and/or extracts of one or more pesticidal natural oil, or a combination thereof. In some further embodiments, synergistic pesticidal compositions may be provided which comprise additional active components other than the principal one or more pesticidal active ingredients, wherein such additional active components may comprise one or more additional efficacies and/or synergistic effects on the pesticidal efficacy of the composition, such as but not limited to adjuvants, synergists, agonists, activators, or combinations thereof, for example. In one such embodiment, such additional active components may optionally comprise naturally occurring compounds or extracts or derivatives thereof. In other embodiments, the pesticidal active ingredient may comprise at least one organic, certified organic, US Department of Agriculture (“USDA”) National Organic Program compliant (“NOP-compliant”) such as may be included in the US Environmental Protection Agency FIFRA 25b, list of ingredients published dated December 2015 by the US EPA entitled “Active Ingredients Eligible for Minimum Risk Pesticide Products”, the US EPA FIFRA 4a list published August 2004 entitled “List 4A—Minimal Risk Inert Ingredients” or the US EPA FIFRA 4b list published August 2004 entitled “List 4B—Other ingredients for which EPA has sufficient information”, for example, Organic Materials Review Institute listed (“OMRI-listed”) or natural pesticidal active ingredient, for example.

In some embodiments, the pesticidal active ingredient may comprise at least one of: neem oil, karanja oil and extracts or derivatives thereof. In further exemplary such embodiments, the pesticidal active ingredient may comprise at least one extract or active component of neem oil or karanja oil, such as but not limited to: azadirachtin, azadiradione, azadirone, nimbin, nimbidin, salannin, deacetylsalannin, salannol, maliantriol, gedunin, karanjin, pongamol, or derivatives thereof, for example.

In some embodiments, the synergistic pesticidal complex has a 1H-NMR spectrum comprising a peak corresponding to a hydrogen atom of a constituent of the complex, the peak shifted to a lower frequency relative to a reference peak of a 1H-NMR spectrum of the constituent when not in the complex, the reference peak also corresponding to the hydrogren atom, and the constituent comprising at least one of said pesticidal agent and said C4-C10 saturated or unsaturated aliphatic acid or an agriculturally compatible salt thereof.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 illustrates general carbonyl alkene structures associated with an exemplary C4-C10 unsaturated aliphatic acid, or agriculturally acceptable salt thereof, according to an embodiment of the present disclosure.

FIG. 2 illustrates an exemplary 96 well microtiter plate showing a color transition of a resazurin dye between colors indicating absence and presence of growth of a representative pest or pathogen, in accordance with a synergistic growth inhibition assay according to an embodiment of the present disclosure.

FIGS. 3-5 illustrate the observed survival rate (percent of original insects still surviving) for Trichoplusia ni (cabbage looper caterpillar) over time for in-vitro testing on a modified McMorran artificial diet to which treatments of Pylon® insecticide (containing chlorfenapyr as the pesticidal active ingredient) and exemplary unsaturated aliphatic acids (and salts) alone are shown in comparison with the corresponding survival rates for treatments with a synergistic pesticidal composition combining Pylon® insecticide with each of the exemplary unsaturated aliphatic acids (and salts) at three concentrations (shown in FIGS. 3, 4, and 5 respectively), according to an embodiment of the present invention.

FIG. 6A illustrates a chemical structure of an exemplary synergistic pesticidal complex composition according to an embodiment of the present invention, comprising azoxystrobin as an exemplary strobilurin pesticidal active ingredient, and octanoic acid as an exemplary aliphatic acid, wherein the azoxystrobin and octanoic acid are hydrogen bonded to form an exemplary synergistic pesticidal composition according to such embodiment.

FIG. 6B illustrates an alternative view of the chemical structure of FIG. 6A. FIGS. 6A and 6B are individually and collectively referred to herein as “FIG. 6”.

FIG. 7A illustrates a chemical structure of an exemplary synergistic pesticidal complex composition according to an embodiment of the present invention, comprising tebuconazole as an exemplary azole pesticidal active ingredient, and octanoic acid as an exemplary aliphatic acid, wherein the tebuconazole and octanoic acid are hydrogen bonded to form an exemplary synergistic pesticidal composition according to such embodiment.

FIG. 7B illustrates an alternative view of the chemical structure of FIG. 7A.

FIG. 7C illustrates a chemical structure of an exemplary synergistic pesticidal complex composition according to an embodiment of the present invention, comprising tebuconazole as an exemplary azole pesticidal active ingredient, and octanoic acid as an exemplary aliphatic acid, wherein the tebuconazole and octanoic acid are hydrogen bonded in an alternative manner to that shown in FIGS. 7A and 7B to form an exemplary synergistic pesticidal composition according to such embodiment. FIGS. 7A, 7B, and 7C are individually and collectively referred to herein as “FIG. 7”.

FIG. 8A illustrates a chemical structure of an exemplary synergistic pesticidal complex composition according to an embodiment of the present invention, comprising chlorfenapyr as an exemplary pyrrole pesticidal active ingredient, and octanoic acid as an exemplary aliphatic acid, wherein the chlorfenapyr and octanoic acid are hydrogen bonded to form an exemplary synergistic pesticidal composition according to such embodiment.

FIG. 8B illustrates an alternative view of the chemical structure of FIG. 8A. FIGS. 8A and 8B are individually and collectively referred to herein as “FIG. 8”.

FIG. 9 illustrates a chemical structure of an exemplary synergistic pesticidal complex composition according to an embodiment of the present invention, comprising chlorantraniliprole as an exemplary diamide pesticidal active ingredient, and octanoic acid as an exemplary aliphatic acid, wherein the chlorantraniliprole and octanoic acid are hydrogen bonded to form an exemplary synergistic pesticidal composition according to such embodiment.

FIG. 10 illustrates a chemical structure of an exemplary synergistic pesticidal complex composition according to an embodiment of the present invention, comprising epoxyconazole as an exemplary triazole pesticidal active ingredient, and octanoic acid as an exemplary aliphatic acid, wherein the chlorfenapyr and octanoic acid are hydrogen bonded to form an exemplary synergistic pesticidal composition according to such embodiment.

FIG. 11 illustrates a representative energetic state of an exemplary pesticidal complex composition comprising a pesticidal active ingredient and a selected C4-C10 aliphatic acid hydrogen bonded thereto according to an embodiment of the present invention, showing the energetically favored lower energetic state of the synergistic pesticidal complex composition due to the presence of the hydrogen bond, and the relationship between hydrogen bond distance and energetic state of the synergistic pesticidal complex composition.

FIG. 12A illustrates proton NMR (¹H-NMR) spectra of an exemplary synergistic pesticidal complex composition (shown in dotted line) according to an embodiment of the invention, the synergistic pesticidal complex composition comprising spinosyn A as a representative spinosyn pesticidal active ingredient, and octanoic acid as a representative C4-C10 aliphatic acid, overlaid with ¹H-NMR spectra of each of the spinosyn A (shown in dashed/dotted line) and octanoic acid (shown in solid line) components of the synergistic pesticidal complex composition alone. FIGS. 12B-12D show each of the spectra of FIG. 12A independently, and with the same axis scaling as FIG. 12A, to aid in legibility.

FIG. 12B illustrates the example proton NMR (¹H-NMR) spectra of spinosyn A of FIG. 12A independently of the other spectra of FIG. 12A.

FIG. 12C illustrates the example proton NMR (¹H-NMR) spectra of octanoic acid of FIG. 12A independently of the other spectra of FIG. 12A.

FIG. 12D illustrates the example proton NMR (¹H-NMR) spectra of the complex of spinosyn A and octanoic acid of FIG. 12A independently of the other spectra of FIG. 12A.

FIG. 13A illustrates an enlarged portion of the proton NMR (¹H-NMR) spectra of an exemplary synergistic pesticidal complex composition (shown in dotted line) according to an embodiment of the invention, the synergistic pesticidal complex composition comprising spinosyn A as a representative spinosyn pesticidal active ingredient, and octanoic acid as a representative C4-C10 aliphatic acid, overlaid with ¹H-NMR spectra of each of the spinosyn A (shown in dashed/dotted line) and octanoic acid (shown in solid line) components of the synergistic pesticidal complex composition alone, showing a lower-frequency shifted and broadened peak in the spectra of the synergistic pesticidal complex composition, relative to the octanoic acid component alone, identifying an intermolecular hydrogen bond between the spinosyn A and octanoic acid components of the synergistic pesticidal complex composition. FIGS. 13B-13D show each of the spectra of FIG. 13A independently, and with the same axis scaling and enlargement as FIG. 13A, to aid in legibility.

FIG. 13B illustrates the example proton NMR (¹H-NMR) spectra of spinosyn A of FIG. 13A independently of the other spectra of FIG. 13A.

FIG. 13C illustrates the example proton NMR (¹H-NMR) spectra of octanoic acid of FIG. 13A independently of the other spectra of FIG. 13A.

FIG. 13D illustrates the example proton NMR (¹H-NMR) spectra of the complex of spinosyn A and octanoic acid of FIG. 13A independently of the other spectra of FIG. 13A.

FIG. 14 illustrates ¹H-NMR spectra of an exemplary synergistic pesticidal complex composition according to an embodiment of the invention. The synergistic pesticidal complex composition comprises glyphosate as a representative synthase inhibitor pesticidal active ingredient; NMR spectra for glyphosate alone is shown in the top chart. The synergistic pesticidal complex composition further comprises trans-3-Hexenoic acid as a representative C4-C10 aliphatic acid; NMR spectra for trans-3-Hexenoic acid alone is shown in the middle chart. A complex of glyphosate and trans-3-Hexenoic acid was simulated; NMR spectra for the complex is shown in the bottom chart. The simulated molecule/complex associated with each chart is shown to the right of the charts.

### DETAILED DESCRIPTION OF SEVERAL EMBODIMENTS

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

### Definitions

Unless otherwise defined, all technical and scientific terms used herein have the same meaning as commonly understood by one of ordinary skill in the art to which this invention belongs. Although methods and materials similar or equivalent to those described herein can be used in the practice or testing of the invention, suitable methods and materials are described herein.

All applications, publications, patents and other references, citations cited herein are incorporated by reference in their entirety. In case of conflict, the specification, including definitions, will control.

As used herein, the singular forms “a”, “and,” and “the” include plural referents unless the context clearly indicates otherwise.

As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

As used herein, “plant” embraces individual plants or plant varieties of any type of plants, in particular agricultural, silvicultural and ornamental plants.

As used herein, the terms “pest” or “pests” or grammatical equivalents thereof, are understood to refer to organisms, e.g., including pathogens, that negatively affect a host or other organism-such as a plant or an animal—by colonizing, damaging, attacking, competing with them for nutrients, infesting or infecting them, as well as undesired organisms that infest human structures, dwellings, living spaces or foodstuffs. Pests include but are not limited to fungi, weeds, nematodes, acari, and arthropods, including insects, arachnids and cockroaches. It is understood that the terms “pest” or “pests” or grammatical equivalents thereof can refer to organisms that have negative effects by infesting plants and seeds, and commodities such as stored grain.

As used herein, the terms “pesticide” or “pesticidal” or grammatical equivalents thereof, are understood to refer to any composition or substance that can be used in the control of any agricultural, natural environmental, human or other animal pathogenic, and domestic/household pests. The terms “control” or “controlling” are meant to include, but are not limited to, any killing, inhibiting, growth regulating, or pestistatic (inhibiting or otherwise interfering with the normal life cycle of the pest) activities of a composition against a given pest. These terms include for example sterilizing activities which prevent the production or normal development of seeds, ova, sperm or spores, cause death of seeds, sperm, ova or spores, or otherwise cause severe injury to the genetic material. Further activities intended to be encompassed within the scope of the terms “control” or “controlling” include preventing larvae from developing into mature progeny, modulating the emergence of pests from eggs including preventing eclosion, degrading the egg material, suffocation, interfering with mycelial growth, reducing gut motility, inhibiting the formation of chitin, disrupting mating or sexual communication, preventing feeding (antifeedant) activity, and interfering with location of hosts, mates or nutrient-sources. The term “pesticide” includes fungicides, herbicides, nematicides, insecticides and the like. The term “pesticide” encompasses, but is not limited to, naturally occurring compounds as well as so-called “synthetic chemical pesticides” having structures or formulations that are not naturally occurring, where pesticides may be obtained by various means including, but not limited to, extraction from biological sources, chemical synthesis of the compound, and chemical modification of naturally occurring compounds obtained from biological sources.

As used herein, the terms “insecticidal” and “acaridical” or “aphicidal” or grammatical equivalents thereof, are understood to refer to substances having pesticidal activity against organisms encompassed by the taxonomical classification of root term and also to refer to substances having pesticidal activity against organisms encompassed by colloquial uses of the root term, where those colloquial uses may not strictly follow taxonomical classifications. The term “insecticidal” is understood to refer to substances having pesticidal activity against organisms generally known as insects of the phylum Arthropoda, class Insecta. Further as provided herein, the term is also understood to refer to substances having pesticidal activity against other organisms that are colloquially referred to as “insects” or “bugs” encompassed by the phylum Arthropoda, although the organisms may be classified in a taxonomic class different from the class Insecta. According to this understanding, the term “insecticidal” can be used to refer to substances having activity against arachnids (class Arachnida), in particular mites (subclass Acari/Acarina), in view of the colloquial use of the term “insect.” The term “acaridical” is understood to refer to substances having pesticidal activity against mites (Acari/Acarina) of the phylum Arthropoda, class Arachnida, subclass Acari/Acarina. The term “aphicidal” is understood to refer to substances having pesticidal activity against aphids (Aphididae) of the phylum Arthopoda, class Insecta, family Aphididae. It is understood that all these terms are encompassed by the term “pesticidal” or “pesticide” or grammatical equivalents. It is understood that these terms are not necessarily mutually exclusive, such that substances known as “insecticides” can have pesticidal activity against organisms of any family of the class Insecta, including aphids, and organisms that are encompassed by other colloquial uses of the term “insect” or “bug” including arachnids and mites. It is understood that “insecticides” can also be known as acaricides if they have pesticidal activity against mites, or aphicides if they have pesticidal activity against aphids.

As used herein, the terms “control” or “controlling” or grammatical equivalents thereof, are understood to encompass any pesticidal (killing) activities or pestistatic (inhibiting, repelling, deterring, and generally interfering with pest functions to prevent the damage to the host plant) activities of a pesticidal composition against a given pest. Thus, the terms “control” or “controlling” or grammatical equivalents thereof, not only include killing, but also include such activities as repelling, deterring, inhibiting or killing egg development or hatching, inhibiting maturation or development, and chemisterilization of larvae or adults. Repellant or deterrent activities may be the result of compounds that are poisonous, mildly toxic, or non-poisonous to pests, or may act as pheromones in the environment.

As used herein, the term “pesticidally effective amount” generally means the amount of the inventive mixtures or of compositions comprising the mixtures needed to achieve an observable effect on growth, including the effects of necrosis, death, retardation, prevention, and removal, destruction, or otherwise diminishing the occurrence and activity of the target pest organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

As used herein, where a range of values is provided, it is understood that each intervening value, to the tenth of the unit of the lower limit unless the context clearly dictates otherwise, between the upper and lower limit of that range and any other stated or intervening value within that stated range is encompassed within embodiments of the invention. The upper and lower limits of these smaller ranges may independently define a smaller range of values, and it is to be understood that these smaller ranges are intended to be encompassed within embodiments of the invention, subject to any specifically excluded limit in the stated range.

In one embodiment according to the present disclosure, a synergistic pesticidal composition comprises a C4-C10 unsaturated aliphatic acid (or agriculturally acceptable salt thereof), and at least one pesticidal active ingredient. In some embodiments, the effective dose of the pesticidal active ingredient when used in combination with the one or more C4-C10 saturated or unsaturated aliphatic acid is lower than the effective dose of the pesticidal active ingredient when used alone (i.e. a smaller amount of pesticidal active can still control pests when used in a synergistic composition together with the one or more C4-C10 saturated or unsaturated aliphatic acid). In some embodiments, a pesticidal active ingredient that is not effective against a particular species of pest can be made effective against that particular species when used in a synergistic composition together with one or more C4-C10 saturated or unsaturated aliphatic acid. In some such embodiments, the pesticidal composition may comprise a C11 unsaturated or saturated aliphatic acid or agriculturally compatible salt thereof. In some further such embodiments, the pesticidal composition may comprise a C12 unsaturated or saturated aliphatic acid or agriculturally compatible salt thereof.

Without being bound by any particular theory, it is believed that the one or more C4-C10 saturated or unsaturated aliphatic acids according to some embodiments of the present disclosure act as cell permeabilizing agents, and when combined with a suitable pesticidal active ingredient, may desirably facilitate the entry of the pesticidal active ingredient into the cells of a target pest or pathogen, thereby desirably providing for a synergistic activity of such a synergistic pesticidal composition. All eukaryotic cell membranes, including for example fungal cell membranes and the cell membranes of insects and nematodes are biochemically similar in that they all comprise a lipid bilayer which is comprised of phospholipids, glycolipids and sterols, as well as a large number of proteins (Cooper & Hausmann 2013).

The amphipathic structure of the lipid bilayer and the polarity of membrane proteins restricts passage of extracellular compounds across the membrane and allows compartmentalization of internal organelles from the intracellular environment. Without being bound by theory, it is believed that the one or more C4-C10 saturated or unsaturated aliphatic acids according to some embodiments disclosed herein will act as cell permeabilizing agents, and when combined with a suitable pesticidal active ingredient may desirably act to enhance the entry of the active ingredient (such as but not limited to fungicidal, insecticidal, acaricidal, molluscicidal, bactericidal and nematicidal actives) into the cells and/or into the intracellular organelles or intracellular bodies of a target pest or pathogen (such as but not limited to fungi, insects, acari, mollusks, bacteria and nematodes, respectively), for example.

In a further embodiment, without being bound by theory, it is believed that the size and/or polarity of many pesticidal molecules prevents and/or limits the pesticidal active ingredient from crossing the cellular membrane, but that the addition of one or more C4-C10 saturated or unsaturated aliphatic acid in accordance with some embodiments of the present disclosure may desirably compromise or provide for the disturbance of the pest cell membrane's lipid bilayer integrity and protein organization such as to create membrane gaps, and/or increase the membrane fluidity, such as to allow the pesticidal active to more effectively enter the cell and/or intracellular organelles of the pest cells, for example. In some such embodiments, the pesticidal composition may comprise a C11 unsaturated aliphatic acid or agriculturally compatible salt thereof. In some further such embodiments, the pesticidal composition may comprise a C12 unsaturated or saturated aliphatic acid or agriculturally compatible salt thereof.

In one particular embodiment, without being bound by theory, it has been determined that the synergistic efficacy of a synergistic pesticidal complex composition comprising a pesticidal active ingredient and at least one C4-C10 aliphatic acid (or agriculturally suitable salt thereof) is determined at least in part by a defined chemical interaction between the pesticidal active ingredient and the C4-C10 aliphatic acid. In one such embodiment, a synergistic pesticidal complex composition may be formed by establishment of at least one hydrogen bond between a pesticidal active ingredient component and a suitable C4-C10 saturated or unsaturated aliphatic acid component. In one such embodiment, a suitable C4-C10 saturated or unsaturated aliphatic acid may be selected for forming a synergistic pesticidal complex composition with a chosen pesticidal active ingredient, by selecting a C4-C10 aliphatic acid which is adapted for forming at least one hydrogen bond with the pesticidal active ingredient. In one such embodiment, a synergistic pesticidal complex composition may be formed comprising a pesticidal active ingredient, and at least one C4-C10 aliphatic acid adapted to form a hydrogen bond with the pesticidal active ingredient, wherein the hydrogen bond has a characteristic bond length of between about 1.5-3.0 Angstroms, including any value or intervening subrange therebetween e.g. 1.6, 1.7, 1.8, 1.9, 2.0, 2.1, 2.2, 2.3, 2.4, 2.5, 2.6, 2.7, 2.8 or 2.9 Angstroms, and a characteristic bond strength of about 7-100 KJ/mol, including any value or intervening subrange therebetween e.g. 10, 15, 20, 25, 30, 35, 40, 45, 50, 55, 60, 65, 70, 75, 80, 85, 90 or 95 KJ/mol. In a particular such embodiment, a synergistic pesticidal complex composition may comprise a pesticidal active ingredient and at least one C4-C10 aliphatic acid, and additionally comprises a hydrogen bond between a hydroxyl group hydrogen donor of the C4-C10 aliphatic acid, and a hydrogen acceptor of the pesticidal active ingredient. In some embodiments, the synergistic pesticidal complex composition comprising a pesticidal active ingredient hydrogen bonded to a C4-C10 aliphatic acid may desirably comprise a lower total energy of the complex than the sum of the energies of the pesticidal active ingredient and the C4-C10 aliphatic acid alone. In a particular such embodiment, the synergistic properties of a synergistic pesticidal complex composition comprising a pesticidal active ingredient and a hydrogen bonded C4-C10 aliphatic acid are distinct from a point of view of pesticidal efficacy against one or more pest organisms, relative to a composition comprising a pesticidal active ingredient with some other compound which is not adapted to form a hydrogen bond with the pesticidal active ingredient. In some such embodiments, the pesticidal composition may comprise a C11 unsaturated aliphatic acid or agriculturally compatible salt thereof. In some further such embodiments, the pesticidal composition may comprise a C12 unsaturated or saturated aliphatic acid or agriculturally compatible salt thereof.

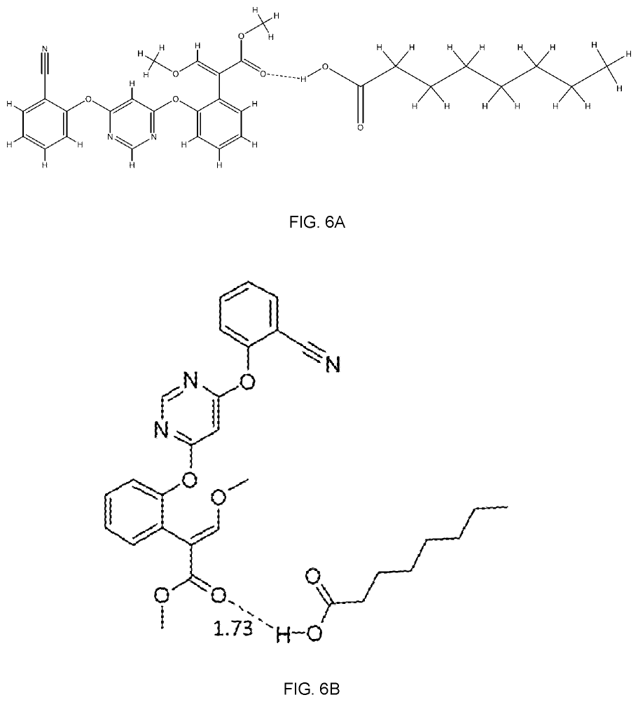

In some additional embodiments, a synergistic pesticidal complex composition comprising a strobilurin fungicide pesticidal active ingredient and at least one C4-C10 aliphatic acid (or agriculturally acceptable salt thereof) which is adapted to form a hydrogen bond between the strobilurin and aliphatic acid. In a particular such embodiment, the C4-C10 aliphatic acid may desirably be adapted to form a hydrogen bond with a carbonyl oxygen in the head group of the strobilurin, as shown in FIGS. 6A and 6B in the exemplary case of azoxystrobin as a representative strobilurin pesticidal active ingredient, for example. In at least the depicted example a carboxyl group of the aliphatic acid (e.g. a hydroxyl group of the carboxyl group) forms a hydrogen bond with a carbonyl oxygen of a methoxypropanoate group of the strobilurin, which structure is conserved across at least some strobilurin pesticidal active ingredients. In at least the depicted embodiment, the aliphatic acid acts as a hydrogen donor and the resulting hydrogen bond has a length of approx. 1.73 Å.

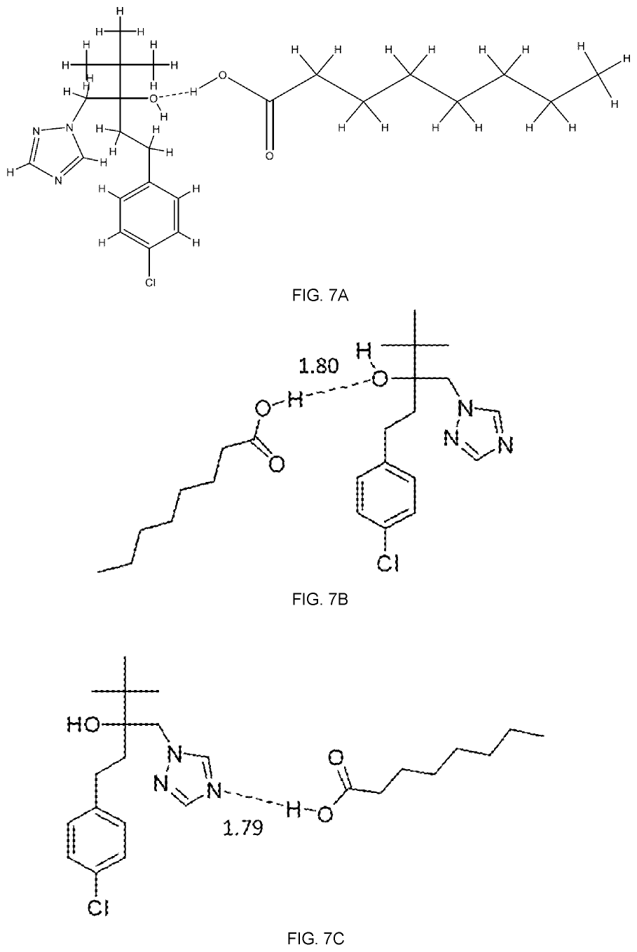

In some additional embodiments, a synergistic pesticidal complex composition comprising an azole fungicide pesticidal active ingredient and at least one C4-C10 aliphatic acid (or agriculturally acceptable salt thereof) which is adapted to form a hydrogen bond between the azole and aliphatic acid. In a particular such embodiment, the C4-C10 aliphatic acid may desirably be adapted to form a hydrogen bond with an oxygen atom of the azole, such as is shown in FIGS. 7A and 7B in the exemplary case of tebuconazole as a representative triazole fungicide pesticidal active ingredient, and/or with a nitrogen atom of the azole, such as is shown in FIGS. 7C and 10 in the exemplary cases of tebuconazole and epoxyconazole, respectively, for example.

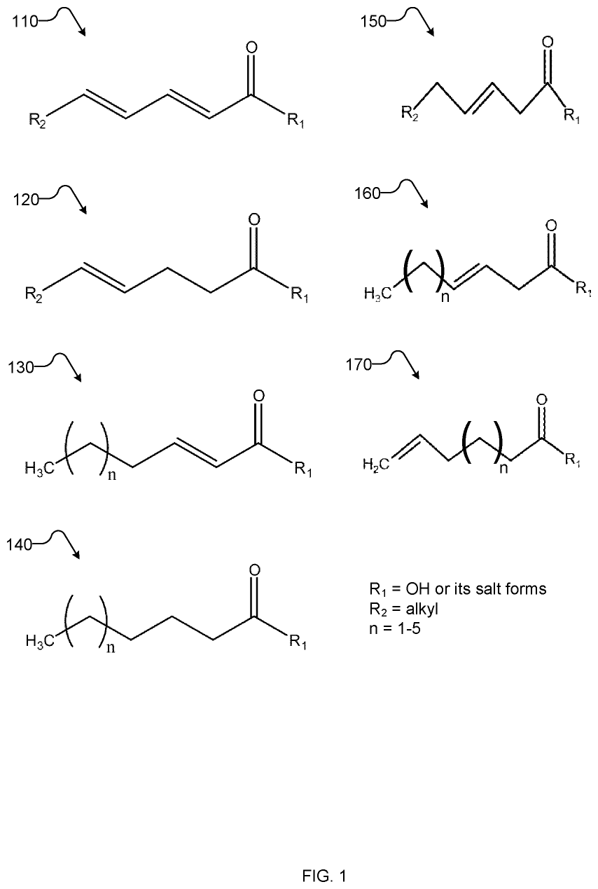

In at least the depicted embodiment of FIGS. 7A and 7B a carboxyl group of the aliphatic acid (e.g. a hydroxyl group of a carboxyl group) forms a hydrogen bond with an oxygen atom (e.g. a hydroxyl oxygen) of the azole, which structure is conserved across at least some azole pesticidal active ingredients. In at least the depicted embodiments of FIGS. 7C and 10a carboxyl group of the aliphatic acid (e.g. a hydroxyl group of a carboxyl group) forms a hydrogen bond with a nitrogen atom (e.g. the third nitrogen atom, as with the tebuconazole of FIG. 7C, and/or the second nitrogen atom, as with the epoxyconazole of FIG. 10) of a triazole group of the azole, which structure is conserved across at least some azole pesticidal active ingredients (and particularly triazoles). In at least the depicted embodiments, the aliphatic acid acts as a hydrogen donor. The resulting hydrogen bond has a length of approx. 1.80 Å in the complex of FIGS. 7A and 7B, 1.79 Å in the complex of FIG. 7C, and 1.73 Å in the complex of FIG. 10.

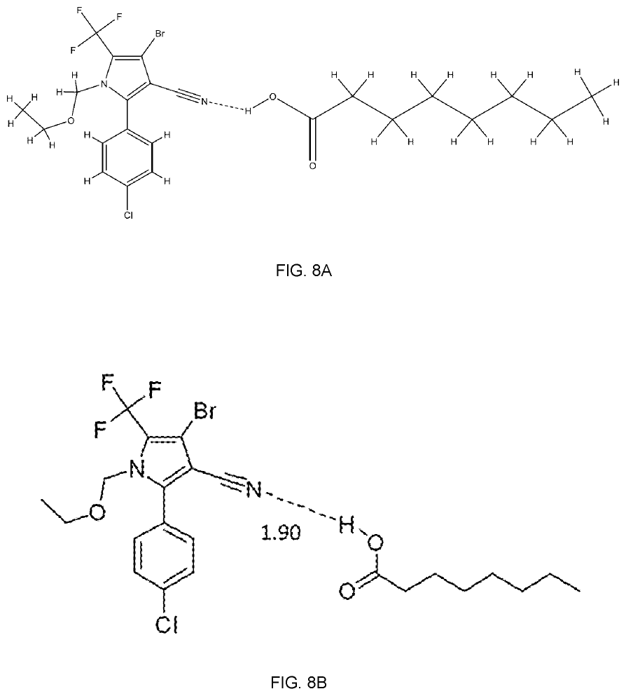

In some additional embodiments, a synergistic pesticidal complex composition comprising a pyrrole insecticide pesticidal active ingredient and at least one C4-C10 aliphatic acid (or agriculturally acceptable salt thereof) which is adapted to form a hydrogen bond between the pyrrole and aliphatic acid. In a particular such embodiment, the C4-C10 aliphatic acid may desirably be adapted to form a hydrogen bond with a nitrogen atom of the pyrrole, such as is shown in FIGS. 8A and 8B in the exemplary case of chlorfenapyr as a representative pyrrole fungicide pesticidal active ingredient, for example. In at least the depicted example a carboxyl group of the aliphatic acid (e.g. a hydroxyl group of the carboxyl group) forms a hydrogen bond with a nitrogen atom of a nitrile group of the pyrrole, which structure is conserved across at least some pyrrole pesticidal active ingredients. In at least the depicted embodiment, the aliphatic acid acts as a hydrogen donor and the resulting hydrogen bond has a length of approx. 1.90 Å.

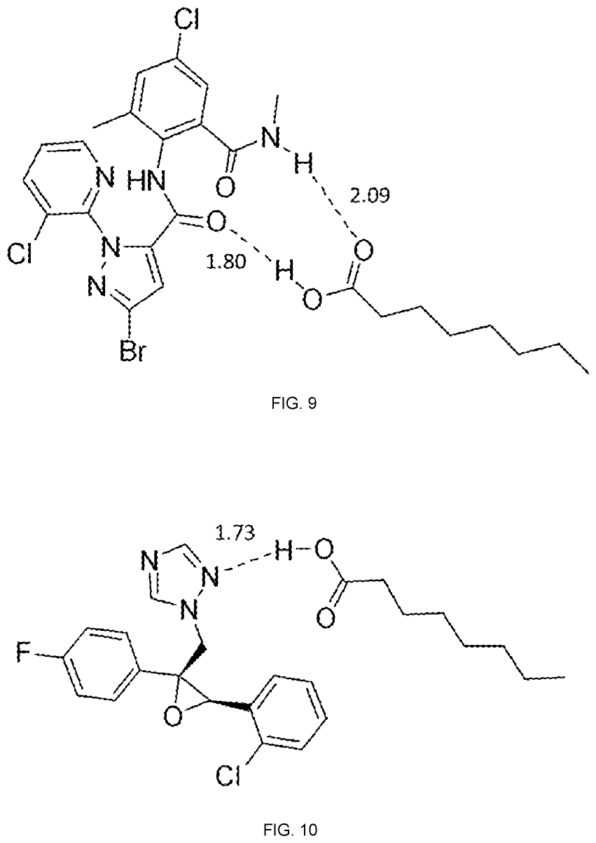

In some additional embodiments, a synergistic pesticidal complex composition comprising a diamide insecticide pesticidal active ingredient and at least one C4-C10 aliphatic acid (or agriculturally acceptable salt thereof) which is adapted to form a hydrogen bond between the diamide and aliphatic acid. In a particular such embodiment, the C4-C10 aliphatic acid may desirably be adapted to form a hydrogen bond with an oxygen atom and/or a hydrogen atom of the diamide, such as is shown in FIG. 9 in the exemplary case of chlorantraniliprole as a representative diamide insecticide pesticidal active ingredient, for example. In at least the depicted example a carboxyl group of the aliphatic acid (e.g. a hydroxyl group of the carboxyl group) forms a hydrogen bond with an oxygen atom of a carbonyl group, and particularly a 3-carboxamide carbonyl group, of the diamide, which structure is conserved across at least some diamide pesticidal active ingredients. In at least the depicted embodiment, the aliphatic acid acts as a hydrogen donor for this bond and the resulting hydrogen bond has a length of approx. 1.80 Å. In at least the depicted example an oxygen atom (e.g. an oxygen of a carboxyl group) of the aliphatic acid forms a hydrogen bond with a hydrogen atom of an amino group (e.g. an amine and/or amide hydrogen, such as an amide hydrogen of a methylcarbamoyl group) of the diamide, which structure is conserved across at least some diamide pesticidal active ingredients (e.g. at least some anthranilic diamides, such as cyantraniliprole, cyclaniliprole, tetraniliprole, and/or tetrachlorantraniliprole). In at least the depicted embodiment, the diamide acts as a hydrogen donor for this bond and the resulting hydrogen bond has a length of approx. 2.09 Å.

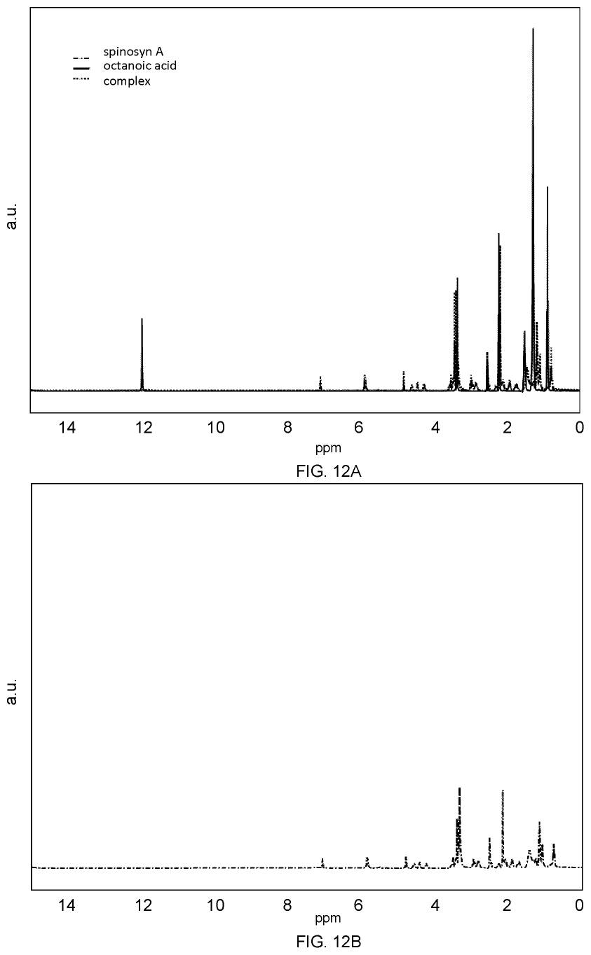

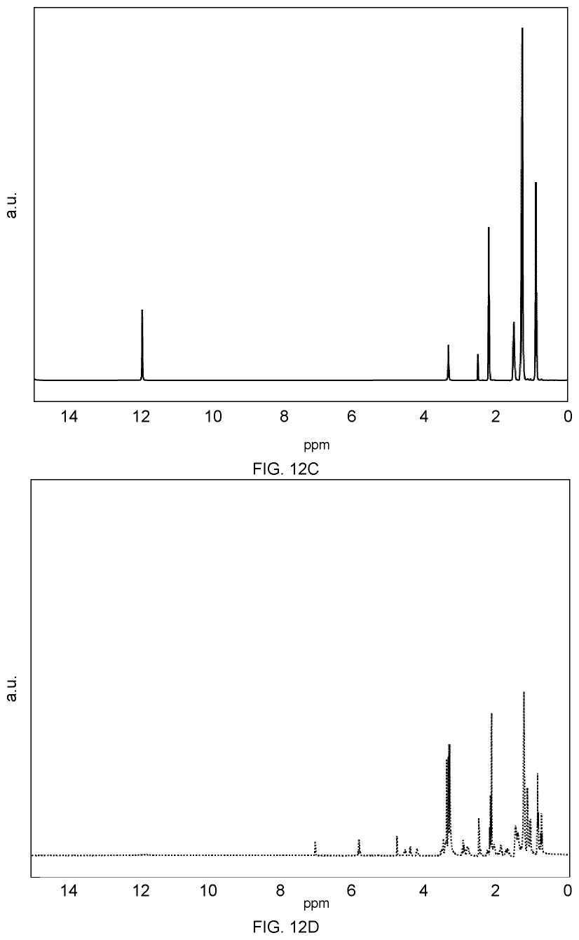

In some additional embodiments, a synergistic pesticidal complex composition comprising a spinosyn insecticide pesticidal active ingredient and at least one C4-C10 aliphatic acid (or agriculturally acceptable salt thereof) which is adapted to form a hydrogen bond between the spinosyn and aliphatic acid. In a particular such embodiment, the C4-C10 aliphatic acid may desirably be adapted to form a hydrogen bond with an oxygen atom of the spinosyn, such as is indicated in the proton NMR spectra shown in FIG. 12 in the exemplary case of spinosyn A as a representative spinosyn insecticide pesticidal active ingredient, for example.

In some embodiments, such as the embodiments illustrated in FIGS. 6-10 and/or described herein, the pesticidal composition may comprise a C11 unsaturated aliphatic acid or agriculturally compatible salt thereof. In some embodiments, the pesticidal composition may comprise a C12 unsaturated or saturated aliphatic acid or agriculturally compatible salt thereof.

Hydrogen Bonding (H-Bond) Between Pesticidal Active Ingredient and C4-C10 Aliphatic Acid Components of a Synergistic Pesticidal Complex Composition According to Embodiments of the Present Invention

The strength of hydrogen bonds are known to vary such as between about 7 KJ/mol (N—H ⋅ ⋅ ⋅ O) to greater than 100 KJ/mol (F—H ⋅ ⋅ ⋅ F). In some embodiments, the strength of H-bond for molecules containing oxygen and nitrogen, such as are present in many pesticidal actives and certain suitable C4-C10 aliphatic acids is presented here:
N— H ⋅ ⋅ ⋅ O: 8 KJ/mol or 0.083 eV (labeled as “A” for this discussion)
N—H ⋅ ⋅ ⋅ N: 13 KJ/mol or 0.13 eV (labeled as “B” for this discussion)
O—H ⋅ ⋅ ⋅ O: 21 KJ/mol or 0.22 eV (labeled as “C” for this discussion)
O—H ⋅ ⋅ ⋅ N: 29 KJ/mol or 0.30 eV (labeled as “D” for this discussion)

In one embodiment, a density functional theory (DFT) approach may be taken to optimize the geometry of the pesticidal active ingredient and aliphatic acid molecules, using ωB97X-D with 6-31G* basis set. In one such exemplary embodiment, such hydrogen bonding geometry calculation is performed for two models:
1—The isolated molecule including the pesticidal active ingredient molecules and the C4-C10 aliphatic acid molecules
2—The synergistic pesticidal complex of pesticidal active ingredient-aliphatic acid with the hydrophobic parts aligned to maximize the interactions between the molecules

Without being bound by theory, in one embodiment, the difference between the sum of the energies of the individual molecules with the energy of the complex should be equal to the strength of the formed hydrogen bond.

The following table shows the results for tebuconazole as a representative azole fungicide and octanoic acid as a representative C4-C10 saturated or unsaturated aliphatic acid:

| | | Dipole | |
|---|---|---|---|
| Molecule | Energy (eV) | (Debye) | Polarizability |
| Tebuconazole | −35983.04283 | 3.69 | 64.69 |
| Octanoic acid | −12648.60751 | 1.82 | 52.46 |
| Sum of molecules | −48631.65035 | 5.51 | — |
| complex | −48632.38598 | 4.24 | 117.15 |
| Difference | −0.74 | | |

Looking at the geometry optimized simulation output, the tebuconazole and octanoic acid form two hydrogen bonds. One of them is intramolecular in form of “D” type within the tebuconazole molecule, while the other one is intermolecular between a hydrogen from octanoic acid (a hydroxyl H from an —OH group) with one of the oxygen atoms in the tebuconazole molecule (C form), which forms the tebuconazole/octanoic acid synergistic pesticidal complex in this representative example. The sum of these energies would be 0.55 eV energy difference, but the final structure is 0.74 eV lower in energy (more stable due to the hydrogen bonding).

In another embodiment, a synergistic pesticidal complex of azoxystrobin as a representative strobilurin fungicide with octanoic acid as a representative C4-C10 saturated or unsaturated aliphatic acid, shows a similar change in the total energies as the synergistic pesticidal complex forms.

| | | Dipole | |
|---|---|---|---|
| Molecule | Energy (eV) | (Debye) | Polarizability |
| Azoxystrobin | −37782.00591 | 4.67 | 71.44 |
| Octanoic Acid | −12648.60751 | 1.82 | 52.46 |
| Sum of molecules | −50430.61343 | 6.49 | |
| complex | −50431.43151 | 6.99 | 85.13 |
| Difference | −0.82 | | |

For the azoxystrobin molecule, the synergistic pesticidal complex formed by hydrogen bonding with the octanoic acid is more stable than the sum of the two molecules by 0.82 eV.

In both complexes, the length of the hydrogen bond is ˜1.8 Å which represents a strong hydrogen bond between the pesticidal active and the C4-C10 aliphatic acid molecules.

In a further embodiment, a similar chemical bonding simulation study has been carried out for the following combinations:
a synergistic pesticidal complex of chlorfenapyr as a representative pyrrole insecticide with octanoic acid as a representative C4-C10 saturated or unsaturated aliphatic acid—with the calculated hydrogen bond distance of 1.973 Å:

| | | Dipole | |
|---|---|---|---|
| Molecule | Energy (eV) | (Debye) | Polarizability |
| Chlorfenapyr | −111463.8561 | 6.46 | 64.55 |
| Octanoic Acid | −12648.60751 | 1.82 | 52.46 |
| Sum of molecules | −124112.4636 | 8.28 | |
| complex | −124113.1973 | 6.14 | 78.23 |
| Difference | −0.733728082 | | |

a synergistic pesticidal complex of picoxystrobin as a representative strobilurin fungicide with decanoic acid as a representative C4-C10 saturated or unsaturated aliphatic acid—With the hydrogen bond distance of 1.796 Å:

| | | Dipole | |
|---|---|---|---|
| Molecule | Energy (eV) | (Debye) | Polarizability |
| Picoxystrobin | −36743.50475 | 2.7 | 67.05 |
| Decanoic Acid | −14787.58866 | 1.88 | 55.45 |
| Sum of molecules | −51531.09341 | 4.58 | |
| complex | −51532.17003 | 2.67 | 83.6 |
| Difference | −1.076618883 | | |

a synergistic pesticidal complex of pyraclostrobin as a representative strobilurin fungicide with decanoic acid as a representative C4-C10 saturated or unsaturated aliphatic acid—With the hydrogen bond distance of 1.773 Å:

| | | Dipole | |
|---|---|---|---|
| Molecule | Energy (eV) | (Debye) | Polarizability |
| Pyraclostrobin | −45163.70226 | 3.09 | 69.4 |
| Decanoic Acid | −14787.58866 | 1.88 | 55.45 |
| Sum of molecules | −59951.29092 | 4.97 | |
| complex | −59952.03011 | 4.35 | 86.06 |
| Difference | −0.739197572 | | |

In a further embodiment, a similar chemical bonding simulation study has been carried out using B3LYP with 6-311+G** basis set for the following combinations:
a synergistic pesticidal complex of azoxystrobin as a representative strobilurin fungicide with trans-2-hexenoic acid as a representative C4-C10 saturated or unsaturated aliphatic acid—With the hydrogen bond distance of 1.782 Å:

| | | Dipole | |
|---|---|---|---|
| Molecule | Energy (eV) | (Debye) | Polarizability |
| Azoxystrobin | −37804.30204 | 4.22 | 72.71 |
| trans-2-hexenoic | −10482.73198 | 2.19 | 50.55 |
| acid | | | |
| Sum of molecules | −48287.03402 | 6.41 | |
| Complex | −48287.44608 | 4.9 | 83.14 |
| Difference | −0.412061088 | | |

a synergistic pesticidal complex of azoxystrobin as a representative strobilurin fungicide with trans-3-Hexenoic acid as a representative C4-C10 saturated or unsaturated aliphatic acid—With the hydrogen bond distance of 1.769 Å:

| | | Dipole | |
|---|---|---|---|
| Molecule | Energy (eV) | (Debye) | Polarizability |
| Azoxystrobin | −37804.30204 | 4.22 | 72.71 |
| trans-3-Hexenoic | −10482.60828 | 1.55 | 50.4 |
| acid | | | |
| Sum of molecules | −48286.91031 | 5.77 | |
| Complex | −48287.37497 | 4.57 | 83.18 |
| Difference | −0.464660578 | | |

a synergistic pesticidal complex of azoxystrobin as a representative strobilurin fungicide with hexanoic acid as a representative C4-C10 saturated or unsaturated aliphatic acid—With the hydrogen bond distance of 1.773 Å:

| | | Dipole | |
|---|---|---|---|
| Molecule | Energy (eV) | (Debye) | Polarizability |
| Azoxystrobin | −37804.30204 | 4.22 | 72.71 |
| hexanoic acid | −10516.15252 | 1.53 | 50.5 |
| Sum of molecules | −48320.45456 | 5.75 | |
| Complex | −48320.90923 | 4.51 | 83.51 |
| Difference | −0.454674022 | | |

a synergistic pesticidal complex of azoxystrobin as a representative strobilurin fungicide with 3-decenoic acid as a representative C4-C10 saturated or unsaturated aliphatic acid—With the hydrogen bond distance of 1.768 Å:

| | | Dipole | |
|---|---|---|---|
| Molecule | Energy (eV) | (Debye) | Polarizability |
| Azoxystrobin | −37804.30204 | 4.22 | 72.71 |
| 3-decenoic acid | −14762.88824 | 1.57 | 56.38 |
| Sum of molecules | −52567.19028 | 5.79 | |
| Complex | −52567.64748 | 4.51 | 89.51 |
| Difference | −0.457204675 | | |

a synergistic pesticidal complex of prothioconazole as a representative triazole fungicide with trans-3-Hexenoic acid as a representative C4-C10 saturated or unsaturated aliphatic acid—With the hydrogen bond distance of 1.812 Å:

| | | Dipole | |
|---|---|---|---|
| Molecule | Energy (eV) | (Debye) | Polarizability |
| Prothioconazole | −57165.93553 | 6.55 | 65.18 |
| trans-3-Hexenoic | −10482.60828 | 1.55 | 50.4 |
| acid | | | |
| Sum of molecules | −67648.54381 | 8.1 | |
| Complex | −67649.05373 | 5.21 | 75.61 |
| Difference | −0.509913011 | | |

a synergistic pesticidal complex of prothioconazole as a representative triazole fungicide with 3-decenoic acid as a representative C4-C10 saturated or unsaturated aliphatic acid—With the hydrogen bond distance of 1.818 Å.

| | | Dipole | |
|---|---|---|---|
| Molecule | Energy (eV) | (Debye) | Polarizability |
| Prothioconazole | −57165.93553 | 6.55 | 65.18 |
| 3-decenoic acid | −14762.88824 | 1.57 | 56.38 |
| Sum of molecules | −71928.82378 | 8.12 | |
| Complex | −71929.31979 | 5.11 | 81.58 |
| Difference | −0.496008024 | | |

a synergistic pesticidal complex of spinosyn A as a representative spinosyn insecticide with octanoic acid as a representative C4-C10 saturated or unsaturated aliphatic acid—With the hydrogen bond distance of 1.720 Å:

| | | Dipole | |
|---|---|---|---|
| Molecule | Energy (eV) | (Debye) | Polarizability |
| Spinosyn A | −65552.95127 | 9.53 | 102.85 |
| octanoic acid | −12656.24916 | 1.93 | 53.56 |
| Sum of molecules | −78209.20043 | 11.46 | |
| Complex | −78209.59039 | 8.14 | 116.65 |
| Difference | −0.389965492 | | |

a synergistic pesticidal complex of spinosyn A as a representative spinosyn insecticide with decanoic acid as a representative C4-C10 saturated or unsaturated aliphatic acid—With the hydrogen bond distance of 1.725 Å:

| | | Dipole | |
|---|---|---|---|
| Molecule | Energy (eV) | (Debye) | Polarizability |
| Spinosyn A | −65552.95127 | 9.53 | 102.85 |
| decanoic acid | −14796.38364 | 1.94 | 56.55 |
| Sum of molecules | −80349.33491 | 11.47 | |
| Complex | −80349.72983 | 8.06 | 119.63 |
| Difference | −0.394917953 | | |

a synergistic pesticidal complex of chlorantraniliprole as a representative diamide insecticide with trans-2-hexenoic acid as a representative C4-C10 saturated or unsaturated aliphatic acid—With the hydrogen bond distance of 1.797 Å:

| | | Dipole | |
|---|---|---|---|
| Molecule | Energy (eV) | (Debye) | Polarizability |
| Chlorantraniliprole | −125538.1327 | 4.92 | 71.33 |
| trans-2-hexenoic | −10482.73198 | 2.19 | 50.55 |
| acid | | | |
| Sum of molecules | −136020.8647 | 7.11 | |
| Complex | −136021.3099 | 6.13 | 81.82 |
| Difference | −0.445231693 | | |

a synergistic pesticidal complex of glyphosate as a representative synthase inhibitor (and further representative of class 9 EPSP synthase inhibitors) with trans-3-Hexenoic acid as a representative C4-C10 saturated or unsaturated aliphatic acid—With the hydrogen bond distance of 1.620 Å:

| | | Dipole | |
|---|---|---|---|
| Molecule | Energy (eV) | (Debye) | Polarizability |
| Glyphosate | −24262.91284 | 2.51 | 50.98 |
| trans-3-Hexenoic | −10482.60828 | 1.55 | 50.4 |
| acid | | | |
| Sum of molecules | −34745.52112 | 4.06 | |
| Complex | −34746.36489 | 1.6 | 61.26 |
| Difference | −0.843768752 | | |

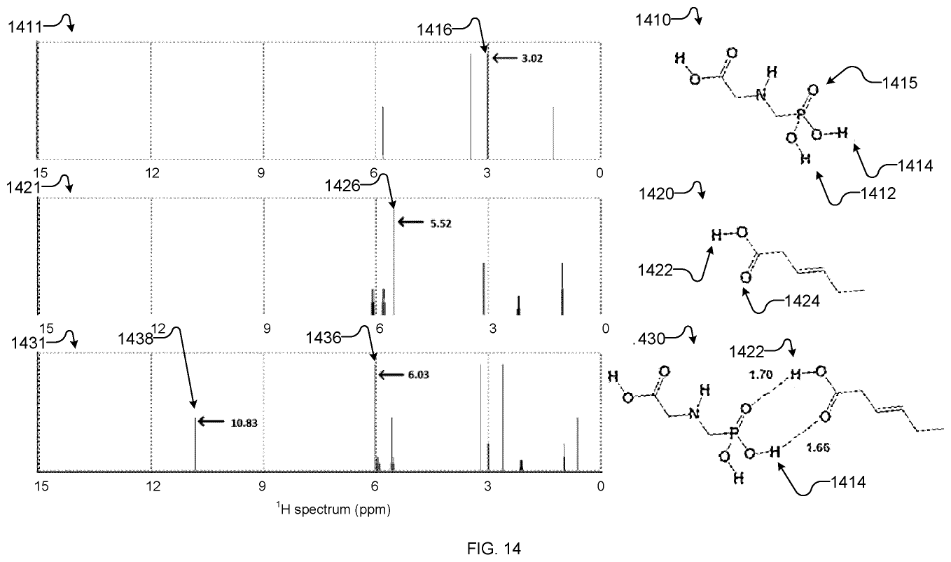

This complex is further characterized in FIG. 14 and its associated description, below.
a synergistic pesticidal complex of pyraclostrobin as a representative strobilurin fungicide with trans-2-hexenoic acid as a representative C4-C10 saturated or unsaturated aliphatic acid—With the hydrogen bond distance of 1.824 Å:

| | | Dipole | |
|---|---|---|---|
| Molecule | Energy (eV) | (Debye) | Polarizability |
| Pyrachlostrobin | −45183.6018 | 2.67 | 70.57 |
| trans-2-hexenoic | −10482.73198 | 2.19 | 50.55 |
| acid | | | |
| Sum of molecules | −55666.33378 | 4.86 | |
| Complex | −55666.75259 | 1.09 | 80.98 |
| Difference | −0.418809496 | | |

a synergistic pesticidal complex of chlorantraniliprole as a representative diamide insecticide with trans-2-Octenoic acid as a representative C4-C10 saturated or unsaturated aliphatic acid—With the hydrogen bond distance of 1.788 Å

| | | Dipole | |
|---|---|---|---|
| Molecule | Energy (eV) | (Debye) | Polarizability |
| Chlorantraniliprole | −125538.1327 | 4.92 | 71.33 |
| trans-2-Octenoic | −12622.86911 | 2.26 | 53.53 |
| acid | | | |
| Sum of molecules | −138161.0018 | 7.18 | |
| Complex | −138161.439 | 5.99 | 84.81 |
| Difference | −0.437149929 | | |

a synergistic pesticidal complex of chlorantraniliprole as a representative diamide insecticide with trans-3-Hexenoic acid as a representative C4-C10 saturated or unsaturated aliphatic acid—With the hydrogen bond distance of 1.791 Å:

| | | Dipole | |
|---|---|---|---|
| Molecule | Energy (eV) | (Debye) | Polarizability |
| Chlorantraniliprole | −125538.1327 | 4.92 | 71.33 |
| trans-3-Hexenoic | −10482.60828 | 1.55 | 50.4 |
| acid | | | |
| Sum of molecules | −136020.741 | 6.47 | |
| Complex | −136021.209 | 4.97 | 81.83 |
| Difference | −0.468034783 | | |

a synergistic pesticidal complex of chlorantraniliprole as a representative diamide insecticide with octanoic acid as a representative C4-C10 saturated or unsaturated aliphatic acid—With the hydrogen bond distance of 1.785 Å:

| | | Dipole | |
|---|---|---|---|
| Molecule | Energy (eV) | (Debye) | Polarizability |
| Chlorantraniliprole | −125538.1327 | 4.92 | 71.33 |
| octanoic acid | −12656.24916 | 1.93 | 53.56 |
| Sum of molecules | −138194.3819 | 6.85 | |
| Complex | −138194.8333 | 4.89 | 85.15 |
| Difference | −0.451435875 | | |

a synergistic pesticidal complex of chlorantraniliprole as a representative diamide insecticide with trans-2-decenoic acid as a representative C4-C10 saturated or unsaturated aliphatic acid—With the hydrogen bond distance of 1.785 Å:

| | | Dipole | |
|---|---|---|---|
| Molecule | Energy (eV) | (Debye) | Polarizability |
| Chlorantraniliprole | −125538.1327 | 4.92 | 71.33 |
| trans-2-decenoic | −14762.99908 | 2.3 | 56.53 |
| acid | | | |
| Sum of molecules | −140301.1318 | 7.22 | |
| Complex | −140301.5747 | 6.15 | 87.8 |
| Difference | −0.442891519 | | |

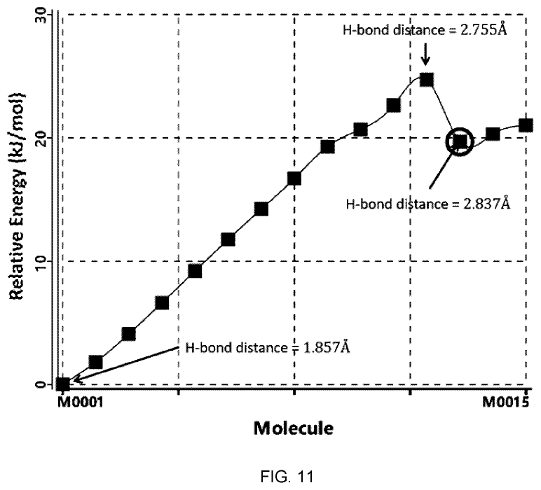

In a further exemplary embodiment, FIG. 11 illustrates the effect of H-bond distance on the relative energy of the synergistic pesticidal complex when a pesticidal active ingredient and a suitable C4-C10 aliphatic acid form a hydrogen bonded complex. The molecules are selected in a way to reproduce the same type of interactions as the interactions between the pesticidal active ingredient and C4-C10 aliphatic acid molecule. As it can be observed in FIG. 11, the reference complex molecule is the one with the hydrogen bond distance of 1.857 Å which reproduces the standard bond distance between the active and aliphatic acid molecule in the synergistic pesticidal complex. As the hydrogen bond distance increases, the energy of the molecule increases. As the H-bond distance increases to more than 2.755 Å, the complex is in its most unstable energy compared to the reference molecule. When the H-bond breaks, the hydrophobic interactions between pesticidal active ingredient and aliphatic acid components become the dominant force that hold the complex together. This will stabilize the molecule (by ˜5KJ/mol in this illustrative example). In one such embodiment, without being limited by theory, it is believed that the hydrogen bond and hydrophobic interactions are the two main forces that help generating the synergistic pesticidal complex and keeping it together while it interacts with a cell or intracellular membrane of a pest organism, such as to enhance the transport of the active ingredient through the membrane, for example. In a further embodiment, without being limited by theory, it is believed that if the hydrophobic interactions between an aliphatic acid and a pest membrane structure (such as lipid bylayer molecules) become greater than the H-bond strength, this could result in dissociation of the complex, such as to release the pesticidal active ingredient, which may be desirable for efficacious delivery in some embodiments, for example. In one such embodiment, the size of the aliphatic acid molecule plays an important role throughout this process as it has a direct effect on the hydrophobic interactions as well as the H-bond strength. Accordingly, in some embodiments, it is therefore desirable to select a suitable C4-C10 aliphatic acid (or agriculturally suitable salt thereof) adapted for forming a suitable hydrogen bonded synergistic pesticidal complex with a selected pesticidal active ingredient.

In a further embodiment, without being limited by theory, in the above simulations it is believed that the synergistic pesticidal complex also has a higher polarizability compared to the individual active ingredient and C4-C10 aliphatic acid component molecules. In one embodiment it is believed that this means that the complex could desirably approach the head groups of pest cell or intracellular membranes more easily and in an energetically advantaged manner than either of the active ingredient or aliphatic acid single molecules.

In a further embodiment, molecular dynamics simulations were constructed to simulate synergistic pesticidal complex interaction with biological membranes, wherein each of the above-discussed active ingredient/aliphatic acid synergistic pesticidal complexes were simulated in an aqueous environment containing ˜100,000 water molecules. This aqueous shell was geometry optimized and equilibrated for 100 Ps. During the simulation time, both molecules form hydrogen bonds with various water molecules but the H-bond within the synergistic pesticidal complex never breaks and is always present, thus confirming that the structure is stable with the hydrogen bond in the form of a synergistic pesticidal complex.

### Proton NMR Characterization of Hydrogen Bonding Between Pesticidal Active Ingredient and C4-C10 Aliphatic Acid Molecules in a Synergistic Pesticidal Complex

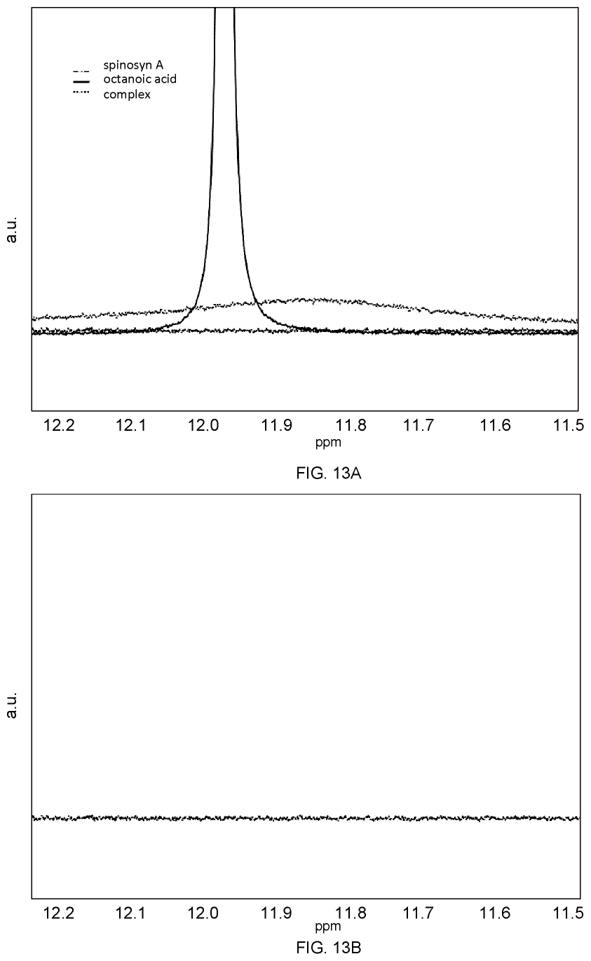

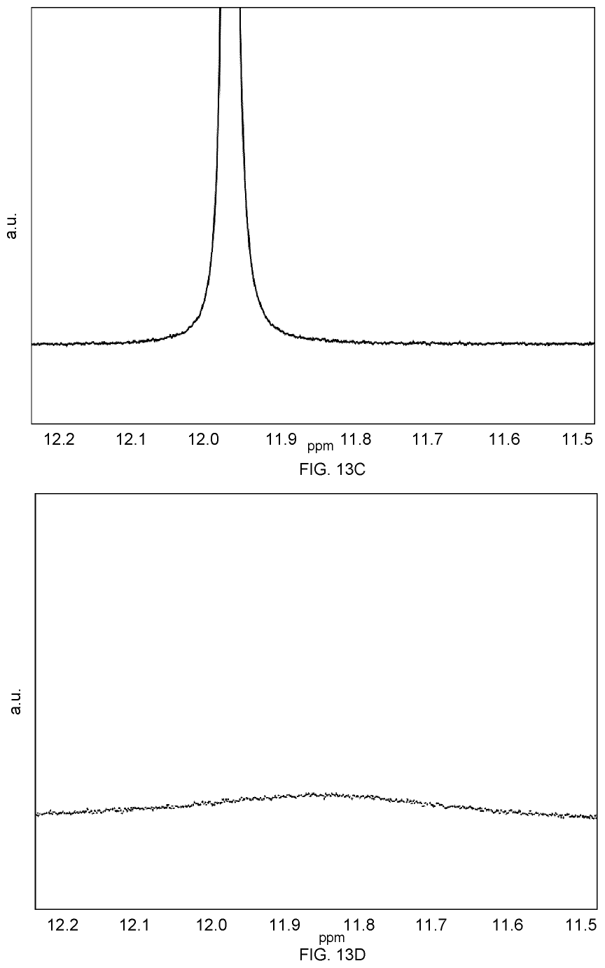

In the previous study discussed above, the H-bond between pesticidal active ingredient and C4-C10 aliphatic acid or agridulturally suitable salts thereof) molecules was studied as a function of the hydrogen bond length. In a further embodiment, proton NMR empirical methods were used to perform an experimental measurement to characterize the hydrogen bond between the active and alphatic acid components of the synergistic pesticidal complex to confirm the presence and character of the hydrogen bond. According to known methods, a hydrogen bond may be characterized using NMR spectroscopy by measuring the broadening and energy shifts of the peaks corresponding to the atoms involved in the H-bond (C═O—H . . . O═R in the exemplary case shown in FIGS. 12 and 13). As is known in the field, proton NMR may be used to characterize H-bonds which represent intermolecular or intramolecular interaction and depending on the type, the observed broadening and energy shifts would be different. If the NMR solution is diluted (in the present case, addition of pesticidal active and aliphatic acid components), the peak corresponding to the H-bond will remain unchanged for intramolecular H-bonds as opposed to an expected observed shift of the peak to lower frequency in the case of intermolecular H-bonds. Also, a broadening of the peak will be observed for intermolecular H-bonding. Such observations are explained, for example, in Breitmaier, E. Structure Elucidation by NMR in Organic Chemistry; Wiley: Chichester, 2002.

FIGS. 12A, 12B, 12C, and 12D (collectively and individually “FIG. 12”) illustrate proton NMR (¹H-NMR) spectra of an exemplary synergistic pesticidal complex composition (shown in dotted lines and individually in FIG. 12D) according to an embodiment of the invention, the synergistic pesticidal complex composition comprising spinosyn A as a representative spinosyn pesticidal active ingredient, and octanoic acid as a representative C4-C10 aliphatic acid, overlaid with ¹H-NMR spectra of each of the spinosyn A (shown in dotted/dashed lines and individually in FIG. 12B) and octanoic acid (shown in solid lines and individually in FIG. 12C) components of the synergistic pesticidal complex composition alone. The peak appearing at 11.9 ppm in the spectra for octanoic acid in FIG. 12C is shifted and broadened in FIG. 12D, corresponding to the H-bond between the spinosyn A pesticidal active ingredient, and the octanoic acid that forms the exemplary synergistic pesticidal complex. Magnification of this peak will show the visualization represented as FIG. 13.

FIG. 13 illustrates an enlarged portion of the proton NMR (¹H-NMR) spectra of an exemplary synergistic pesticidal complex composition (shown in dotted lines and individually in FIG. 13D) according to an embodiment of the invention, the synergistic pesticidal complex composition comprising spinosyn A as a representative spinosyn pesticidal active ingredient, and octanoic acid as a representative C4-C10 aliphatic acid, overlaid with ¹H-NMR spectra of each of the spinosyn A (shown in dotted/dashed lines and individually in FIG. 13B) and octanoic acid (shown in solid lines and individually in FIG. 13C) components of the synergistic pesticidal complex composition alone, showing a lower-frequency shifted and broadened peak in the spectra of the synergistic pesticidal complex composition, relative to the octanoic acid component alone, identifying an intermolecular hydrogen bond between the spinosyn A and octanoic acid components of the synergistic pesticidal complex composition. As shown in FIG. 13, the peak is broadened and shifted to lower frequency which confirms the presence of the intermolecular H-bond forming the synergistic pesticidal complex between the spinosyn A and the octanoic acid (dotted peak vs solid peak).

FIG. 14 illustrates ¹H-NMR spectra of an exemplary synergistic pesticidal complex composition according to an embodiment of the invention. The synergistic pesticidal complex composition comprises glyphosate as a representative synthase inhibitor (and particularly as a representative class 9 EPSP synthase inhibitor) pesticidal active ingredient 1410; NMR spectra 1411 for glyphosate alone is shown in the top chart. The synergistic pesticidal complex composition further comprises trans-3-Hexenoic acid as a representative C4-C10 aliphatic acid 1420; NMR spectra 1421 for trans-3-Hexenoic acid alone is shown in the middle chart. A complex 1430 of glyphosate and trans-3-Hexenoic acid was simulated as described above, i.e. based on B3LYP modelling using triple-zeta 6-311+G** basis sets. The simulated complex 1430 formed two H-bonds, one having distance 1.66 Å between a phosphate hydroxyl hydrogen 1414 of glyphosate and a carboxyl oxygen 1424 of trans-3-Hexenoic acid and another having distance 1.70 Å between a phosphate oxygen 1415 of glyphosate and a hydroxyl hydrogen 1422 of trans-3-Hexenoic acid, as shown in the corresponding chemical structure illustrations of FIG. 14. NMR spectra 1431 for complex 1430 is shown in the bottom chart. The formation of the depicted H-bonds causes the corresponding shift to lower frequencies for the hydroxyl hydrogens 1412, 1414 of glyphosate and the hydroxyl hydrogen 1422 of trans-3-Hexenoic acid 14. This can be seen in the charts as a shift from 3.02 ppm (at peak 1416) to 6.03 ppm (at peak 1436) for at least one of the relevant glyphosate hydrogens 1412, 1414 and from 5.52 ppm (at peak 1426) to 10.83 ppm (at peak 1438) for the relevant trans-3-Hexenoic acid hydrogen 1422. These simulated results for one exemplary synergistic pesticidal complex composition correspond generally to the shifts in NMR spectra observed in experimental measurements associated with FIGS. 12 and 13 as described above for a second exemplary synergistic pesticidal complex composition.

In some embodiments, the pesticidal composition comprises a complex having at least one hydrogen bond between the complex constituents (e.g. a pesticidal active ingredient and a C4-C10 saturated or unsaturated aliphatic acid or an agriculturally compatible salt thereof, as described elsewhere herein). The complex has a ¹H-NMR spectrum comprising a peak corresponding to a hydrogen atom of a constituent of the complex. In at least some embodiments, the peak is shifted to a lower frequency by the formation of the hydrogen bond. That is, the peak is shifted to a lower frequency relative to a reference peak of a ¹H-NMR spectrum of the constituent when not in the complex, where the reference peak also corresponds to the hydrogren atom. In some embodiments, the peak is shifted by at least a threshold amount relative to the reference peak. The threshold amount may be an absolute value, such as, for example, 0.1 ppm, 0.2 ppm, 0.3 ppm, 0.4 ppm, 0.5 ppm, 0.6 ppm, 0.7 ppm, 0.8 ppm, 0.9 ppm, 1 ppm, 1.5 ppm, 2 ppm, 3 ppm, 4 ppm, 5 ppm, 6 ppm, 7 ppm, 8 ppm, 9 ppm, and/or 10 ppm. The threshold amount may be a relative value, such as, for example, 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, and/or 100% (and/or any value therebetween) of a frequency of the reference peak.

In some embodiments, the pesticidal composition may comprise a C12 unsaturated aliphatic acid or agriculturally compatible salt thereof. In another aspect, without being bound to any particular theory, it is believed that the one or more C4-C10 saturated or unsaturated aliphatic acids, or agriculturally acceptable salts thereof, (and in some additional embodiments, alternatively a C11 or C12 unsaturated or saturated aliphatic acid or agriculturally compatible salt thereof) can, according to some embodiments of the present disclosure, act as at least one of a potentiator, synergist, adjuvant and/or agonist when combined with a suitable pesticidal active ingredient, thereby desirably providing for a synergistic activity of such a synergistic pesticidal composition against a target pest or pathogen.

In some embodiments according to the present disclosure, a synergistic pesticidal composition accordingly to the present invention comprises one or more C4-C10 saturated or unsaturated aliphatic acid, or agriculturally acceptable salts thereof (and in some additional embodiments, alternatively a C11 or C12 unsaturated or saturated aliphatic acid or agriculturally compatible salt thereof), as an exemplary cell permeabilizing agent, in combination with a pesticide. In some embodiments, the synergistic composition comprises one or more C4-C10 saturated or unsaturated aliphatic acid (or agriculturally acceptable salt thereof), as an exemplary cell permeabilizing agent, in combination with a fungicide. In some embodiments, the synergistic composition comprises one or more C4-C10 saturated or unsaturated aliphatic acid (or agriculturally acceptable salt thereof), as an exemplary cell permeabilizing agent, in combination with a nematicide. In some embodiments, the synergistic composition comprises one or more C4-C10 saturated or unsaturated aliphatic acid (or agriculturally acceptable salt thereof), as an exemplary cell permeabilizing agent, in combination with an insecticide.

In one such embodiment, without being bound to a particular theory, it is believed that the one or more C4-C10 saturated or unsaturated aliphatic acid (and in some additional embodiments, alternatively a C11 or C12 unsaturated or saturated aliphatic acid or agriculturally compatible salt thereof) may act as a cellular membrane delivery agent, so as to improve the entry of and/or bioavailability or systemic distribution of a pesticidal active ingredient within a target pest cell and/or within a pest intracellular organelle, such as by facilitating the pesticidal active ingredient in passing into the mitochondria of the pest cells, for example. In some other embodiments, without being bound by a particular theory, the one or more C4-C10 saturated or unsaturated aliphatic acid may further provide for synergistic interaction with one or more additional compounds provided as part of the pesticidal composition, such as an additional one or more C4-C10 saturated aliphatic acid, or one or more C4-C10 unsaturated aliphatic acid, or one or more additional active ingredients or adjuvants, so as to provide for synergistic enhancement of a pesticidal effect provided by the at least one pesticidal active ingredient, for example.

In another aspect, without being bound to any particular theory, it is believed that the one or more C4-C10 saturated or unsaturated aliphatic acids (or agriculturally acceptable salts thereof) according to some embodiments of the present disclosure act as at least one of a potentiator, synergist, adjuvant and/or agonist when combined with a suitable pesticidal ingredient, thereby desirably providing for a synergistic activity of such a synergistic pesticidal composition against a target pest or pathogen. In some additional embodiments, such synergistic pesticidal composition may alternatively comprise a C11 or C12 unsaturated or saturated aliphatic acid or agriculturally compatible salt thereof.

Without being bound by any particular theory, in some embodiments of the present invention, it is believed that the one or more C4-C10 saturated or unsaturated aliphatic acids act to compromise or alter the integrity of the lipid bilayer and protein organization of cellular membranes in target pest organisms. Further, it is also believed that in some embodiments one or more C4-C10 saturated or unsaturated aliphatic acids are particularly adapted for combination to form synergistic pesticidal compositions according to embodiments of the invention, which demonstrate synergistic efficacy, with pesticidal actives having a pesticidal mode of action that is dependent upon interaction with one or more components of the cellular membrane of a target pest. In some such embodiments, one or more C4-C10 saturated or unsaturated aliphatic acids may be particularly adapted for combining to form a synergistic pesticidal composition, demonstrating synergistic efficacy, with pesticidal actives which have a mode of action dependent on interaction with a cellular membrane protein. In one such embodiment, the cellular membrane protein may comprise one or more cytochrome complexes, such as a cytochrome bel complex or a cytochrome p450 complex, for example. Accordingly, in one aspect, synergistic pesticidal compositions according to some embodiments of the present invention may desirably be selected to comprise one or more C4-C10 saturated or unsaturated aliphatic acids, and one or more pesticidal active having a pesticidal mode of action that is dependent upon interaction with one or more components of the cellular membrane of a target pest, such as a cellular membrane protein, for example. In one aspect, one or more C11 or C12 saturated or unsaturated aliphatic acids is provided in combination with one or more pesticidal active having a pesticidal mode of action that is dependent upon interaction with one or more components of the cellular membrane of a target pest, such as a cellular membrane protein, for example. In a particular embodiment, one or more C4-C10 saturated or unsaturated aliphatic acids are particularly adapted for combination to form synergistic pesticidal compositions according to embodiments of the invention, which demonstrate synergistic efficacy, with pesticidal actives having a pesticidal mode of action interacting with (such as by inhibiting one or more receptor sites) the cellular membrane cytochrome be 1 complex (also known as the cytochrome complex III), such as fungicidal actives collectively referred to as Group 11 actives by the Fungicide Resistance Action Committee (FRAC), including e.g. azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl trifloxystrobin, dimoxystrobin, fenaminstrobin, metominostrobin, orysastrobin, famoxadone, fluoxastrobin, fenamidone, or pyribencar. In one such embodiment, a synergistic pesticidal composition may be selected comprising one or more C4-C10 saturated or unsaturated aliphatic acid and a pesticidal active having a pesticidal mode of action interacting with the cellular cytochrome bel complex, such as a strobilurin pesticidal active. In alternative such embodiments, the synergistic pesticidal composition comprises one or more C11 or C12 saturated or unsaturated aliphatic acids.

In another particular embodiment, one or more C4-C10 saturated or unsaturated aliphatic acids are particularly adapted for combination to form synergistic pesticidal compositions according to embodiments of the invention, which demonstrate synergistic efficacy, with pesticidal actives having a pesticidal mode of action interacting with (such as by inhibiting one or more receptor sites) the cellular membrane cytochrome p450 complex, such as to inhibit sterol biosynthesis, as is the case with exemplary fungicidal actives collectively referred to as FRAC Group 3 actives, including e.g. triforine, pyrifenox, pyrisoxazole, fenarimol, nuarimol, imazalil, oxpoconazole, pefurazoate, prochloraz, triflumizole, azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, or prothioconazole. In one such embodiment, a synergistic pesticidal composition may be selected comprising one or more C4-C10 saturated or unsaturated aliphatic acid and a pesticidal active having a pesticidal mode of action interacting with the cellular cytochrome p450 complex, such as an azole or triazole pesticidal active, for example. In alternative such embodiments, the synergistic pesticidal composition comprises one or more C11 or C12 saturated or unsaturated aliphatic acids.

In another particular embodiment, one or more C4-C10 saturated or unsaturated aliphatic acids are particularly adapted for combination to form synergistic pesticidal compositions according to embodiments of the invention, which demonstrate synergistic efficacy, with pesticidal actives having a pesticidal mode of action interacting with (such as by inhibiting one or more receptor sites) the cellular membrane, such as to uncouple oxidative phosphorylation, as is the case with exemplary insecticidal actives collectively referred to as Group 13 actives by the Insecticide Resistance Action Committee (IRAC), including e.g. quinoxyfen or proquinazid. In one such embodiment, a synergistic pesticidal composition may be selected comprising one or more C4-C10 saturated or unsaturated aliphatic acid and a pesticidal active having a pesticidal mode of action interacting with the cellular membrane, such as a pyrrole insecticidal active, an example of which is chlorfenapyr. In alternative such embodiments, the synergistic pesticidal composition comprises one or more C11 or C12 saturated or unsaturated aliphatic acids.

In another particular embodiment, one or more C4-C10 saturated or unsaturated aliphatic acids are particularly adapted for combination to form synergistic pesticidal compositions according to embodiments of the invention, which demonstrate synergistic efficacy, with pesticidal actives having a pesticidal mode of action interacting with (such as by disrupting and/or allosterically modulating one or more receptor sites) the cellular membrane, such as to disrupt one or more nicotinic acetylcholine receptor sites (such as Site 1), as is the case with exemplary insecticidal actives collectively referred to as Group 5 actives by the Insecticide Resistance Action Committee (IRAC). Such IRAC Group 5 actives include, for example: spinosyn (including but not limited to spinosyns A, D, B, C, E, F, G, H, J, and other spinosyn isolates from Saccharopolyspora spinosa culture), spinosad (comprising primarily spinsyns A and D), and derivatives or substituents thereof (including but not limited to tetracyclic and pentacyclic spinosyn derivatives, aziridine spinosyn derivatives, C-5,6 and/or C-13,14 substituted spinosyn derivatives); spinetoram (including but not limited to XDE-175-J, XDE-175-L or other O-ethyl substituted spinosyn derivatives); butenyl-spinosyn and derivatives or substituents thereof (such as isolates from Saccharopolyspora pogona culture). In one such embodiment, a synergistic pesticidal composition may be selected comprising one or more C4-C10 saturated or unsaturated aliphatic acid and a pesticidal active having a pesticidal mode of action interacting with the cellular membrane, such as a spinosyn or spinosyn derivative insecticidal active, examples of which may include Spinosad and spinetoram. In alternative such embodiments, the synergistic pesticidal composition may comprise one or more C11 or C12 saturated or unsaturated aliphatic acids, substituents, or salts thereof.

Without being bound by any particular theory, in some further embodiments of the present invention, it is believed that one or more C4-C10 saturated or unsaturated aliphatic acids act to compromise or alter the integrity of the lipid bilayer and protein organization of cellular membranes in target pest organisms, and by so doing are effective to increase at least one of the fluidity and permeability of a cellular membrane of a target pest organism, which may desirably increase permeability and/or transport of a pesticidal active through the cellular membrane, for example. Further, it is also believed that in some embodiments one or more C4-C10 saturated or unsaturated aliphatic acids are particularly adapted for combination to form synergistic pesticidal compositions according to embodiments of the invention, which demonstrate synergistic efficacy, with pesticidal actives having a pesticidal mode of action that is dependent upon transport across one or more cellular membrane of a target pest, such as to interact with a target site inside a cell or an intracellular organelle of the target pest. In some such embodiments, a synergistic pesticidal composition according to an embodiment of the present invention, demonstrating synergistic efficacy, may comprise one or more C4-C10 saturated or unsaturated aliphatic acid, and one or more pesticidal active having a mode of action dependent on transport across a cellular membrane. Accordingly, in one aspect, synergistic pesticidal compositions according to some embodiments of the present invention may desirably be selected to comprise one or more C4-C10 saturated or unsaturated aliphatic acids, and one or more pesticidal active having a pesticidal mode of action that is dependent upon interaction with a target site within a cell or intracellular organelle of a target pest, such as a cellular membrane protein, for example. In alternative such embodiments, the synergistic pesticidal composition comprises one or more C11 or C12 saturated or unsaturated aliphatic acids.

In a particular embodiment, one or more C4-C10 saturated or unsaturated aliphatic acids are particularly adapted for combination to form synergistic pesticidal compositions according to embodiments of the invention, which demonstrate synergistic efficacy, with pesticidal actives having a pesticidal mode of action interacting with (such as by inhibiting one or more receptors) at a target site across a cellular membrane of a target pest, such as fungicidal actives collectively referred to as FRAC Group 9 and Group 12 actives, for example, including e.g. cyprodinil, mepanipyrim, pyrimethanil, fenpiclonil or fludioxonil.

In one such embodiment, a synergistic pesticidal composition may be selected comprising one or more C4-C10 saturated or unsaturated aliphatic acid and a pesticidal active having a pesticidal mode of action interacting with a target site within a cellular membrane of a target pest, such as one or more of an anilinopyrimidine such as cyprodinil, and a phenylpyrrole such as fludioxonil, for example. In alternative such embodiments, the synergistic pesticidal composition comprises one or more C11 or C12 saturated or unsaturated aliphatic acids.

Without being bound by any particular theory, in some yet further embodiments of the present invention, it is believed that one or more C4-C10 saturated or unsaturated aliphatic acids act to compromise or alter the integrity of the lipid bilayer and protein organization of cellular membranes in target pest organisms, and by so doing are effective to increase at least one of the fluidity and permeability of a cellular membrane of a target pest organism, which may desirably increase permeability and/or transport of a pesticidal active through the cellular membrane, for example. Further, it is also believed that in some alternative embodiments one or more C4-C10 unsaturated aliphatic acids having unsaturated C—C bonds at one or more of the second (2-), third (3-) and terminal ((n−1)−) locations in the aliphatic acid carbon chain may be desirably adapted for combination to form synergistic pesticidal compositions according to embodiments of the invention, which demonstrate synergistic efficacy, with pesticidal actives. In some particular such embodiments, one or more C4-C10 aliphatic acids comprising an unsaturated C—C bond at one or more of the 2-,3- and (n−1)-locations (wherein n is the number of carbons in the unsaturated aliphatic acid) may desirably be adapted for forming synergistic pesticidal compositions in combination with one or more pesticidal active having a pesticidal mode of action that is dependent upon interaction with a cellular membrane component of a target pest, or dependent upon transport across one or more cellular membrane of a target pest (such as to interact with a target site inside a cell or an intracellular organelle of the target pest). In some such embodiments, a synergistic pesticidal composition according to an embodiment of the present invention, demonstrating synergistic efficacy, may comprise one or more C4-C10 unsaturated aliphatic acid having an unsaturated C—C bond at one or more of the 2-, 3- and terminal ((n−1)−) locations in the aliphatic acid carbon chain, and one or more pesticidal active having a mode of action dependent on interaction with a target pest cellular membrane component, or on transport across a target pest cellular membrane. In alternative such embodiments, the synergistic pesticidal composition comprises one or more C11 or C12 unsaturated aliphatic acids having an unsaturated C—C bond at one or more of the 2-, 3- and terminal ((n−1)−).

In some embodiments, the one or more C4-C10 saturated or unsaturated aliphatic acid (or agriculturally acceptable salt thereof) comprises an aliphatic carbonyl alkene. In some embodiments, the one or more C4-C10 saturated or unsaturated aliphatic acid (or agriculturally acceptable salt thereof) comprises at least one C4-C10 unsaturated aliphatic acid having at least one carboxylic group and at least one unsaturated C—C bond. In another embodiment, the C4-C10 unsaturated aliphatic acid (or agriculturally acceptable salt thereof) comprises at least two C4-C10 unsaturated aliphatic acids having at least one carboxylic group and at least one unsaturated C—C bond. In yet another embodiment, the C4-C10 unsaturated aliphatic acid (or agriculturally acceptable salt thereof) comprises at least one carboxylic acid group and at least one of a double or triple C—C bond. In a further embodiment, a synergistic pesticidal composition is provided comprising at least one pesticidal active ingredient, and at least one C4-C10 unsaturated aliphatic acid (or agriculturally acceptable salt thereof) having at least one carboxylic acid group and at least one unsaturated C—C bond, in combination with at least one C4-C10 saturated aliphatic acid (or agriculturally acceptable salt thereof). In yet another embodiment, the C4-C10 saturated or unsaturated aliphatic acid may be provided as a plant extract or oil, or fraction thereof, containing the at least one C4-C10 saturated or unsaturated aliphatic acid, for example, or in further embodiments, containing the one or more C11 or C12 saturated or unsaturated aliphatic acid.

In some embodiments, the one or more C4-C10 saturated or unsaturated aliphatic acid (or agriculturally acceptable salt thereof) comprises an aliphatic carbonyl alkene having one of the general structures (1), (2) or (3), as shown in FIG. 1. In further embodiments, the one or more C4-C10 saturated or unsaturated aliphatic acid may additionally comprise a C11 or C12 saturated or unsaturated aliphatic acid, and may comprise an aliphatic carbonyl alkene having one of the general structures (1), (2) or (3) as shown in FIG. 1. In some embodiments, the C4-C10 (or alternatively C11 or C12) saturated or unsaturated aliphatic acid may additionally comprise at least one substituent selected from the list comprising: hydroxy, alkyl and amino substituents. In some exemplary embodiments, the at least one substituent may comprise at least one of: 2-hydroxy, 3-hydroxy, 4-hydroxy, 8-hydroxy, 10-hydroxy, 12-hydroxy, 2-methyl, 3-methyl, 4-methyl, 2-ethyl, 3-ethyl, 4-ethyl, 2,2-diethyl, 2-amino, 3-amino, and 4-amino substituents, for example. In some embodiments, the C4-C10 (or alternatively C11 or C12) saturated or unsaturated aliphatic acid may comprise an agriculturally acceptable salt form of any of the above-mentioned aliphatic acids.

In some embodiments, the composition comprises one or more C4-C10 saturated or unsaturated aliphatic acid (or agriculturally acceptable salt thereof) and a fungicidal active ingredient. In some embodiments, the effective dose of the fungicidal active ingredient when used in combination with the one or more C4-C10 saturated or unsaturated aliphatic acid is lower than the effective dose of the fungicidal active ingredient when used alone (i.e. a smaller amount of fungicidal active can still control fungi when used in a composition together with the one or more C4-C10 saturated or unsaturated aliphatic acid). In some embodiments, a fungicidal active ingredient that is not effective against a particular species of fungi (such as at a particular concentration that is below a lower limit of efficacy for a particular fungi, or for a particular species of fungi which may be at least partially resistant or tolerant to the particular fungicidal active ingredient when applied alone) can be made effective against that particular species when used in a composition together with one or more C4-C10 saturated or unsaturated aliphatic acid, or in further embodiments, with one or more C11 or C12 saturated or unsaturated aliphatic acid.

In some embodiments, the composition comprises one or more C4-C10 saturated or unsaturated aliphatic acid (or agriculturally acceptable salt thereof) and a nematicidal active ingredient. In some embodiments, the effective dose of the nematicidal active ingredient when used in combination with the one or more C4-C10 saturated or unsaturated aliphatic acid is lower than the effective dose of the nematicidal active ingredient when used alone (i.e. a smaller amount of nematicidal active can still control nematodes when used in a composition together with the one or more C4-C10 saturated or unsaturated aliphatic acid). In some embodiments, a nematicidal active ingredient that is not effective against a particular species of nematode (such as at a particular concentration that is below a lower limit of efficacy for a particular nematode, or for a particular species of nematode which may be at least partially resistant or tolerant to the particular nematicidal active ingredient when applied alone) can be made effective against that particular species when used in a composition together with one or more C4-C10 saturated or unsaturated aliphatic acid, or in further embodiments, with one or more C11 or C12 saturated or unsaturated aliphatic acid.

In some embodiments, the composition comprises one or more C4-C10 saturated or unsaturated aliphatic acid (or agriculturally acceptable salt thereof) and an insecticidal active ingredient. In some embodiments, the effective dose of the insecticidal active ingredient when used in combination with the one or more C4-C10 saturated or unsaturated aliphatic acid is lower than the effective dose of the insecticidal active ingredient when used alone (i.e. a smaller amount of insecticidal active can still control insects, to an exemplary desired degree of control, when used in a composition together with the one or more C4-C10 saturated or unsaturated aliphatic acid). In some embodiments, the aliphatic acid may further comprise one or more C11 or C12 saturated or unsaturated aliphatic acid. In some embodiments, an insecticidal active ingredient that is not effective against a particular species of insect (such as at a particular concentration that is below a lower limit of efficacy for a particular insect, or for a particular species of insect which may be at least partially resistant or tolerant to the particular insecticidal active ingredient when applied alone) can be made effective against that particular species when used in a composition together with one or more C4-C10 saturated or unsaturated aliphatic acid, or in further embodiments, with one or more C11 or C12 saturated or unsaturated aliphatic acid. In further embodiments, the one or more C4-C10 saturated or unsaturated aliphatic acid (or in further embodiments, with one or more C11 or C12 saturated or unsaturated aliphatic acid) may desirably provide for a synergistic increased efficacy of at least one of an acaricidal, molluscicidal, bactericidal or virucidal active ingredient such that the composition is pesticidally effective against one or more of an acari, mollusk, bacterial or viral pest, for example.

In some embodiments, a pesticidal composition is provided comprising at least one C4-C10 saturated or unsaturated aliphatic acid (or in some further embodiments at least one C11 or C12 saturated or unsaturated aliphatic acid) and an insecticidal pesticidal active ingredient, comprising at least one nicotinic acetylcholine receptor disruptors. In one such embodiment, the insecticidal active ingredient may comprise at least one or more of: a spinosyn (including but not limited to spinosyns A, D, B, C, E, F, G, H, J, and other spinosyn isolates from Saccharopolyspora spinosa culture), spinosad (comprising primarily spinsyns A and D), and derivatives or substituents thereof (including but not limited to tetracyclic and pentacyclic spinosyn derivatives, aziridine spinosyn derivatives, C-5,6 and/or C-13,14 substituted spinosyn derivatives); a spinetoram (including but not limited to XDE-175-J and XDE-175-L); and a butenyl-spinosyn and derivatives or substituents thereof (such as isolates from Saccharopolyspora pogona culture). In a particular such embodiment, a pesticidal composition is provided, comprising at least one C4-C10 saturated or unsaturated aliphatic acid (or in some further embodiments at least one C11 or C12 saturated or unsaturated apliphatic acid) and at least one of spinosyn A and spinosyn D. In a further such embodiment, the at least one spinosyn comprises spinosad. In some embodiments, the pesticidal composition comprises a synergistic pesticidal composition. In some particular embodiments, the synergistic pesticidal composition desirably provides a synergistic efficacy to control at least one insect pest.

In some further embodiments, a method of reducing a risk of resistance of at least one target pest to at least one pesticidal active ingredient is provided, the method comprising:
selecting at least one C4-C10 saturated or unsaturated aliphatic acid, or suitable salt thereof, which when applied to said at least one target pest as a pesticidal composition comprising said at least one pesticidal active ingredient and said at least one C4-C10 saturated or unsaturated aliphatic acid, or suitable salt thereof, is effective to provide a synergistic efficacy against said at least one target pest, relative to the application of said at least one pesticidal active ingredient alone; and

applying said at least one pesticidal composition to a locus proximate to said at least one target pest.

In some embodiments, the at least one C4-C10 saturated or unsaturated aliphatic acid, or in further embodiments, with one or more C11 or C12 saturated or unsaturated aliphatic acid, may comprise a naturally occurring aliphatic acid, such as may be present in, or extracted, fractionated or derived from a natural plant or animal material, for example. In one such embodiment, the at least one C4-C10 saturated or unsaturated aliphatic acid may comprise one or more naturally occurring aliphatic acids provided in a plant extract or fraction thereof. In another such embodiment, the at least one C4-C10 saturated or unsaturated aliphatic acid may comprise one or more naturally occurring aliphatic acids provided in an animal extract or product, or fraction thereof. In one such embodiment, the at least one C4-C10 saturated or unsaturated alphatic acid may comprise a naturally occurring aliphatic acid comprised in a plant oil extract, such as one or more of coconut oil, palm oil, palm kernel oil, corn oil, or fractions or extracts therefrom. In another such embodiment, the at least one C4-C10 saturated or unsaturated alphatic acid may comprise a naturally occurring aliphatic acid comprised in an animal extract or product, such as one or more of cow's milk, goat's milk, beef tallow, and/or cow or goat butter, or fractions or extracts thereof for example. In a particular embodiment, at least one C4-C10 saturated or unsaturated aliphatic acid may be provided as a component of one or more natural plant or animal material, or extract or fraction thereof. In a particular such embodiment, at least one C4-C10 saturated aliphatic acid may be provided in an extract or fraction of one or more plant oil extract, such as one or more of coconut oil, palm oil, palm kernel oil, corn oil, or fractions or extracts therefrom.

In some embodiments, an emulsifier or other surfactant may be used in preparing pesticidal compositions according to aspects of the present disclosure. Suitable surfactants can be selected by one skilled in the art. Examples of surfactants that can be used in some embodiments of the present disclosure include, but are not limited to sodium lauryl sulfate, saponin, ethoxylated alcohols, ethoxylated fatty esters, alkoxylated glycols, ethoxylated fatty acids, ethoxylated castor oil, glyceryl oleates, carboxylated alcohols, carboxylic acids, ethoxylated alkylphenols, fatty esters, sodium dodecylsulfide, other natural or synthetic surfactants, and combinations thereof. In some embodiments, the surfactant(s) are non-ionic surfactants. In some embodiments, the surfactant(s) are cationic or anionic surfactants. In some embodiments, a surfactant may comprise two or more surface active agents used in combination. The selection of an appropriate surfactant depends upon the relevant applications and conditions of use, and selection of appropriate surfactants are known to those skilled in the art.

In one aspect, a pesticidal composition according to some embodiments of the present disclosure comprises one or more suitable carrier or diluent component. A suitable carrier or diluent component can be selected by one skilled in the art, depending on the particular application desired and the conditions of use of the composition. Commonly used carriers and diluents may include ethanol, isopropanol, isopropyl myristate, other alcohols, water and other inert carriers, such as but not limited to those listed by the EPA as a Minimal Risk Inert Pesticide Ingredients (4A) (the list of ingredients published dated December 2015 by the US EPA FIFRA 4a list published August 2004 entitled “List 4A—Minimal Risk Inert Ingredients”) or, for example, Inert Pesticide Ingredients (4B) (the US EPA FIFRA 4b list published August 2004 entitled “List 4B—Other ingredients for which EPA has sufficient information”) or under EPA regulation 40 CFR 180.950 dated May 24, 2002, each of which is hereby incorporated herein in its entirety for all purposes including for example, citric acid, lactic acid, glycerol, castor oil, benzoic acid, carbonic acid, ethoxylated alcohols, ethoxylated amides, glycerides, benzene, butanol, 1-propanol, hexanol, other alcohols, dimethyl ether, and polyethylene glycol.

In one embodiment according to the present disclosure, a method of enhancing the efficacy of a pesticide is provided. In one aspect, a method of enhancing the efficacy of a fungicide is provided. In another aspect, a method of enhancing the efficacy of a nematicide is provided. In a further aspect, a method of enhancing the efficacy of an insecticide is provided.

In one such embodiment, the method comprises providing a synergistic pesticidal composition comprising a pesticidal active ingredient and at least one C4-C10 saturated or unsaturated aliphatic acid (or in further embodiments, with one or more C11 or C12 saturated or unsaturated aliphatic acid) and exposing a pest to the resulting synergistic composition. In a particular exemplary embodiment, without being bound by any particular theory, the at least one C4-C10 saturated or unsaturated aliphatic acid may desirably be functional as a cell permeabilizing or cell membrane disturbing agent. In one aspect, the method comprises providing a fungicidal composition comprising a fungicidal active ingredient and at least one C4-C10 saturated or unsaturated aliphatic acid and exposing a fungus to the resulting synergistic composition. In another aspect, the method comprises providing a nematicidal composition comprising a nematicidal active ingredient and at least one C4-C10 saturated or unsaturated aliphatic acid and exposing a nematode to the resulting synergistic composition. In a further aspect, the method comprises providing an insecticidal composition comprising an insecticidal active ingredient and at least one C4-C10 saturated or unsaturated aliphatic acid and exposing an insect to the resulting synergistic composition.

In one embodiment according to the present disclosure, the at least one C4-C10 saturated or unsaturated aliphatic acid (or in further embodiments, with one or more C11 or C12 saturated or unsaturated aliphatic acid) provided in a pesticidal composition comprises an unsaturated aliphatic carbonyl alkene. In a particular such embodiment, without being bound by any particular theory, the at least one C4-C10 unsaturated aliphatic acid may desirably be functional as a cell permeabilizing or cell membrane disturbing agent. In one such embodiment, the cell permeabilizing agent comprises a carbonyl alkene having the general structure 110, 120, 130, 140, 150, 160, and/or 170, as shown in FIG. 1. In a further embodiment, the cell permeabilizing agent comprises at least one unsaturated aliphatic acid comprising at least one carboxylic group and having at least one unsaturated C—C bond.

In one exemplary embodiment, a method comprises providing a synergistic pesticidal composition comprising a pesticidal active ingredient and at least one C4-C10 saturated or unsaturated aliphatic acid (or in further embodiments, with one or more C11 or C12 saturated or unsaturated aliphatic acid) which is functional as a cell permeabilizing agent, and exposing a pest to the synergistic pesticidal composition to increase the amount of the pesticidal active ingredient that enters cells of the pest. In some such embodiments, the pesticidal active is a fungicide and the pest is a fungus, and without being bound by a particular theory, the at least one C4-C10 saturated or unsaturated aliphatic acid cell permeabilizing agent allows the fungicide to pass more easily through the fungal cell walls and membranes, and/or intracellular membranes. In some such embodiments, the pesticide is a nematicide and the pest is a nematode, and without being bound by a particular theory, the at least one C4-C10 saturated or unsaturated aliphatic acid cell permeabilizing agent allows the nematicide to pass more easily through the nematode cell and intracellular membranes. In some such embodiments, the pesticide is an insecticide, and without being bound by a particular theory, the at least one C4-C10 saturated or unsaturated aliphatic acid cell permeabilizing agent allows the insecticide to pass more easily through insect cuticle, chitin membrane, or cell or intracellular membranes.

In some embodiments, in addition to the actual synergistic action with respect to pesticidal activity, certain synergistic pesticidal compositions according to embodiments of the present disclosure can also desirably have further surprising advantageous properties. Examples of such additional advantageous properties may comprise one or more of: more advantageous degradability in the environment; improved toxicological and/or ecotoxicological behaviour such as reduced aquatic toxicity or toxicity to beneficial insects, for example.

In a further aspect, for any of the embodiments described above or below providing for a synergistic pesticidal composition comprising at least one pesticidal active and one or more C4-C10 saturated or unsaturated aliphatic acid or salt thereof, in an alternative embodiment, the synergistic pesticidal composition may alternatively comprise at least one pesticidal active and one or more C11 saturated or unsaturated aliphatic acid or salt thereof. In another aspect, for any of the embodiments described above providing for a synergistic pesticidal composition comprising at least one pesticidal active and one or more C4-C10 saturated or unsaturated aliphatic acid or salt thereof, in an alternative embodiment, the synergistic pesticidal composition may alternatively comprise at least one pesticidal active and one or more C12 saturated or unsaturated aliphatic acid or salt thereof.

### Experimental Methods

In accordance with an embodiment of the present disclosure, the combination of at least one C4-C10 saturated or unsaturated aliphatic acid (and in some embodiments alternatively at least one C11 or C12 saturated or unsaturated aliphatic acid) and a pesticidal active ingredient produces a synergistic pesticidal composition demonstrating a synergistic pesticidal effect. In some embodiments, the synergistic action between the pesticidal active ingredient, and the at least one C4-C10 (or alternatively C11 or C12) saturated or unsaturated aliphatic acid components of the pesticidal compositions according to embodiments of the present disclosure was tested using a Synergistic Growth Inhibition Assay, which is derived from and related to a checkerboard assay as is known in the art for testing of combinations of antimicrobial agents. In the Synergistic Growth Inhibition Assay used in accordance with some embodiments of the present disclosure, multiple dilutions of combinations of pesticidal active ingredient and at least one C4-C10 saturated or unsaturated aliphatic acid agents are tested in individual cells for inhibitory activity against a target pest or pathogenic organism. In one such embodiment, the combinations of pesticidal active ingredient and C4-C10 (or alternatively C11 or C12) saturated or unsaturated aliphatic acid agents may preferably be tested in decreasing concentrations. In a further such embodiment, the combinations of pesticidal active ingredient and C4-C10 (or alternatively C11 or C12) saturated or unsaturated aliphatic acid agents may be tested in increasing concentrations. These multiple combinations of the pesticidal active ingredient and at least one C4-C10 (or alternatively C11 or C12) saturated or unsaturated aliphatic acid agents may be prepared in 96-well microtiter plates. In one such embodiment, the Synergistic Growth Inhibition Assay then comprises rows which each contain progressively decreasing concentrations of the pesticidal active ingredient and one or more C4-C10 (or alternatively C11 or C12) saturated or unsaturated aliphatic acid agents to test for the MIC of the agents in combination at which growth of the target pest or pathogen is inhibited. Thus, each well of the microtiter plate is a unique combination of the two agents, at which inhibitory efficacy of the combination against the target pest or pathogen can be determined.

A method of determining and quantifying synergistic efficacy is by calculation of the “Fractional Inhibitory Concentration Index” or FIC index, as is known in the art for determining synergy between two antibiotic agents (see for example M. J. Hall et al., “The fractional inhibitory concentration (FIC) index as a measure of synergy”, J Antimicrob Chem., 11 (5):427-433, 1983, for example). In one embodiment according to the present disclosure, for each row of microtiter cells in the Synergistic Growth Inhibition Assay, the FIC index is calculated from the lowest concentration of the pesticidal active ingredient and one or more C4-C10 saturated or unsaturated aliphatic acid agents necessary to inhibit growth of a target pest or pathogen. The FIC of each component is derived by dividing the concentration of the agent present in that well of the microtiter plate by the minimal inhibitory concentration (MIC) needed of that agent alone to inhibit growth of the target pest or pathogen. The FIC index is then the sum of these values for both agents in that well of the microtiter plate. The FIC index is calculated for each row as follows:

FIC_{index}=MICₐ/MIC_{A}+MIC_{b}/MIC_{B}

where MICₐ, MIC_{b} are the minimal inhibitory concentration (MIC) of compounds A and B, respectively, when combined in the mixture of the composition, and MIC_{A}, MIC_{B} are the MIC of compounds A and B, respectively, when used alone. Fractional inhibitory concentration indices may then used as measure of synergy. When the lowest FIC index obtained in a microtiter plate in this way is less than 1 (FIC_{index}<1), the combination of the pesticidal active ingredient and one or more C4-C10 (or alternatively C11 or C12) saturated or unsaturated aliphatic acid agents exhibits synergism, and indicates a synergistic pesticidal composition. When the FIC index is equal to 1, the combination is additive. FIC index values of greater than 4 are considered to exhibit antagonism.

In a particular embodiment, when the FIC index is equal or less than 0.5, the combination of the pesticidal active ingredient and one or more C4-C10 (or alternatively C11 or C12) saturated or unsaturated aliphatic acid agents exhibits strong synergism. For example, in one embodiment, an FIC index of 0.5 may correspond to a synergistic pesticidal composition comprising a pesticidal agent at % of its individual MIC, and one or more (or alternatively C11 or C12) C4-C10 saturated or unsaturated aliphatic acid agent at ¼ of its individual MIC.

In some embodiments of the present disclosure, the exemplary Synergistic Growth Inhibition Assay was conducted starting with an initial composition comprising a pesticidal active ingredient agent (compound A) at its individual MIC and one or more C4-C10 (or alternatively C11 or C12) saturated or unsaturated aliphatic acid agent (compound B) at its individual MIC in the first well of a row on a 96 well microtiter plate. Then, serial dilutions of these initial compositions in successive wells in the row of the microtiter plate were used to assay the pesticidal composition under the same conditions to determine the concentration of the composition combining the two agents corresponding to the microtiter well in which growth inhibition of the target pest or organism ceases. The minimal inhibitory concentrations of each individual pesticidal active ingredient agent (compound A) and each of the one or more C4-C10 saturated or unsaturated aliphatic acid agent (as compound B) were determined in parallel with the compositions combining the two agents.

In some embodiments, Fusarium oxysporum was used as a representative pest organism or pathogen to determine synergy in pesticidal compositions comprising a pesticidal active ingredient agent (compound A) and one or more C4-C10 (or alternatively C11 or C12) saturated or unsaturated aliphatic acid agent (compound B). Resazurin dye (also known as Alamar blue dye) was used as an indicator to determine the presence of growth or inhibition of growth of Fusarium oxysporum in the wells of the 96 well microtiter plates used in the exemplary Synergistic Growth Inhibition Assay. In addition to the color change of the resazurin dye in the presence of growth of the Fusarium oxysporum, an optical or visual examination of the microtiter well may also be made to additionally determine the presence of growth or inhibition of growth of the Fusarium oxysporum.

In other embodiments, Botrytis cinerea was used as a representative pest organism or pathogen to determine synergy in pesticidal compositions comprising a pesticidal active ingredient (compound A) and one or more C4-C10 (or alternatively C11 or C12) saturated or unsaturated aliphatic acid agent (compound B). Similarly to as described above, Resazurin was used as an indicator of growth or inhibition of growth of Botrytis cinerea in the exemplary Synergistic Growth Inhibition Assay. In addition to the color change of the resazurin, an optical or visual examination of the microtiter well may also be made to additionally determine the presence of growth or inhibition of growth of the Botrytis cinerea.

In further embodiments, Sclerotinia sclerotiorum was used as a representative pest organism or pathogen to determine synergy in pesticidal compositions comprising a pesticidal active ingredient (compound A) and one or more C4-C10 (or alternatively C11 or C12) saturated or unsaturated aliphatic acid agent (compound B). Similarly to as described above, Resazurin was used as an indicator of growth or inhibition of growth of Sclerotinia sclerotiorum in the exemplary Synergistic Growth Inhibition Assay. In addition to the color change of the resazurin, an optical or visual examination of the microtiter well may also be made to additionally determine the presence of growth or inhibition of growth of the Sclerotinia sclerotiorum.

Alternatively, other suitable representative pest or pathogen organisms may be used to determine synergy of combinations of pesticidal active ingredient agents and one or more C4-C10 (or alternatively C11 or C12) saturated or unsaturated aliphatic acid agents in accordance with embodiments of the present disclosure. For example, other representative fungal pathogens may be used, such as but not limited to Leptosphaeria maculans, Sclerotinia spp. and Verticillium spp. In yet other examples, suitable non-fungal representative pests or pathogens may be used, such as insect, acari, nematode, bacterial, viral, mollusc or other pests or pathogens suitable for use in an MIC growth inhibition assay test method.

All examples detailed below were tested according to the exemplary Synergistic Growth Inhibition Assay described above, using routine techniques for MIC determination known to those of skill in the art. Stock solutions of the pesticidal active ingredient agents and the one or more C4-C10 (or alternatively C11 or C12) saturated or unsaturated aliphatic acid agents were initially prepared in 100% dimethylsulfoxide (“DMSO”), and diluted to 10% DMSO using sterile potato dextrose broth (PDB) before further serial dilution to obtain the test solution concentrations for use in the microtiter plate wells, with exceptions in particular experimental examples noted in detail below. Accordingly, the maximum concentration of DMSO in the test solutions was limited to 10% DMSO or less, which was separately determined to be non-inhibitory to the growth of the representative fungal pests used in the test.

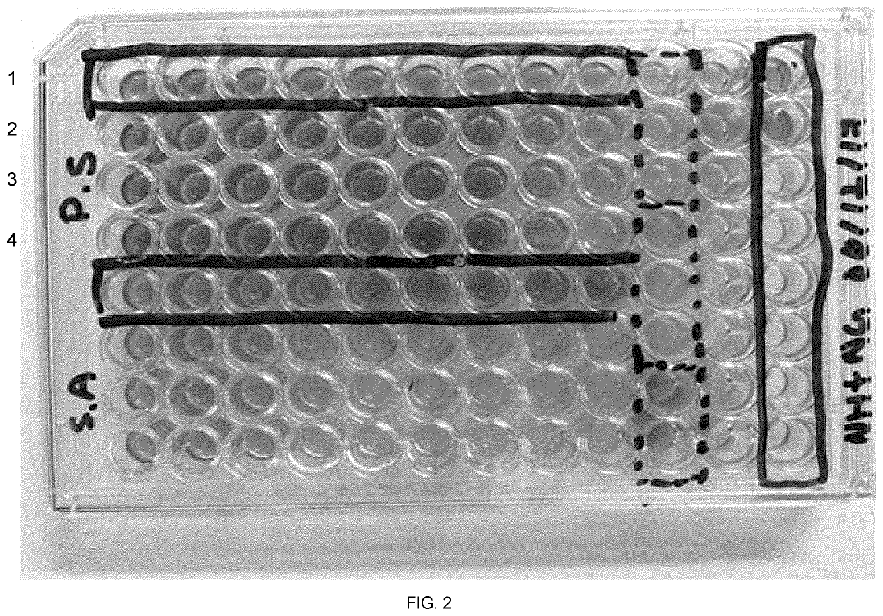

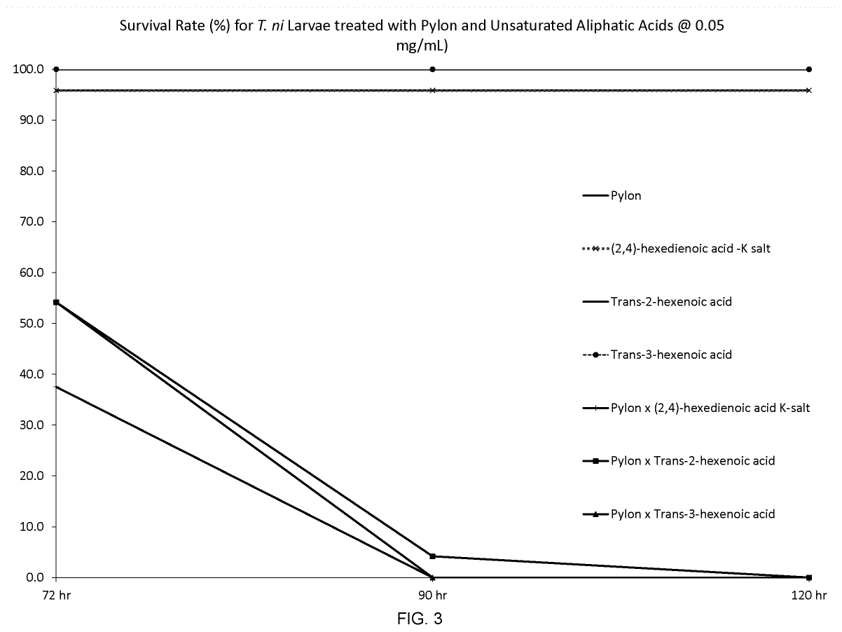

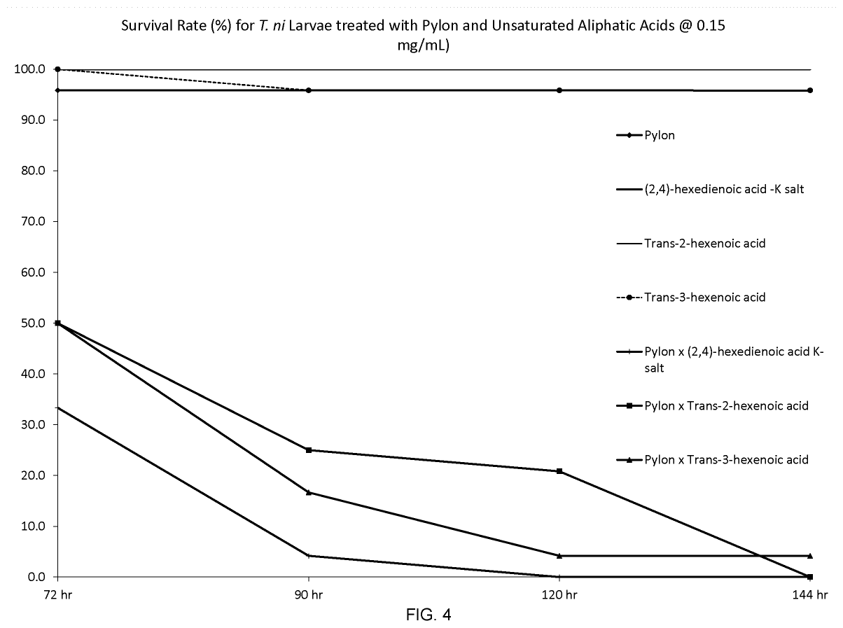

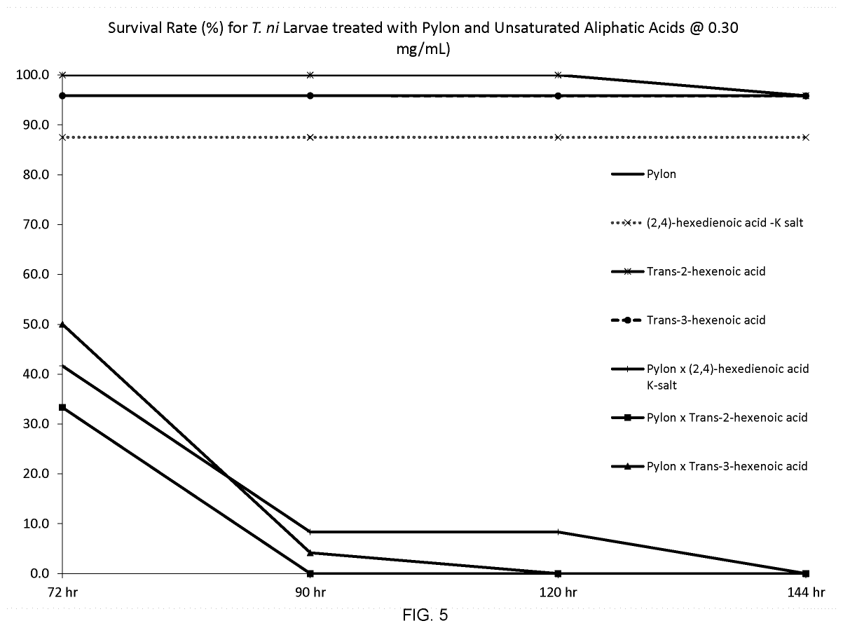

A culture of the representative fungal pathogen, namely Fusarium oxysporum, Botrytis cinerea, or Sclerotinia sclerotiorum, for example, is grown to exponential phase in potato dextrose broth (PDB). A 20 uL aliquot of homogenized mycelium from the culture is transferred to a well of a 96 well microtiter plate, and incubated for a period between 1 day and 7 days (depending on the pathogen and the particular assay reagents, as noted in the example descriptions below) with 180 uL of the test solution comprising the pesticidal and aliphatic acid agents in combination at a range of dilutions, to allow the mycelium to grow. Following the incubation period, 10 uL of resazurin dye is added to each well and the color in the solution is observed and compared to the color of the test solution at the same concentrations in wells without mycelial culture innoculum to control for effects of the test solution alone. The resazurin dye appears blue for wells with only the initial 20 uL culture where growth has been inhibited, and appears pink for wells where mycelial growth has occurred, as shown in FIG. 2, where the transition from blue to pink color can be clearly seen in each of the uppermost 4 rows of microtiter wells (labelled as 1-4 in FIG. 2) as the concentration of the pesticidal and one or more C4-C10 (or alternatively C11 or C12) saturated or unsaturated aliphatic acid agents in the test solution decreases from left to right. In addition to the color change of the resazurin dye, growth or absence of growth of the mycelial culture is also observed visually or optically.

In accordance with this assay method, the Minimum Inhibitory Concentration is the lowest concentration at which growth is inhibited, and corresponds to the microtiter well in which the dye color is the same as for the control without culture and without growth, and/or in which a visual and/or optical inspection confirm that growth is inhibited.

### Experimental Examples

Extensive experimental results have been produced for several active ingredients, such as strobilurins (e.g. azoxystrobin, pyraclostrobin, and picoxystrobin), azoles (e.g. triazoles such as tebuconazole and prothioconazole), pyrroles (e.g. chlorfenapyr and fludioxonil), spinosyns (e.g. spinosyn A and spinosad), diamides (e.g. chlorantraniliprole), and synthase inhibitors (e.g. EPSP synthase inhibitors, such as class 9 EPSP synthase inhibitors, such as glyphosate). Exemplary experimental results are provided below. Further results are presented in U.S. Provisional Application Nos. 62/956,108, 63/104,394, 62/566,269, 62/580,964, 62/737,914, 62/585,827, 62/737,907, 62/829,010, 62/829,512, and 63/063,219, PCT Patent Application Nos. PCT/IB2018/057598, PCT/IB2018/057597, PCT/CA2019/051388, and PCT/CA2019/051386, each of which is incorporated by reference herein in its entirety for all purposes.

### Example 1

Growth inhibition of Fusarium oxysporum by pyraclostrobin in combination with several exemplary C4-C10 unsaturated aliphatic acids (or agriculturally acceptable salts thereof)

### Sample Preparation:

10 mg of pyraclostrobin (available from Santa Cruz Biotechnology of Dallas, Tex. as stock #229020) was dissolved in 10 mL dimethylsulfoxide (DMSO) and the resulting solution was diluted 2-fold in DMSO to give a concentration of 0.5 mg/mL. This solution was diluted 10-fold in potato dextrose broth (PDB) to give a concentration of 0.05 mg/mL in 10% DMSO/90% PDB. The solubility of pyraclostrobin in 10% DMSO/90% PDB was determined to be 0.0154 mg/mL using high performance liquid chromatography (HPLC).

A solution of (2E,4E)-2,4-hexadienoic acid, potassium salt, was prepared by dissolving 2 g of (2E,4E)-2,4-hexadienoic acid, potassium salt, in 20 mL of PDB which was diluted further by serial dilution in PDB. A solution of (2E,4E)-2,4-hexadienoic acid (available from Sigma-Aldrich as stock #W342904) was prepared by dissolving 20 mg of (2E,4E)-2,4-hexadienoic acid in 1 mL DMSO and adding 0.1 mL to 0.9 mL PDB resulting in a 2 mg/mL solution of (2E,4E)-2,4-hexadienoic acid in 10% DMSO/90% PDB which was diluted further by serial dilution in PDB.

A solution of trans-2-hexenoic acid (available from Sigma-Aldrich as stock #W316903) was prepared by dissolving 100 mg trans-2-hexenoic acid in 1 mL DMSO and adding 0.1 mL to 0.9 mL PDB resulting in a 10 mg/mL solution in 10% DMSO/90% PDB which was diluted further by serial dilution in PDB. A solution of trans-3-hexenoic acid (available from Sigma-Aldrich as stock #W317004) was prepared by adding 20 uL trans-3-hexenoic acid to 1980 uL PDB and the resulting solution was serially diluted in PDB. The density of trans-3-hexenoic acid was assumed to be 0.963 g/mL.

Combinations of pyraclostrobin and one or more exemplary C4-C10 saturated or unsaturated aliphatic acids (and agriculturally acceptable salts thereof) were prepared by adding 0.5 mL of 0.0308 mg/mL pyraclostrobin to 0.5 mL of 1.25 mg/mL (2E,4E)-2,4-hexadienoic acid, potassium salt, (combination 1), 0.5 mL of 0.25 mg/mL (2E,4E)-2,4-hexadienoic acid (combination 2), 0.5 mL of 0.625 mg/mL (2E,4E)-2,4-hexadienoic acid (combination 3), 0.5 mL of 1.25 mg/mL of trans-2-hexenoic acid (combination 4), or 0.5 mL of 0.6019 mg/mL trans-3-hexenoic acid (combination 5). Each combination was tested over a range of 2-fold dilutions in the Synergistic Growth Inhibition Assay detailed above, observed following a 24 hour incubation period, and the FIC Index for each combination calculated, as shown below in Table 1.

TABLE 1
Growth inhibition of Fusarium oxysporum by pyraclostrobin in combination with several
exemplary unsaturated aliphatic acids (or agriculturally acceptable salts thereof).

| | | | | | Ratio | |
|---|---|---|---|---|---|---|
| | | | | | Com- | |
| Com- | | | MIC | MIC | pound B/ | |
| bin- | | | (A) | (B) | Com- | FIC |
| ation | Compound A | Compound B | (mg/mL) | (mg/mL) | pound A | Index |
| | Pyraclostrobin | | 0.0154 | | | |
| | | (2E,4E)-2,4-hexadienoic | | 0.625 | | |
| | | acid, potassium salt | | | | |
| | | (2E,4E)-2,4-hexadienoic | | 0.125 | | |
| | | acid | | | | |
| | | Trans-2-hexenoic acid | | 0.3125 | | |
| | | Trans-3-hexenoic acid | | 0.3125 | | |
| 1 | Pyraclostrobin | (2E,4E)-2,4-hexadienoic | 0.00385 | 0.1563 | 40 | 0.50 |
| | | acid, potassium salt | | | | |
| 2 | Pyraclostrobin | (2E,4E)-2,4-hexadienoic | 0.00385 | 0.03125 | 20 | 0.50 |
| | | acid | | | | |
| 3 | Pyraclostrobin | (2E,4E)-2,4-hexadienoic | 0.001925 | 0.03906 | 8 | 0.44 |
| | | acid | | | | |
| 4 | Pyraclostrobin | Trans-2-hexenoic acid | 0.00385 | 0.1563 | 40 | 0.75 |
| 5 | Pyraclostrobin | Trans-3-hexenoic acid | 0.00385 | 0.07813 | 20 | 0.50 |

### Sample Preparation for Examples 2-4

For each of experimental Examples 2-4 described below, concentrated stock solutions, and diluted working solutions were prepared for each of the exemplary pesticidal active ingredients as Component A, and each of the exemplary unsaturated and saturated aliphatic acids as Component B, in accordance with the following descriptions:

### Compound A Pesticidal Active Ingredients:

Concentrated stock solutions were prepared by dissolving pesticidal active ingredient in 100% dimethylsulfoxide (DMSO), which were then diluted 10-fold in potato dextrose broth (PDB) to give a working stock solution, as described below:

Pyraclostrobin (available from Santa Cruz Biotech, Dallas, Tex., USA, as stock #SC-229020): A 0.5 mg/mL stock solution in 100% DMSO was diluted 10-fold in PDB to provide a nominal 0.05 mg/mL working stock solution, for which an effective solubilized concentration of 0.015 mg/mL was verified using high performance liquid chromatography (HPLC). This 0.015 mg/mL effective concentration working stock solution was used for further serial dilution in PDB to the required individual concentrations as specified in the tables below.

Azoxystrobin (available from Sigma-Aldrich, St. Louis, Mo., USA, as stock #31697): A 1.75 mg/mL stock solution in 100% DMSO was diluted 10-fold in PDB to provide a nominal 0.175 mg/mL working stock solution, for which an effective solubilized concentration of 0.15 mg/mL was verified using high performance liquid chromatography (HPLC). This 0.15 mg/mL effective concentration working stock solution was used for further serial dilution in PDB to the required individual concentrations as specified in the tables below.

Chlorothalonil (available from Chem Service Inc., West Chester, Pa., USA, as stock #N-11454): A 0.5 mg/mL stock solution in 100% DMSO was diluted 10-fold in PDB to provide a nominal 0.05 mg/mL working stock solution, for which an effective solubilized concentration of 0.002 mg/mL was verified using high performance liquid chromatography (HPLC). This 0.002 mg/mL effective concentration working stock solution was used for further serial dilution in PDB to the required individual concentrations as specified in the tables below.

Fludioxonil (available from Shanghai Terppon Chemical Co. Ltd., of Shanghai, China): A 1.05 mg/mL stock solution in 100% DMSO was diluted 10-fold in PDB to provide a nominal 0.105 mg/mL working stock solution, for which an effective solubilized concentration of 0.021 mg/mL was verified using high performance liquid chromatography (HPLC). This 0.021 mg/mL effective concentration working stock solution was used for further serial dilution in PDB to the required individual concentrations as specified in the tables below.

Cyprodinil (available from Shanghai Terppon Chemical Co. Ltd., of Shanghai, China): A 1.37 mg/mL stock solution in 100% DMSO was diluted 10-fold in PDB to provide a nominal 0.137 mg/mL working stock solution, for which an effective solubilized concentration of 0.009 mg/mL was verified using high performance liquid chromatography (HPLC). This 0.009 mg/mL effective concentration working stock solution was used for further serial dilution in PDB to the required individual concentrations as specified in the tables below.

Metalaxyl: A 3.32 mg/mL stock solution in 100% DMSO was diluted 10-fold in PDB to provide a nominal 0.332 mg/mL working stock solution, for which an effective solubilized concentration of 0.316 mg/mL was verified using high performance liquid chromatography (HPLC). This 0.316 mg/mL effective concentration working stock solution was used for further serial dilution in PDB to the required individual concentrations as specified in the tables below.

Difenoconazole (available from Santa Cruz Biotech, Dallas, Tex., USA, as stock no. SC-204721): A 1.3 mg/mL stock solution in 100% DMSO was diluted 10-fold in PDB to provide a nominal 0.13 mg/mL working stock solution, for which an effective solubilized concentration of 0.051 mg/mL was verified using high performance liquid chromatography (HPLC). This 0.051 mg/mL effective concentration working stock solution was used for further serial dilution in PDB to the required individual concentrations as specified in the tables below.

Propiconazole (available from Shanghai Terppon Chemical Co. Ltd., of Shanghai, China): A 1.0 mg/mL stock solution in 100% DMSO was diluted 10-fold in PDB to provide a nominal 0.10 mg/mL working stock solution, for which an effective solubilized concentration of 0.089 mg/mL was verified using high performance liquid chromatography (HPLC). This 0.089 mg/mL effective concentration working stock solution was used for further serial dilution in PDB to the required individual concentrations as specified in the tables below.

Epoxiconazole (available from Shanghai Terppon Chemical Co. Ltd., of Shanghai, China): A 2.5 mg/mL stock solution in 100% DMSO was diluted 10-fold in PDB to provide a nominal 0.25 mg/mL working stock solution, for which an effective solubilized concentration of 0.03 mg/mL was verified using high performance liquid chromatography (HPLC). This 0.025 mg/mL effective concentration working stock solution was used for further serial dilution in PDB to the required individual concentrations as specified in the tables below.

Tebuconazole (available from Shanghai Terppon Chemical Co. Ltd., of Shanghai, China): A 5.0 mg/mL stock solution in 100% DMSO was diluted 10-fold in PDB to provide a nominal 0.50 mg/mL working stock solution, for which an effective solubilized concentration of 0.45 mg/mL was verified using high performance liquid chromatography (HPLC). This 0.45 mg/mL effective concentration working stock solution was used for further serial dilution in PDB to the required individual concentrations as specified in the tables below.

Picoxystrobin (available from Sigma Aldrich, #33658): A 5.0 mg/mL stock solution in 100% DMSO was diluted 10-fold in PDB to provide a nominal 0.50 mg/mL working picoxystrobin stock solution, which was used for further serial dilution in PDB to the required individual concentrations as specified in the tables below.

Isopyrazam (available from Sigma Aldrich, #32532): A 5.0 mg/mL stock solution in 100% DMSO was diluted 10-fold in PDB to provide a nominal 0.50 mg/mL working isopyrazam stock solution, which was used for further serial dilution in PDB to the required individual concentrations as specified in the tables below.

Penthiopyrad (available from aksci.com, #X5975): A 5.0 mg/mL stock solution in 100% DMSO was diluted 10-fold in PDB to provide a nominal 0.50 mg/mL working penthiopyrad stock solution, which was used for further serial dilution in PDB to the required individual concentrations as specified in the tables below.

Oxathiapiprolin (available from carbosynth.com, #FO159014): A 5.0 mg/mL stock solution in 100% DMSO was diluted 10-fold in PDB to provide a nominal 0.50 mg/mL working oxathiapiprolin stock solution, which was used for further serial dilution in PDB to the required individual concentrations as specified in the tables below.

Prothioconazole (available from Sigma Aldrich, #34232): A 5.0 mg/mL stock solution in 100% DMSO was diluted 10-fold in PDB to provide a nominal 0.50 mg/mL working prothioconazole stock solution, which was used for further serial dilution in PDB to the required individual concentrations as specified in the tables below.

Trifloxystrobin (available from Sigma Aldrich, #46447): A 5.0 mg/mL stock solution in 100% DMSO was diluted 10-fold in PDB to provide a nominal 0.50 mg/mL working trifloxystrobin stock solution, which was used for further serial dilution in PDB to the required individual concentrations as specified in the tables below.

### Compound B Unsaturated Aliphatic Acids:

Concentrated stock solutions were prepared by dissolving each exemplary unsaturated aliphatic acid in 100% dimethylsulfoxide (DMSO), which were then diluted 10-fold in potato dextrose broth (PDB) to give a working stock solution, as described below:

Trans-2-hexenoic acid, trans-3-hexenoic acid, cis-3-hexenoic acid, 5-hexenoic acid, 3-heptenoic acid, trans-2-octenoic acid, trans-3-octenoic acid, 3-octenoic acid, 7-octenoic acid, 3-decenoic acid, cis-3-decenoic acid, 9-decenoic acid, trans-2-nonenoic acid, 3-nonenoic acid, (9Z)-octadecenoic acid (oleic acid) (all available from Sigma-Aldrich, St. Louis, Mo., USA), trans-2-decenoic acid (available from TCI America, Portland, Oreg., USA as stock #D0098), cis-2-decenoic acid (available from BOC Sciences, Sirley, N.Y., USA), and trans-2-undecenoic acid (available from Alfa Aesar, Ward Hill, Mass., USA as stock #L-11579): A 50 mg/mL stock solution in 100% DMSO was diluted 10-fold in PDB to provide a working stock solution of 5 mg/mL concentration. This 5 mg/mL effective concentration working stock solution was used for further serial dilution in PDB to the required individual concentrations as specified in the tables below.

(2E,4E)-2,4-hexadienoic acid (available from Sigma-Aldrich, St. Louis, Mo., USA): A 20 mg/mL stock solution in 100% DMSO was diluted 10-fold in PDB to provide a working stock solution of 2 mg/mL concentration. This 2 mg/mL effective concentration working stock solution was used for further serial dilution in PDB to the required individual concentrations as specified in the tables below.

### Compound B Saturated Aliphatic Acids:

Concentrated stock solutions were prepared by dissolving each exemplary saturated aliphatic acid in 100% dimethylsulfoxide (DMSO), which were then diluted 10-fold in potato dextrose broth (PDB) to give a working stock solution, as described below:

Hexanoic acid, heptanoic acid, octanoic acid, nonanoic acid (all available from Sigma-Aldrich, St. Louis, Mo., USA): A 50 mg/mL stock solution in 100% DMSO was diluted 10-fold in PDB to provide a working stock solution of 5 mg/mL concentration. This 5 mg/mL effective concentration working stock solution was used for further serial dilution in PDB to the required individual concentrations as specified in data Tables below.

Decenoic acid (available from Sigma-Aldrich, St. Louis, Mo., USA): A 10 mg/mL stock solution in 100% DMSO was diluted 10-fold in PDB to provide a working stock solution of 1 mg/mL concentration. This 1 mg/mL effective concentration working stock solution was used for further serial dilution in PDB to the required individual concentrations as specified in data Tables below.

Dodecenoic acid (available from Sigma-Aldrich, St. Louis, Mo., USA): A 1 mg/mL stock solution in 100% DMSO was diluted 10-fold in PDB to provide a working stock solution of 0.1 mg/mL concentration. This 0.1 mg/mL effective concentration working stock solution was used for further serial dilution in PDB to the required individual concentrations as specified in data Tables below.

Exemplary Hydroxy-substituted aliphatic acids: 2- and 3-hydroxybutyric acid, 2-hydroxyhexanoic acid, 12-hydroxydodecanoic acid (all available from Sigma-Aldrich, St. Louis, Mo., USA); 3-hydroxydecanoic acid, 3-hydroxyhexanoic acid (both available from Shanghai Terppon Chemical, Shanghai, China); 3-, 8-, 10-hydroxyoctanoic acid (all available from AA Blocks LLC, San Diego, Calif., USA), 2-hydroxyoctanoic acid (available from Alfa Aesar, Ward Hill, Mass., USA): a stock solution was prepared for each by dissolving each acid in 100% DMSO, which was then diluted in PDB to 10% DMSO concentration, before further serial dilution in PDB to the required individual concentrations as specified in the data Tables below.

Exemplary alkyl-substituted aliphatic acids: 2-ethylhexanoic acid, 2-methyloctanoic acid, 3-methylnonanoic acid, 3-methylbutyric acid (all available from Sigma-Aldrich, St. Louis, Mo., USA); 2,2-diethylbutyric acid, 2- and 4-methylhexanoic acid, 2-methyldecanoic acid (all available from AA Blocks LLC, San Diego, Calif., USA); 3-methylhexanoic acid (available from 1 ClickChemistry Inc., Kendall Park, N.J., USA): a stock solution was prepared for each by dissolving each acid in 100% DMSO, which was then diluted in PDB to 10% DMSO concentration, before further serial dilution in PDB to the required individual concentrations as specified in the data Tables below.

Exemplary amino-substituted aliphatic acid: 3-aminobutyric acid (available from AK Scientific Inc., Union City, Calif., USA): a stock solution was prepared by dissolving each acid in 100% DMSO, which was then diluted in PDB to 10% DMSO concentration, before further serial dilution in PDB to the required individual concentrations as specified in the data Tables below.

The working stock solutions for each Compound A and Compound B component were then serially diluted to test the individual MIC of each pesticidal active ingredient (as Compound A), each unsaturated or saturated aliphatic acid (as Compound B), and the combined MIC of each combination of Compound A and Compound B, according to the synergistic growth inhibition assay described above.

### Example 2

Growth inhibition of Fusarium oxysporum by pyraclostrobin, azoxystrobin, chlorothalonil, fluidioxonil, cyprodinil, difenoconazole, and tebuconazole, in combination with various exemplary saturated aliphatic acids

Working solutions of pyraclostrobin, azoxystrobin, chlorothalonil, fluidioxonil, cyprodinil, difenoconazole, and tebuconazole were each prepared as described above (as Compound A) and were serially diluted in PDB to the individual required concentrations for MIC testing as shown in Tables 2-8 below. Working solutions of hexanoic acid, heptanoic acid, octanoic acid, nonanoic acid, and decanoic acid, (as Compound B), were each prepared as described above, and were serially diluted in PDB to the individual required concentrations for MIC testing as shown in Tables 2-8 below.

Each individual compound and combination was tested over a range of 2-fold dilutions in the synergistic growth inhibition assay, observed following an incubation period of 48 hours, and the FIC Index for each combination calculated, as shown in Tables 2-8 below.

TABLE 2
Growth inhibition of Fusarium oxysporum by pyraclostrobin, in
combination with various exemplary saturated aliphatic acids

| Com- | | | | | Ratio | |
|---|---|---|---|---|---|---|
| bin- | | | MIC (A) | MIC (B) | Compound B/ | FIC |
| ation | Compound A | Compound B | (mg/mL) | (mg/mL) | Compound A | Index |
| | Pyraclostrobin | | 0.015 | | | |
| | | Hexanoic acid | | 0.15625 | | |
| | | Heptanoic acid | | 0.15625 | | |
| | | Octanoic acid | | 0.15625 | | |
| | | Nonanoic acid | | 0.15625 | | |
| | | Decanoic acid | | 0.125 | | |
| | | Dodecanoic acid | | 0.1 | | |
| | | 3-Hydroxybutyric | | 10 | | |
| | | acid | | | | |
| | | 3-Hydroxy decanoic | | 0.25 | | |
| | | acid | | | | |
| 1 | Pyraclostrobin | Hexanoic acid | 0.00187 | 0.019531 | 10 | 0.25 |
| 2 | Pyraclostrobin | Heptanoic acid | 0.00375 | 0.039062 | 10 | 0.50 |
| 3 | Pyraclostrobin | Octanoic acid | 0.00187 | 0.039062 | 21 | 0.38 |
| 4 | Pyraclostrobin | Nonanoic acid | 0.00375 | 0.039062 | 10 | 0.50 |
| 5 | Pyraclostrobin | Decanoic acid | 0.00375 | 0.015625 | 4 | 0.38 |
| 6 | Pyraclostrobin | Dodecanoic acid | 0.00375 | 0.025 | 7 | 0.50 |
| 7 | Pyraclostrobin | 3-Hydroxybutyric | 0.00375 | 2.5 | 667 | 0.50 |
| | | acid | | | | |
| 8 | Pyraclostrobin | 3-Hydroxy decanoic | 0.001875 | 0.015626 | 8 | 0.25 |
| | | acid | | | | |

TABLE 3
Growth inhibition of Fusarium oxysporum by azoxystrobin, in
combination with various exemplary saturated aliphatic acids

| Com- | | | | | Ratio | |
|---|---|---|---|---|---|---|
| bin- | | | MIC (A) | MIC (B) | Compound B/ | FIC |
| ation | Compound A | Compound B | (mg/mL) | (mg/mL) | Compound A | Index |
| | Azoxystrobin | | 0.075 | | | |
| | | Hexanoic acid | | 0.15625 | | |
| | | Heptanoic acid | | 0.15625 | | |
| | | Octanoic acid | | 0.15625 | | |
| | | Nonanoic acid | | 0.07812 | | |
| | | Dodecanoic acid | | 0.1 | | |
| 1 | Azoxystrobin | Hexanoic acid | 0.01875 | 0.039062 | 2 | 0.50 |
| 2 | Azoxystrobin | Heptanoic acid | 0.01875 | 0.039062 | 2 | 0.50 |
| 3 | Azoxystrobin | Octanoic acid | 0.01875 | 0.039062 | 2 | 0.50 |
| 4 | Azoxystrobin | Nonanoic acid | 0.01875 | 0.019531 | 1 | 0.50 |
| 5 | Azoxystrobin | Dodecanoic acid | 0.01875 | 0.025 | 1.3 | 0.50 |

TABLE 4
Growth inhibition of Fusarium oxysporum by chlorothalonil, in
combination with various exemplary saturated aliphatic acids

| Com- | | | | | Ratio | |
|---|---|---|---|---|---|---|
| bin- | | | MIC (A) | MIC (B) | Compound B/ | FIC |
| ation | Compound A | Compound B | (mg/mL) | (mg/mL) | Compound A | Index |
| | Chlorothalonil | | 0.000125 | | | |
| | | Heptanoic acid | | 0.15625 | | |
| | | Octanoic acid | | 0.3125 | | |
| | | Nonanoic acid | | 0.3125 | | |
| | | Dodecanoic acid | | 0.1 | | |
| | | 3-Hydroxydecanoic | | 0.25 | | |
| | | acid | | | | |
| 1 | Chlorothalonil | Heptanoic acid | 6.25 × 10 − 5 | 0.039062 | 625 | 0.75 |
| 2 | Chlorothalonil | Octanoic acid | 6.25 × 10 − 5 | 0.039062 | 625 | 0.63 |
| 3 | Chlorothalonil | Nonanoic acid | 6.25 × 10 − 5 | 0.019531 | 313 | 0.56 |
| 4 | Chlorothalonil | Dodecanoic acid | 6.25 × 10 − 5 | 0.025 | 400 | 0.75 |
| 5 | Chlorothalonil | 3-Hydroxydecanoic | 1.9531 × | 0.003125 | 16000 | 0.19 |
| | | acid | 10⁻⁶ | | | |

TABLE 5
Growth inhibition of Fusarium oxysporum by fludioxonil and cyprodinil,
in combination with an exemplary saturated aliphatic acid

| Com- | | | | | Ratio | |
|---|---|---|---|---|---|---|
| bin- | | | MIC (A) | MIC (B) | Compound B/ | FIC |
| ation | Compound A | Compound B | (mg/mL) | (mg/mL) | Compound A | Index |
| | Fludioxonil | | 0.021 | | | |
| | Cyprodinil | | 0.009 | | | |
| | | Dodecanoic acid | | 0.1 | | |
| | | 3-Hydroxydecanoic | | 0.25 | | |
| | | acid | | | | |
| 1 | Fludioxonil | Dodecanoic acid | 0.00525 | 0.025 | 5 | 0.50 |
| 2 | Fludioxonil | 3-Hydroxydecanoic | 0.00131 | 0.03125 | 24 | 0.19 |
| | | acid | | | | |
| 3 | Cyprodinil | 3-Hydroxydecanoic | 0.00225 | 0.03125 | 14 | 0.50 |
| | | acid | | | | |

TABLE 6
Growth inhibition of Fusarium oxysporum by difenoconazole, in
combination with various exemplary saturated aliphatic acids

| Com- | | | | | Compound B | |
|---|---|---|---|---|---|---|
| bin- | | | MIC (A) | MIC (B) | Compound A/ | FIC |
| ation | Compound A | Compound B | (mg/mL) | (mg/mL) | Ratio | Index |
| | Difenoconazole | | 0.051 | | | |
| | | Heptanoic acid | | 0.15625 | | |
| | | Octanoic acid | | 0.3125 | | |
| 1 | Difenoconazole | Heptanoic acid | 0.01275 | 0.039062 | 3 | 0.50 |
| 2 | Difenoconazole | Octanoic acid | 0.01275 | 0.078125 | 6 | 0.50 |

TABLE 7
Growth inhibition of Fusarium oxysporum by tebuconazole, in
combination with various exemplary saturated aliphatic acids

| Combi- | | | MIC (A) | MIC (B) | Ratio Compound | FIC |
|---|---|---|---|---|---|---|
| nation | Compound A | Compound B | (mg/mL) | (mg/mL) | B/ Compound A | Index |
| | Tebuconazole | | 0.255 | | | |
| | | Heptanoic acid | | 0.15625 | | |
| | | Octanoic acid | | 0.15625 | | |
| | | Nonanoic acid | | 0.15625 | | |
| | | Decanoic acid | | 0.03125 | | |
| | | Dodecanoic acid | | 0.1 | | |
| 1 | Tebuconazole | Heptanoic acid | 0.05625 | 0.039062 | 0.7 | 0.50 |
| 2 | Tebuconazole | Octanoic acid | 0.05625 | 0.039062 | 0.7 | 0.50 |
| 3 | Tebuconazole | Nonanoic acid | 0.05625 | 0.039062 | 0.7 | 0.50 |
| 4 | Tebuconazole | Decanoic acid | 0.05625 | 0.007812 | 0.14 | 0.50 |
| 5 | Tebuconazole | Dodecanoic acid | 0.05625 | 0.0025 | 0.4 | 0.50 |

TABLE 8
Growth inhibition of Fusarium oxysporum by various synthetic
fungicides in combination with saturated 3-hydroxy aliphatic acids

| Combi- | | | MIC (A) | MIC (B) | Ratio Compound | FIC |
|---|---|---|---|---|---|---|
| nation | Compound A | Compound B | (mg/mL) | (mg/mL) | B/ Compound A | Index |
| | Pyraclostrobin | | 0.015 | | | |
| | Azoxy strobin | | 0.15 | | | |
| | Fludioxonil | | 0.021 | | | |
| | Difenoconazole | | 0.051 | | | |
| | Tebuconazole | | 0.225 | | | |
| | | 3-Hydroxybutyric | | 10 | | |
| | | acid | | | | |
| | | 3-Hydroxyhexanoic | | 2.5 | | |
| | | acid | | | | |
| | | 3-Hydroxydecanoic | | 0.25 | | |
| | | acid | | | | |
| 1 | Pyraclostrobin | 3-Hydroxybutyric | 0.001875 | 2.5 | 1333 | 0.38 |
| | | acid | | | | |
| 2 | Azoxy strobin | 3-Hydroxybutyric | 0.0375 | 2.5 | 67 | 0.50 |
| | | acid | | | | |
| 3 | Azoxy strobin | 3-Hydroxyhexanoic | 0.0375 | 0.625 | 17 | 0.50 |
| | | acid | | | | |
| 4 | Fludioxonil | 3-Hydroxybutyric | 0.00525 | 2.5 | 476 | 0.50 |
| | | acid | | | | |
| 5 | Difenoconazole | 3-Hydroxybutyric | 0.01275 | 2.5 | 196 | 0.50 |
| | | acid | | | | |
| 6 | Tebuconazole | 3-Hydroxybutyric | 0.05625 | 2.5 | 44 | 0.50 |
| | | acid | | | | |
| 7 | Tebuconazole | 3-Hydroxydecanoic | 0.05625 | 0.0625 | 1.1 | 0.50 |
| | | acid | | | | |

### Example 3

Growth inhibition of Fusarium oxysporum by pyraclostrobin, azoxystrobin, fludioxonil, cyprodinil, difenoconazole, epoxiconazole, and tebuconazole, in combination with various exemplary unsaturated aliphatic acids

Working solutions of pyraclostrobin, azoxystrobin, fludioxonil, cyprodinil, difenoconazole, epoxiconazole, and tebuconazole were each prepared as described above (as Compound A) and were serially diluted in PDB to the individual required concentrations for MIC testing as shown in Tables 9-14 below. Working solutions of (2E,4E)-2,4-hexadienoic acid, trans-3-hexenoic acid, 4-hexenoic acid, 5-hexenoic acid, 3-heptenoic acid, trans-2-octenoic acid, trans-3-octenoic acid, 7-octenoic acid, 3-decenoic acid, 9-decenoic acid, trans-2-nonenoic acid, 3-nonenoic acid, trans-2-decenoic acid, and trans-2-undecenoic acid, (as Compound B), were each prepared as described above, and were serially diluted in PDB to the individual required concentrations for MIC testing as shown in Tables 9-14 below.

Each individual compound and combination was tested over a range of 2-fold dilutions in the synergistic growth inhibition assay, observed following an incubation period of 48 hours, and the FIC Index for each combination calculated, as shown in Tables 9-14 below.

TABLE 9
Growth inhibition of Fusarium oxysporum by pyraclostrobin, in
combination with various exemplary unsaturated aliphatic acids

| | | | | | Ratio | |
|---|---|---|---|---|---|---|
| Combi- | | | MIC (A) | MIC (B) | Compound B/ | FIC |
| nation | Compound A | Compound B | (mg/mL) | (mg/mL) | Compound A | Index |
| | Pyraclostrobin | | 0.015 | | | |
| | | (2E,4E)-2,4-hexadienoic | | 0.025 | | |
| | | acid | | | | |
| | | Trans-3-hexenoic acid | | 0.3125 | | |
| | | 4-Hexenoic acid | | 0.3125 | | |
| | | 5-Hexenoic acid | | 0.3125 | | |
| | | 3-Heptenoic acid | | 0.15625 | | |
| | | Trans-2-octenoic acid | | 0.3125 | | |
| | | Trans-3-octenoic acid | | 0.15625 | | |
| | | 7-Octenoic acid | | 0.3125 | | |
| | | 3-Decenoic acid | | 0.3125 | | |
| | | 9-Decenoic acid | | 0.3125 | | |
| 1 | Pyraclostrobin | (2E,4E)-2,4-hexadienoic | 0.00375 | 0.0625 | 17 | 0.50 |
| | | acid | | | | |
| 2 | Pyraclostrobin | Trans-3-hexenoic acid | 0.001875 | 0.078125 | 42 | 0.38 |
| 3 | Pyraclostrobin | 4-Hexenoic acid | 0.00375 | 0.15625 | 42 | 0.75 |
| 4 | Pyraclostrobin | 5-Hexenoic acid | 0.00375 | 0.039062 | 10 | 0.38 |
| 5 | Pyraclostrobin | 3-Heptenoic acid | 0.001875 | 0.078125 | 42 | 0.63 |
| 6 | Pyraclostrobin | Trans-2-octenoic acid | 0.001875 | 0.019531 | 10 | 0.19 |
| 7 | Pyraclostrobin | Trans-3-octenoic acid | 0.001875 | 0.019531 | 10 | 0.25 |
| 8 | Pyraclostrobin | 7-Octenoic acid | 0.001875 | 0.019531 | 10 | 0.19 |
| 9 | Pyraclostrobin | 3-Decenoic acid | 0.00375 | 0.078125 | 21 | 0.50 |
| 10 | Pyraclostrobin | 9-Decenoic acid | 0.00375 | 0.039062 | 10 | 0.38 |

TABLE 10
Growth inhibition of Fusarium oxysporum by azoxystrobin, in
combination with various exemplary unsaturated aliphatic acids

| Com- | | | | | Ratio | |
|---|---|---|---|---|---|---|
| bina- | | | MIC (A) | MIC (B) | Compound B/ | FIC |
| tion | Compound A | Compound B | (mg/mL) | (mg/mL) | Compound A | Index |
| | Azoxystrobin | | 0.15 | | | |
| | | Trans-3-hexenoic acid | | 0.3125 | | |
| | | 3-Heptenoic acid | | 0.15625 | | |
| | | Trans-2-nonenoic acid | | 0.15625 | | |
| | | 3-Decenoic acid | | 0.078125 | | |
| | | 9-Decenoic acid | | 0.3125 | | |
| 1 | Azoxystrobin | Trans-3-hexenoic acid | 0.0375 | 0.078125 | 2 | 0.50 |
| 2 | Azoxy strobin | 3-Heptenoic acid | 0.001875 | 0.019531 | 1 | 0.25 |
| 3 | Azoxy strobin | Trans-2-nonenoic acid | 0.0375 | 0.039062 | 1 | 0.50 |
| 4 | Azoxy strobin | 3-Decenoic acid | 0.001875 | 0.019531 | 1 | 0.38 |
| 5 | Azoxy strobin | 9-Decenoic acid | 0.00375 | 0.039062 | 1 | 0.50 |

TABLE 11
Growth inhibition of Fusarium oxysporum by fludioxonil and cyprodinil,
in combination with various exemplary unsaturated aliphatic acids

| Com- | | | | | Ratio | |
|---|---|---|---|---|---|---|
| bina- | | | MIC (A) | MIC (B) | Compound B/ | FIC |
| tion | Compound A | Compound B | (mg/mL) | (mg/mL) | Compound A | Index |
| | Fludioxonil | | 0.021 | | | |
| | Cyprodinil | | 0.009 | | | |
| | | 3-Heptenoic acid | | 0.15625 | | |
| | | 3-Decenoic acid | | 0.15625 | | |
| 1 | Fludioxonil | 3-Heptenoic acid | 0.00525 | 0.03906 | 7 | 0.50 |
| 2 | Fludioxonil | 3-Decenoic acid | 0.00525 | 0.03906 | 7 | 0.50 |
| 3 | Cyprodinil | 3-Decenoic acid | 0.00225 | 0.019531 | 9 | 0.38 |

TABLE 12
Growth inhibition of Fusarium oxysporum by difenoconazole, in
combination with various exemplary unsaturated aliphatic acids

| Com- | | | | | Ratio | |
|---|---|---|---|---|---|---|
| bina- | | | MIC (A) | MIC (B) | Compound B/ | FIC |
| tion | Compound A | Compound B | (mg/mL) | (mg/mL) | Compound A | Index |
| | Difenoconazole | | 0.051 | | | |
| | | Trans-3-hexenoic acid | | 0.3125 | | |
| | | 4-Hexenoic acid | | 0.3125 | | |
| | | 3-Heptenoic acid | | 0.15625 | | |
| | | Trans-2-octenoic acid | | 0.15625 | | |
| | | 3-Octenoic acid | | 0.15625 | | |
| | | Trans-3-octenoic acid | | 0.15625 | | |
| | | 7-Octenoic acid | | 0.15625 | | |
| | | Trans-2-nonenoic acid | | 0.3125 | | |
| | | Trans-2-decenoic acid | | 0.078125 | | |
| | | 9-Decenoic acid | | 0.15625 | | |
| 1 | Difenoconazole | Trans-3-hexenoic acid | 0.006375 | 0.078125 | 12 | 0.38 |
| 2 | Difenoconazole | 4-Hexenoic acid | 0.01275 | 0.15625 | 12 | 0.75 |
| 3 | Difenoconazole | 3-Heptenoic acid | 0.006375 | 0.078125 | 12 | 0.63 |
| 4 | Difenoconazole | Trans-2-octenoic acid | 0.01275 | 0.039062 | 3 | 0.50 |
| 5 | Difenoconazole | 3-Octenoic acid | 0.01275 | 0.019531 | 1.5 | 0.38 |
| 6 | Difenoconazole | Trans-3-octenoic acid | 0.01275 | 0.039062 | 3 | 0.50 |
| 7 | Difenoconazole | 7-Octenoic acid | 0.01275 | 0.039062 | 3 | 0.50 |
| 8 | Difenoconazole | Trans-2-nonenoic acid | 0.01275 | 0.039062 | 3 | 0.38 |
| 9 | Difenoconazole | Trans-2 -decenoic acid | 0.01275 | 0.019531 | 1.5 | 0.50 |
| 10 | Difenoconazole | 9-Decenoic acid | 0.01275 | 0.039062 | 3 | 0.50 |

TABLE 13
Growth inhibition of Fusarium oxysporum by epoxiconazole, in
combination with various exemplary unsaturated aliphatic acids

| Com- | | | | | Ratio | |
|---|---|---|---|---|---|---|
| bina- | | | MIC (A) | MIC (B) | Compound B/ | FIC |
| tion | Compound A | Compound B | (mg/mL) | (mg/mL) | Compound A | Index |
| | Epoxiconazole | | 0.03 | | | |
| | | Trans-3-hexenoic acid | | 0.15625 | | |
| | | 3-Heptenoic acid | | 0.15625 | | |
| | | Trans-2-octenoic acid | | 0.15625 | | |
| | | 3-Octenoic acid | | 0.15625 | | |
| | | 3-Decenoic acid | | 0.078125 | | |
| 1 | Epoxiconazole | Trans-3-hexenoic acid | 0.0075 | 0.078125 | 10 | 0.75 |
| 2 | Epoxiconazole | 3-Heptenoic acid | 0.0075 | 0.039062 | 5 | 0.50 |
| 3 | Epoxiconazole | Trans-2-octenoic acid | 0.0075 | 0.039062 | 5 | 0.50 |
| 4 | Epoxiconazole | 3-Octenoic acid | 0.0075 | 0.039062 | 5 | 0.50 |
| 5 | Epoxiconazole | 3-Decenoic acid | 0.0075 | 0.039062 | 5 | 0.75 |

TABLE 14
Growth inhibition of Fusarium oxysporum by tebuconazole, in
combination with various exemplary unsaturated aliphatic acids

| Com- | | | | | Ratio | |
|---|---|---|---|---|---|---|
| bina- | | | MIC (A) | MIC (B) | Compound B/ | FIC |
| tion | Compound A | Compound B | (mg/mL) | (mg/mL) | Compound A | Index |
| | Tebuconazole | | 0.225 | | | |
| | | Trans-2-octenoic acid | | 0.3125 | | |
| | | 3-Octenoic acid | | 0.15625 | | |
| | | Trans-3-octenoic acid | | 0.15625 | | |
| | | 7-Octenoic acid | | 0.15625 | | |
| | | Trans-2-nonenoic acid | | 0.3125 | | |
| | | 3-Nonenoic acid | | 0.15625 | | |
| | | Trans-2-decenoic acid | | 0.15625 | | |
| | | 9-Decenoic acid | | 0.078125 | | |
| | | Trans-2 -undecenoic acid | | 0.15625 | | |
| 1 | Tebuconazole | Trans-2-octenoic acid | 0.05625 | 0.039062 | 0.7 | 0.38 |
| 2 | Tebuconazole | 3-Octenoic acid | 0.05625 | 0.019531 | 0.3 | 0.38 |
| 3 | Tebuconazole | Trans-3-octenoic acid | 0.05625 | 0.039062 | 0.7 | 0.50 |
| 4 | Tebuconazole | 7-Octenoic acid | 0.05625 | 0.039062 | 0.7 | 0.50 |
| 5 | Tebuconazole | Trans-2-nonenoic acid | 0.028125 | 0.019531 | 0.7 | 0.19 |
| 6 | Tebuconazole | 3-Nonenoic acid | 0.05625 | 0.019531 | 0.3 | 0.38 |
| 7 | Tebuconazole | Trans-2-decenoic acid | 0.05625 | 0.019531 | 0.3 | 0.38 |
| 8 | Tebuconazole | 9-Decenoic acid | 0.05625 | 0.039062 | 0.7 | 0.75 |
| 9 | Tebuconazole | Trans-2-undecenoic acid | 0.05625 | 0.019531 | 0.3 | 0.38 |

### Example 4

In-vitro insecticidal efficacy against Trichoplusia ni by spinosad (active ingredient in Entrust® SC insecticide and comprising insecticidal spinosyns A and D), in combination with various exemplary saturated and unsaturated aliphatic acids (and agriculturally acceptable salts thereof)

### Sample Preparation:

Spinosad, an insecticide isolated from culture of S. spinosa and comprising spinosyns A (˜85%) and D (˜15%), was provided as the active ingredient in Entrust® SC insecticide (available from Dow Agrosciences LLC, Indianapolis, Ind., USA), and is present as 22.5% w/w of the Entrust® SC liquid formulation. Entrust® SC liquid formulation was diluted in water to form an Entrust® SC stock solution of 0.0000034% or 0.034 ppm of the Entrust® SC formulation (and containing 0.0077 ppm spinosad active ingredient).

A stock solution was prepared for each of: (2E,4E)-2,4 hexadienoic acid, trans-2 hexanoic acid, trans-3 hexanoic acid, hexanoic acid, octanoic acid, octanoic acid potassium salt, decanoic acid, dodecanoic acid, 5-hexenoic acid, 7-octenoic acid, 3-heptanoic acid, trans-2 nonenoic acid, 3-nonenoic acid, 3-octenoic acid, trans-3 octenoic acid, trans-2 decenoic acid, 3-decenoic acid, 9-decenoic acid, trans-2 undecenoic acid, heptanoic acid, and nonanoic acid (sourced as disclosed in examples above), by dissolving each exemplary unsaturated aliphatic acid in 100% dimethylsulfoxide (DMSO), followed by 50-fold dilution with water to provide a concentration of each aliphatic acid of 0.1% or 1,000 ppm in the stock solution. A stock solution was prepared for each of the potassium salt of (2E,4E)-2,4-hexadienoic acid, and the potassium salt of octanoic acid by dissolving the salt in water to form a 1.0% (1000 ppm) stock solution. An artificial diet suitable for Trichoplusia ni (cabbage looper caterpillar) was prepared from a commercially available general purpose lepidoptera artificial diet premix (General Purpose Lepidoptera Diet available from Frontier Scientific Services, Newark, Del.) mixed in agar media and then heated to liquify the media. The liquid artificial diet media was then used to fill each well of a 96-well treatment plate with 200 uL of artificial diet media, which was allowed to solidify at room temperature and stored at approximately 4C.

The Entrust® SC stock solution and each exemplary saturated or unsaturated aliphatic acid (or salt thereof) individually and in combination, were diluted in water to produce treatment formulations having a concentration of 0.00000085% (0.0085 ppm) for the Entrust® SC formulation (and containing 0.0019 ppm spinosad active ingredient), and 0.5% (500 ppm) for each of the exemplary unsaturated or saturated aliphatic acid (and salt) components. A 20 uL treatment sample of each treatment formulation was then placed on top of the solidified artificial diet media in each well of the 96 well plates and allowed to dry overnight. The following day, one neonate Trichoplusia ni (cabbage looper) larva (hatched from eggs obtained from the Natural Resource Canada insect research facility in Sault-Ste-Marie, ON, Canada) was added to each well of the plate, and their mortality rate was evaluated after 5 days, to determine the insecticidal efficacy of the Entrust® SC treatment alone, each exemplary unsaturated or saturated aliphatic acid (and salt) alone, and each combination of spinosad (as Entrust® SC) and unsaturated or saturated aliphatic acid (and salt). Each experiment contained 3 replicates.

The aggregate results showing the insecticidal efficacy (which is equal to (100%−(survival rate)) for each treatment are shown below in Table 15 (corresponding to an unsaturated or saturated aliphatic acid and salt concentration of 500 ppm).

The observed survival rate in percent (equal to 1-(mortality rate in %)) was converted to observed treatment efficacies to take account of the background mortality in the untreated (water) control using the well-established Abbott Formula:

$$Observed Efficacy , W , of a treatment Y ( in \% ) = Wy = \frac{( X - Y )}{X} \times 100 ( min zero )$$

where X=survival rate of untreated control (%)
Y=survival rate of treatment Y (%)
per W. S. Abbott, A Method of Computing the Effectiveness of an Insecticide, Journal of Economic Entomology, Vol. 19, 1925, pp. 265-267.

The resulting Observed Efficacy of individual and combination treatments was used to evaluate the efficacy data in Table 15 for synergistic effects in the combination of spinosad (as Entrust® SC) and the exemplary unsaturated and saturated aliphatic acids (and salts), using the Colby Formula, per S. R. Colby, Calculating Synergistic and Antagonistic Responses of Herbicide Combinations, Weeds, Vol. 15, No. 1 (January 1967), as is well known in the agricultural experimental field for determining synergism between two or more compounds. In accordance with the Colby Formula, the expected efficacy, E (%), of a combination treatment of compounds A (spinosad) and B (unsaturated or saturated aliphatic acid or salt) in concentrations a and b, respectively, can be determined by evaluating:

E=x+y−(xy/100); where:

x=efficacy (%) of compound A alone, applied at concentration a;

y=efficacy (%) of compound B alone, applied at concentration b.

The existence and extent of synergy present in a combination treatment can be determined according to the Colby Formula by evaluating a Synergy Factor, SF=(Observed efficacy) W/(Expected efficacy) E.

For values of SF >1, synergistic efficacy is shown in the observed efficacy of the combination of compounds, with increasing synergy present as the SF increases above 1. While for SF<1, antagonism is present and for SF=1, the efficacy of the compounds is merely additive. Table 15 shows the Synergy Factor calculated according to the above Colby Formula for the observed insecticidal efficacy of each combination treatment between spinosad (as Entrust® SC) and the tested exemplary unsaturated or saturated aliphatic acids (and salts). As shown in Table 15, the combination of spinosad (as Entrust® SC) insecticide at 0.034 ppm (equivalent to 0.0019 ppm of spinosad as the insecticidal active ingredient) with exemplary unsaturated or saturated aliphatic acid (and salt) concentration of 500 ppm produced synergistic efficacy factors of between 1.17 to 3.0 times, relative to the Expected efficacy of the individual components assuming mere additivity, thus indicating strong evidence of the synergistic pesticidal efficacy of the below combinations, according to an embodiment of the invention.

TABLE 15
Expected and Observed Efficacy (%) of Entrust ® SC (Spinosad AI) at 0.034 ppm (0.0019 ppm
of spinosad) in combination with Unsaturated/Saturated Aliphatic Acid (salt) at 500 ppm

| | Observed | Expected | |
|---|---|---|---|
| | Efficacy, W | Efficacy, E | |
| Treatment | (%) | (%) | Synergy Factor (W/E) |
| Entrust ® SC @ 0.034 ppm (0.0019 | 27.3 | — | — |
| ppm spinosad) | | | |
| (2E,4E)-2,4 hexadienoic acid, K- | 9.1 | — | — |
| salt | | | |
| (2E,4E)-2,4 hexadienoic acid | 4.5 | — | — |
| Trans-2-hexenoic acid | 0 | — | — |
| Trans-3-hexenoic acid | 0 | — | — |
| Hexanoic acid | 27.3 | — | — |
| Octanoic acid | 4.5 | — | — |
| Octanoic acid, K-salt | 0 | — | — |
| Decanoic acid | 0 | — | — |
| Dodecanoic acid | 0 | — | — |
| 5-hexenoic acid | 0 | — | — |
| 7-octenoic acid | 0 | — | — |
| 3-heptanoic acid | 4.5 | — | — |
| Trans-2 nonenoic acid | 3.6 | — | — |
| 3-nonenoic acid | 9.1 | — | — |
| 3-octenoic acid | 0 | — | — |
| Trans-3 octenoic acid | 4.5 | — | — |
| Trans-2 decenoic acid | 0 | — | — |
| 3-decenoic acid | 0 | — | — |
| 9-decenoic acid | 4.5 | — | — |
| Trans-2 undecenoic acid | 27.3 | — | — |
| Heptanoic acid | 9.1 | — | — |
| Nonanoic acid | 0 | — | — |
| Entrust ® SC × (2E,4E)-2,4 | 40.9 | 33.9 | 1.21 |
| hexadienoic acid, K−salt | | | |
| Entrust ® SC × (2E,4E)-2,4 | 59.1 | 30.6 | 1.93 |
| hexadienoic acid | | | |
| Entrust ® SC × Trans-2-hexenoic | 40.9 | 27.3 | 1.50 |
| acid | | | |
| Entrust ® SC × Trans-3-hexenoic | 50.0 | 20.7 | 2.42 |
| acid | | | |
| Entrust ® SC × Hexanoic acid | 73.7 | 47.1 | 1.54 |
| Entrust ® SC × Octanoic acid | 63.6 | 30.6 | 2.08 |
| Entrust ® SC × Octanoic acid, K- | 31.8 | 27.3 | 1.17 |
| salt | | | |
| Entrust ® SC × Decanoic acid | 77.3 | 27.3 | 2.83 |
| Entrust ® SC × Dodecanoic acid | 40.9 | 27.3 | 1.50 |
| Entrust ® SC × 5-hexenoic acid | 40.9 | 27.3 | 1.50 |
| Entrust ® SC × 7-octenoic acid | 45.5 | 27.3 | 1.67 |
| Entrust ® SC × 3-heptanoic acid | 50.0 | 30.6 | 1.64 |
| Entrust ® SC × Trans-2 nonenoic | 77.3 | 27.3 | 2.83 |
| acid | | | |
| Entrust ® SC × 3-nonenoic acid | 81.8 | 33.9 | 2.41 |
| Entrust ® SC × 3-octenoic acid | 63.6 | 27.3 | 2.33 |
| Entrust ® SC × Trans-3 octenoic | 68.2 | 30.6 | 2.23 |
| acid | | | |
| Entrust ® SC × Trans-2 decenoic | 68.2 | 27.3 | 2.50 |
| acid | | | |
| Entrust ® SC × 3-decenoic acid | 77.3 | 27.3 | 2.83 |
| Entrust ® SC × 9-decenoic acid | 90.9 | 30.6 | 2.97 |
| Entrust ® SC × Trans-2 undecenoic | 95.5 | 47.1 | 2.03 |
| acid | | | |
| Entrust ® SC × Heptanoic acid | 72.7 | 33.9 | 2.15 |
| Entrust ® SC × Nonanoic acid | 81.8 | 27.3 | 3.00 |

### Example 5

In-planta insecticidal efficacy against Trichoplusia ni by chlorantraniliprole (active ingredient in Coragen® insecticide), in combination with several exemplary aliphatic acids

### Sample Preparation:

Chlorantraniliprole was provided as the active ingredient in Coragen® insecticide (available from FMC Corp., Philadelphia, Pa., USA), and is present as 18.4% w/w of the Coragen® insecticide product formulation. Coragen® product formulation was diluted in water to form a Coragen® stock solution of 0.00228 μL Coragen/mL water, or 2.28 ppm of the Coragen® formulation (and containing 0.420 ppm of the chlorantraniliprole active ingredient).

A stock solution was prepared for each of 10-hydroxydecanoic acid, 4-methylhexanoic acid, and 2-aminobutyric acid (sourced as disclosed in examples above), by dissolving each exemplary aliphatic acid (or salt thereof) in water, (or in 100% dimethylsulfoxide (DMSO) followed by dilution in water where water solubility limitations exist) to a stock concentration of 50000 ppm, followed by dilution with water to provide a working stock concentration of each aliphatic acid (or salt thereof) of 0.100% or 1000 ppm in the working stock solution.

Treatment solutions for each of Coragen®, and each exemplary aliphatic acid (or salt thereof), and each combination of Coragen® and exemplary aliphatic acid were prepared by diluting the Coragen® and exemplary aliphatic acid stock solutions in a 10% isopropanol solution in water, to provide acqueous treatment solutions comprising treatment concentrations of 0.57 ppm of Coragen® (comprising 0.105 ppm of chlorantraniliprole active ingredient), 750 ppm for each exemplary aliphatic acid, and 10% isopropanol as a wetting agent. Water and 10% isopropanol were tested as control treatments.

Green cabbage plants (Brassica oleracea var. capitate, Danish Ballhead cultivar) were grown from seed (available from West Coast Seeds, Delta, BC, Canada) in potting soil for 4-6 weeks in a pest-free indoor growing environment. At between 4-6 weeks of age, each cabbage plant was sprayed with 20 mL of treatment solution using a pressurized CO₂ sprayer from approximately 18 inches above the plant, and allowed to dry. After the treatment solution sprays had dried on the leaves of the cabbage plants, 5 neonate Trichoplusia ni (cabbage looper) larvae (hatched from eggs such as available from Benzon Research, Inc. of Carlisle, Pa., USA) were placed into a small fine mesh organza bag, which was then secured over each cabbage leaf to contain the 5 larvae on each leaf, and the treated and infested cabbage plants were then placed in a controlled indoor growing environment and the larvae were left to feed on the plants for 6 days, at which time the number of surviving larvae were observed and survival rates (%) were determined.

The aggregate results showing the insect survival rate (which is equal to (100%−(mortality rate)) for each treatment are shown below in Table 16 (for treatment concentrations of 0.57 ppm of Coragen® (comprising 0.104 ppm of chlorantraniliprole active ingredient) and 750 ppm for each exemplary aliphatic acid, and including 10% isopropanol as a wetting agent).

The observed survival rate in percent (also equivalent to 100-(mortality rate in %)) was converted to observed treatment efficacies to take account of the background mortality in the untreated 10% isopropanol control using the well-established Abbott Formula:

$$Observed Efficacy , W , of a treatment Y ( in \% ) = Wy = \frac{( X - Y )}{X} \times 100 ( min zero )$$

where X=survival rate of untreated control (%)
Y=survival rate of treatment Y (%)
per W. S. Abbott, A Method of Computing the Effectiveness of an Insecticide, Journal of Economic Entomology, Vol. 19, 1925, pp. 265-267.

The resulting Observed Efficacy of individual and combination treatments was used to evaluate the efficacy data in Table 16 for synergistic effects in the combination of chlorantraniliprole (as Coragen®) and the exemplary aliphatic acids, using the Colby Formula, per S. R. Colby, Calculating Synergistic and Antagonistic Responses of Herbicide Combinations, Weeds, Vol. 15, No. 1 (January 1967), as is well known in the agricultural experimental field for determining synergism between two or more compounds. In accordance with the Colby Formula, the expected efficacy, E (%), of a combination treatment of compounds A (chlorantraniliprole as Coragen®) and B (exemplary aliphatic acid) in concentrations a and b, respectively, can be determined by evaluating:

E=x+y−(xy/100); where:

x=efficacy (%) of compound A alone, applied at concentration a;

y=efficacy (%) of compound B alone, applied at concentration b.

The existence and extent of synergy present in a combination treatment can be determined according to the Colby Formula by evaluating a Synergy Factor, SF=(Observed efficacy) W/(Expected efficacy) E. For values of SF >1, synergistic efficacy is shown in the observed efficacy of the combination of compounds, with increasing synergy present as the SF increases above 1. While for SF<1, antagonism is present and for SF=1, the efficacy of the compounds is merely additive.

Table 16 shows the Synergy Factor calculated according to the above Colby Formula for the observed insecticidal efficacy of each combination treatment between chlorantraniliprole (as Coragen®) and the tested exemplary aliphatic acids. As shown in Table 16, the tested combinations of chlorantraniliprole (as Coragen®) insecticide and exemplary aliphatic acids produced synergistic efficacy factors of between 1.17 to 1.35 times, relative to the Expected efficacy of the individual components assuming mere additivity, thus indicating the synergistic pesticidal efficacy of the below combinations, according to an embodiment of the invention. In a further embodiment, it was also found that occurrence of leaf damage to the cabbage leaves caused by the feeding of the T. ni larvae during the above-described T. ni trials decreased in plants treated with combinations of chlorantraniliprole (as Coragen®) and the exemplary aliphatic acids which showed synergistic pesticidal efficacy, relative to plants treated with the spinosad pesticidal active or aliphatic acid individually. This similar synergistic result in the observed extent of leaf damage in combination treated plants relative to the expected additive damage in plants treated with the individual insecticide and aliphatic acid components, additionally supports the synergistic pesticidal efficacy of the exemplary insecticide and aliphatic acid combinations.

TABLE 16
Expected and Observed In-Planta Efficacy (%) of Coragen ® insecticide
(chlorantraniliprole active ingredient) at 0.57 ppm (0.104 ppm of chlorantraniliprole)
in combination with exemplary aliphatic acids at 750 ppm

| | Survival Rate | Observed | Expected | Synergy Factor |
|---|---|---|---|---|
| Treatment | (%) | Efficacy, W (%) | Efficacy, E (%) | (W/E) |
| 10% Isopropanol Control | 64.00 | — | — | — |
| Coragen ® @ 0.57 ppm (0.104 | 40.50 | 36.72 | — | — |
| ppm chlorantraniliprole) | | | | |
| 10-hydroxydecanoic acid (750 | 40.50 | 36.72 | — | — |
| ppm) | | | | |
| 4-methylhexanoic acid (750 | 62.50 | 2.34 | — | — |
| PPm) | | | | |
| 2-aminobutyric acid (750 ppm) | 58.50 | 8.59 | — | — |
| Coragen ® + 10-hydroxydecanoic | 19.00 | 70.31 | 59.95 | 1.17 |
| acid | | | | |
| Coragen ® + 4-methylhexanoic | 35.00 | 45.31 | 38.20 | 1.19 |
| acid | | | | |
| Coragen ® + 2-aminobutyric acid | 27.50 | 57.03 | 42.16 | 1.35 |

In some embodiments according to the present disclosure, and as illustrated in some exemplary embodiments in the above-described experimental examples, the combination of a C4-C10 unsaturated aliphatic acid (and agriculturally acceptable salts thereof in some particular embodiments) and a pesticidal active ingredient produces a synergistic pesticidal composition demonstrating or reasonably predicted to demonstrate a synergistic effect. That is, when used in combination, the C4-C10 unsaturated aliphatic acid and the pesticidal active ingredient have or are reasonably predicted to have an efficacy that is greater than would be expected by simply adding the efficacy of the pesticidal active ingredient and the C4-C10 unsaturated aliphatic acid when used alone. In some alternative embodiments, the unsaturated aliphatic acid or agriculturally acceptable salt thereof may comprise a C11 unsaturated aliphatic acid or agriculturally acceptable salt thereof. In some further alternative embodiments, the unsaturated aliphatic acid or agriculturally acceptable salt thereof may comprise a C12 unsaturated aliphatic acid or agriculturally acceptable salt thereof.

In some embodiments according to the present disclosure, and as illustrated in some exemplary embodiments in the above-described experimental examples, the combination of a C4-C10 saturated aliphatic acid (and agriculturally acceptable salts thereof in some particular embodiments) and a pesticidal active ingredient produces a synergistic pesticidal composition demonstrating a synergistic effect or reasonably predicted to demonstrate a synergistic effect. That is, when used in combination, the C4-C10 saturated aliphatic acid and the pesticidal active ingredient have or are predicted to have an efficacy that is greater than would be expected by simply adding the efficacy of the pesticidal active ingredient and the C4-C10 saturated aliphatic acid when used alone. In some particular embodiments, the combination of a C4-C10 saturated aliphatic acid and a neem seed, kernel, oil, extract or derivative pesticidal active ingredient produces a synergistic pesticidal composition demonstrating a synergistic pesticidal effect. In some further embodiments, the combination of a C11 or C12 saturated aliphatic acid and a neem seed, kernel, oil, extract or derivative pesticidal active ingredient produces a synergistic pesticidal composition demonstrating or reasonably predicted to demonstrate a synergistic pesticidal effect. In some alternative embodiments according to the present disclosure, the combination of a C11 or C12 saturated aliphatic acid (and agriculturally acceptable salts thereof in some particular embodiments) and a pesticidal active ingredient produces a synergistic pesticidal composition demonstrating a synergistic effect.

While a number of exemplary aspects and embodiments have been discussed above, those of skill in the art will recognize certain modifications, permutations, additions and sub-combinations thereof. It is therefore intended that the following appended claims and claims hereafter introduced are to be given the broadest interpretation consistent with the disclosure as a whole.

1. A pesticidal composition comprising a pesticidal complex, said complex comprising:
a pesticidal active ingredient; and
a C4-C10 saturated or unsaturated aliphatic acid or an agriculturally compatible salt thereof;
wherein a hydrogen bond exists between the pesticidal active ingredient and the C4-C10 saturated or unsaturated aliphatic acid to form the complex; and
wherein a ratio of the concentrations of said pesticidal active ingredient and said C4-C10 saturated or unsaturated aliphatic acid or an agriculturally compatible salt thereof is between about 1:15000 and 15000:1.

2. The pesticidal composition according to claim 1, wherein said pesticidal composition comprises a synergistic pesticidal composition, and said pesticidal complex comprises a synergistic pesticidal complex.

3. The synergistic pesticidal composition according to claim 2, wherein the pesticidal active ingredient comprises a strobilurin fungicide, and wherein the hydrogen bond exists between a carboxyl group of the aliphatic acid, and a carbonyl group of the strobilurin fungicide.

4. The synergistic pesticidal composition according to claim 2, wherein the pesticidal active ingredient comprises an azole fungicide, and wherein the hydrogen bond exists between a carboxyl group of the aliphatic acid, and a carbonyl or hydroxy group of the azole fungicide.

5. The synergistic pesticidal composition according to claim 2, wherein the pesticidal active ingredient comprises a pyrrole insecticide, and wherein the hydrogen bond exists between a carboxyl group of the aliphatic acid, and a N atom of the pyrrole insecticide.

6. The synergistic pesticidal composition according to claim 2, wherein the pesticidal active ingredient comprises a spinosyn insecticide, and wherein the hydrogen bond exists between a carboxyl group of the aliphatic acid, and at least one of an O and an N atom of the spinosyn insecticide.

7. The synergistic pesticidal composition according to claim 2, wherein the pesticidal active ingredient comprises a diamide insecticide, and wherein the hydrogen bond exists between a carboxyl group of the aliphatic acid and at least one of: an O atom and an amine H atom of the diamide insecticide.

8. The synergistic pesticidal composition according to claim 2, wherein the pesticidal active ingredient comprises a synthase inhibitor, and wherein the hydrogen bond exists between a carboxyl group of the aliphatic acid and at least one of: an O atom and a hydroxyl group of the synthase inhibitor.

9. The synergistic pesticidal composition according to claim 1, wherein the pesticidal active ingredient comprises least one nicotinic acetylcholine receptor disruptor or allosteric modulator.

10. The pesticidal composition according to claim 9, wherein the at least one nicotinic acetylcholine receptor disruptor or allosteric modulator comprises at least one of: a spinosyn and derivatives or substituents thereof, spinosad, a tetracyclic substituted spinosyn, a pentacyclic substituted spinosyn, an aziridine spinosyn derivative, a C-5,6 substituted spinosyn, a C-13,14 substituted spinosyn, a spinetoram, a butenyl-spinosyn, an isolate from Saccharopolyspora spinosa culture, and an isolate from Saccharopolyspora pogona culture.

11. The synergistic pesticidal composition according to claim 2, wherein the synergistic pesticidal composition has an FIC Index value of less than 1; or preferably less than 0.75, or more preferably less than 0.5.

12. The synergistic pesticidal composition according to claim 2, wherein the synergistic pesticidal composition has a synergistic efficacy factor, according to the Colby formula, of at least 1.1.

13. The synergistic pesticidal composition according to claim 2, wherein said composition exhibits a synergistic inhibition of growth of at least one target pest organism.

14. The synergistic pesticidal composition according to claim 2, wherein said composition comprises a pesticidally effective concentration of said pesticidal active ingredient and said C4-C10 saturated or unsaturated aliphatic acid or agriculturally compatible salt thereof.

15. The synergistic pesticidal composition according to claim 2, wherein said agriculturally compatible salt thereof comprises at least one of a potassium, sodium, calcium, aluminum and ammonium salt of a C4-C10 saturated or unsaturated aliphatic acid.

16. The synergistic pesticidal composition according to claim 2, wherein said synergistic pesticidal complex has a ¹H-NMR spectrum comprising a peak corresponding to a hydrogen atom of a constituent of the complex, the peak shifted to a lower frequency relative to a reference peak of a ¹H-NMR spectrum of the constituent when not in the complex, the reference peak also corresponding to the hydrogren atom, and the constituent comprising at least one of said pesticidal agent and said C4-C10 saturated or unsaturated aliphatic acid or an agriculturally compatible salt thereof.

17. The synergistic pesticidal composition according to claim 1, wherein said pesticidal active ingredient comprises at least one pesticidal active ingredient selected from the list comprising:
A) Respiration inhibitors selected from:
inhibitors of complex III at Qₒ site: azoxystrobin (II-1), coumethoxy-strobin, coumoxystrobin, dimoxystrobin (II-2), enestroburin, fenamin-strobin, fenoxystrobin/flufenoxystrobin, fluoxastrobin (II-3), kresoxim-methyl (II-4), metominostrobin, orysastrobin (II-5), picoxystrobin (II-6), pyraclostrobin (II-7), pyrame-tostrobin, pyraoxystrobin, trifloxystrobin (II-8), 2-[2-(2,5-dimethyl-phenoxymethyl)-phenyl]-3-methoxy-acrylic acid methyl ester and 2-(2-(3-(2,6-dichlorophenyl)-1-methyl-allylideneamino-oxymethyl)-phe-nyl)-2-methoxyimino-N-methyl-acetamide, pyribencarb, triclopyricarb/chlorodincarb, famoxadone, fenamidone;
Inhibitors of complex III at Qᵢ site: cyazofamid, amisulbrom, [(3S,6S,7R,8R)-8-benzyl-3-[(3-acetoxy-4-methoxy-pyridine-2-carbonyl)-amino]-6-methyl-4,9-dioxo-1,5-dioxonan-7-yl] 2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl] 2-methylpropanoate, [(3S,6S,7R,8R)-8-benzyl-3-[(3-isobutoxycarbony-loxy-4-methoxy-pyridine-2-carbonyl)amino]-6-methyl-4,9-dioxo-1,5-dioxonan-7-yl] 2-methylpro-panoate, [(3S,6S,7R,8R)-8-benzyl-3-[[3-(1,3-benzodioxol5-ylmethoxy)-4-methoxy-pyridine-2-carbon-yl]amino]-6-methyl-4,9-dioxo1,5-dioxonan-7-yl] 2-methylpropanoate; (3S,6S,7R,8R)-3-[[(3-hydroxy-4-methoxy-2-pyridinyl)carbonyl]amino]-6-methyl-4,9-dioxo-8-(phenyl-methyl)-1,5-dioxonan-7-yl 2-methylpropanoate;
Inhibitors of complex II: benodanil, benzovindiflupyr (II-9), bixafen (II-10), boscalid (II-11), carboxin, fenfuram, fluopyram (II-12), flutolanil, fluxapyroxad (II-13), furametpyr, isofetamid, isopyrazam (II-14), mepronil, oxycarboxin, penflufen (II-15), penthiopyrad (II-16), sedaxane (II-17), tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, 3-(difluorome-thyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 1,3,5-trimethyl-N-(1,1,3-trimethylindan-4-yl)pyrazole-4-carboxamide, N-(7-fluoro-1,1,3-trime-thyl-indan-4-yl)-1,3-dimethyl-pyrazole-4-carboxamide, N-[2-(2,4-dichlorophenyl)-2-methoxy-1-methyl-ethyl]-3-(difluoromethyl)-1-methyl-pyrazole-4-carboxamide;
Other respiration inhibitors: diflumetorim, (5,8-difluoroquinazolin-4-yl)-{2-[2-fluoro-4-(4-trifluorometh-ylpyridin-2-yloxy)-phenyl]-ethyl}-amine; binapacryl, dinobuton, dinocap, fluazinam (II-18); ferimzone; fentin salts such as fentin-acetate, fentin chloride or fentin hydroxide; ametoctradin (II-19); and silthiofam;
B) Sterol biosynthesis inhibitors (SBI fungicides) selected from:
C14 demethylase inhibitors (DMI fungicides): azaconazole, bitertanol, bromuconazole, cyproconazole (II-20), difenoconazole (II-21), diniconazole, diniconazole-M, epoxiconazole (II-22), fenbuconazole, fluquinconazole (II-23), flusilazole, flutriafol, hexaconazole, imibenconazole, ipconazole, metconazole (II-24), myclobutanil, oxpoconazole, paclobutrazole, penconazole, propiconazole (II-25), prothioconazole (II-26), simeconazole, tebuconazole (II-27), tetraconazole, triadimefon, triadimenol, triticonazole, uniconazole; imazalil, pefurazoate, prochloraz, triflumizol; fenarimol, nuarimol, pyrifenox, triforine, [3-(4-chloro-2-fluorophenyl)-5-(2,4-difluorophenyl)isoxazol-4-yl]-(3-pyridyl)methanol;
Delta14-reductase inhibitors: aldimorph, dodemorph, dodemorphacetate, fenpropimorph, tridemorph, fenpropidin, piperalin, spiroxamine;
Inhibitors of 3-keto reductase: fenhexamid;
C) Nucleic acid synthesis inhibitors selected from:
phenylamides or acyl amino acid fungicides: benalaxyl, benalaxyl-M, kiralaxyl, metalaxyl, metalaxyl-M (mefenoxam) (II-38), ofurace, oxadixyl;
others nucleic acid inhibitors: hymexazole, octhilinone, oxolinic acid, bupirimate, 5-fluorocytosine, 5-fluoro-2-(p-tolylmethoxy)pyrimidin-4-amine, 5-fluoro-2-(4-fluorophenylmethoxy)pyrimidin-4-amine;
D) Inhibitors of cell division and cytoskeleton selected from:
tubulin inhibitors: benomyl, carbendazim, fuberidazole, thiabendazole, thiophanate-methyl (11-39); 5-chloro-7-(4-methylpiperidin-1-yl)-6-(2,4,6-trifluorophenyl)-[1,2,4]triazolo[1,5-a]pyrimidine
other cell division inhibitors: diethofencarb, ethaboxam, pencycuron, fluopicolide, zoxamide, metrafenone (II-40), pyriofenone;
E) Inhibitors of amino acid and protein synthesis selected from:
methionine synthesis inhibitors (anilino-pyrimidines): cyprodinil, mepanipyrim, Pyrimethanil (II-41);
protein synthesis inhibitors: blasticidin-S, kasugamycin, kasugamycin hydrochloride-hydrate, mildiomycin, streptomycin, oxytetracyclin, polyoxine, validamycin A;
F) Signal transduction inhibitors selected from:
MAP/histidine kinase inhibitors: fluoroimid, iprodione, procymidone, vinclozolin, fenpiclonil, fludioxonil;
G protein inhibitors: quinoxyfen;
G) Lipid and membrane synthesis inhibitors selected from:
Phospholipid biosynthesis inhibitors: edifenphos, iprobenfos, pyrazophos, isoprothiolane; propamocarb, propamocarb-hydrochloride;
lipid peroxidation inhibitors: dicloran, quintozene, tecnazene, tolclofos-methyl, biphenyl, chloroneb, etridiazole;
phospholipid biosynthesis and cell wall deposition: dimethomorph (II-42), flumorph, mandipropamid (II-43), pyrimorph, benthiavalicarb, iprovalicarb, valifenalate, N-(1-(1-(4-cyano-phenyl)ethanesulfonyl)-but-2-yl) carbamic acid-(4-fluorophenyl) ester;
acid amide hydrolase inhibitors: oxathiapiprolin;
H) Inhibitors with Multi Site Action selected from:
inorganic active substances: Bordeaux mixture, copper acetate, copper hydroxide, copper oxychloride (II-44), basic copper sulfate, sulfur;
thio- and dithiocarbamates: ferbam, mancozeb (II-45), maneb, metam, metiram (II-46), propineb, thiram, zineb, ziram;
organochlorine compounds: anilazine, Chlorothalonil (II-47), captafol, captan, folpet, dichlofluanid, dichlorophen, hexachlorobenzene, pentachlorophenole and its salts, phthalide, tolylfluanid, N-(4-chlo-ro-2-nitro-phenyl)-N-ethyl-4-methyl-benzenesulfonamide;
guanidines and others: guanidine, dodine, dodine free base, guazatine, guazatine-acetate, iminoc-tadine, iminoctadine-triacetate, iminoctadine-tris(albesilate), dithianon, 2,6-dimethyl-1H,5H-[1,4]dithii-no[2,3-c:5,6-c′]dipyrrole-1,3,5,7(2H,6H)-tetraone (II-48);
I) Cell wall synthesis inhibitors selected from:
inhibitors of glucan synthesis: validamycin, polyoxin B;
melanin synthesis inhibitors: pyroquilon, tricyclazole, carpropamid, dicyclomet, fenoxanil;
J) Plant defence inducers selected from:
acibenzolar-S-methyl, probenazole, isotianil, tiadinil, prohexadione-calcium; fosetyl, fosetyl-aluminum, phosphorous acid and its salts (II-49);
K) Unknown mode of action selected from: bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxathiapiprolin, tolprocarb, 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, 2-[3,5-bis-(difluoromethyl)-1H-pyrazol-1-yl]-1-[4-(4-{5-[2-fluoro-6-(prop-2-yn-1-yl-oxy)phenyl]-4,5-dihydro-1,2-oxazol-3-yl}-1,3-thiazol-2-yl)piperidin-1-yl]-ethanone, 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, oxin-copper, proquinazid, tebufloquin, tecloftalam, triazoxide, 2-butoxy-6-iodo-3-propylchromen-4-one, N-(cyclo-propylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethylphenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, methoxyacetic acid 6-tert-butyl-8-fluoro-2,3-dimethyl-quinolin-4-yl ester, 3-[5-(4-meth-ylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl) cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phe-nyl)-isoxazol-5-yl]-2-prop2-ynyloxy-acetamide, ethyl (Z)-3-amino-2-cyano-3-phenyl-prop-2-enoate, tertbutyl N-[6-[[(Z)-[(1-methyltetrazol-5-yl)-phenyl-methylene]-amino]oxymethyl]-2-pyridyl]carbamate, pentyl N-[6-[[(Z)-[(1-methyltetrazol-5-yl)-phenyl-methylene]amino]oxymethyl]-2-pyridyl]carbamate, 2-[2-[(7,8-dif-luoro-2-methyl-3-quinolyl)oxy]-6-fluoro-phenyl]propan-2-ol, 2-[2-fluoro-6-[(8-fluoro-2-methyl-3-qui-nolyl)oxy]phenyl]propan-2-ol, 3-(5-fluoro-3,3,4,4-tetramethyl-3,4-dihydroisoquinolin-1-yl)quinoline, 3-(4,4-difluoro-3,3-dimethyl-3,4-dihydroisoquinolin-1-yl)quinoline, 3-(4,4,5-trifluoro-3,3-dimethyl-3,4-dihydroiso-quinolin-1-yl)quinoline;
L) Antifungal biopesticides selected from: Ampelomyces quisqualis, Aspergillus flavus, Aureobasidium pullulans, Bacillus pumilus (II-50), Bacillus subtilis (II-51), Bacillus subtilis var. amyloliquefaciens (II-52), Candida oleophila I-82, Candida saitoana, Clonostachys rosea F. catenulata, also named Gliocladium catenulatum, Coniothyrium minitans, Cryphonectria parasitica, Cryptococcus albidus, Metschnikowia fructicola, Microdochium dimerum, Phlebiopsis gigantea, Pseudozyma flocculosa, Pythium oligandrum DV74, Reynoutria sachlinensis, Talaromyces flavus V117b, Trichoderma asperellum SKT-1, T. atroviride LC52, T. harzianum T-22, T. harzianum TH 35, T. harzianum T-39; T. harzianum and T. viride, T. harzianum ICC012 and T. viride ICC080; T. polysporum and T. harzianum; T. stromaticum, T. virens GL-21, T. viride, T. viride TV1, Ulocladium oudemansii HRU3;
M) Growth regulators selected from: abscisic acid, amidochlor, ancymidol, 6-benzylaminopurine, brassino-lide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride) (II-54), naphthaleneacetic acid, N-6-benzyladenine, paclobutrazol, prohexadione (prohexadione-calcium, II-55), prohydrojasmon, thidiazuron, triapenthenol, tributyl phosphorotrithioate, 2,3,5-tri-iodobenzoic acid, trinex-apac-ethyl and uniconazole;
N) Herbicides selected from:
acetamides: acetochlor, alachlor, butachlor, dimethachlor, dimethenamid, flufenacet, mefenacet, me-tolachlor, metazachlor, napropamide, naproanilide, pethoxamid, pretilachlor, propachlor, thenylchlor;
amino acid derivatives: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
Bipyridyls: diquat, paraquat;
(thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen; -hydroxybenzonitriles: bomoxynil, dichlobenil, ioxynil;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlorprop, MCPA, MCPA-thioethyl, MCPB, Mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonyl ureas: amidosulfuron, azimsulfuron, bensulfuron, chlorimuronethyl, chlorsulfuron, cinosul-furon, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nico-sulfuron, oxasulfuron, primisulfuron, prosulfuron, pyrazosulfuron, rimsulfuron, sulfometuron, sulfosul-furon, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
triazines: ametryn, atrazine, cyanazine, dimethametryn, ethiozin, hexazinone, metamitron, metribuzin, prometryn, simazine, terbuthylazine, terbutryn, triaziflam;
ureas: chlorotoluron, daimuron, diuron, fluometuron, isoproturon, linuron, methabenzthiazuron, tebuthiuron;
other acetolactate synthase inhibitors: bispyribac-sodium, cloransulammethyl, diclosulam, florasulam, flucarbazone, flumetsulam, metosulam, ortho-sulfamuron, penoxsulam, propoxycarbazone, pyribam-benz-propyl, pyribenzoxim, pyriftalid, pyriminobac-methyl, pyrimisulfan, pyrithiobac, pyroxasulfone, py-roxsulam;
other herbicides: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethyl, chlorthal, cinmethylin, clomazone, cumyluron, cyprosulfa-mide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-3,6-dihydro-2H-pyrimidin-1-yl)-phenoxy]-pyri-din-2-yloxy)-acetic acid ethyl ester, 6-amino-5-chloro-2-cyclopropyl-pyrimidine-4-carboxylic acid methyl ester, 6-chloro-3-(2-cyclopropyl-6-methyl-phenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester;
O) Insecticides selected from:
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phos-phamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenox-ycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zetacypermethrin, deltamethrin, esfenvalerate, etofenprox, fenpropathrin, fen-valerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
insect growth regulators: a) chitin synthesis inhibitors: benzoylureas: chlorfluazuron, cyramazin, dif-lubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
nicotinic receptor agonists/antagonists compounds: clothianidin, dinotefuran, flupyradifurone, imidacloprid, thiamethoxam, nitenpyram, acetamiprid, thiacloprid, 1-2-chloro-thiazol-5-ylmethyl)-2-nitrimino-3,5-dimethyl-[1,3,5]triazinane;
nicotinic acetylcholine receptor disruptors or allosteric modulators (IRAC Goup 5): spinosyn (including but not limited to spinosyns A, D, B, C, E, F, G, H, J, and other spinosyn isolates from Saccharopolyspora spinosa culture), spinosad (comprising primarily spinosyns A and D), and derivatives or substituents thereof (including but not limited to tetracyclic and pentacyclic spinosyn derivatives, aziridine spinosyn derivatives, C-5,6 and/or C-13,14 substituted spinosyn derivatives); spinetoram (including but not limited to XDE-175-J, XDE-175-L or other O-ethyl substituted spinosyn derivatives); butenyl-spinosyn and derivatives or substituents thereof (such as isolates from Saccharopolyspora pogona culture);
bioinsecticides including but not limited to Bacillus thuriengiensis, Burkholderia spp, Beauveria bassiana, Metarhizium anisoptiae, Paecilomyces fumosoroseus, and baculoviruses (including but not limited to granuloviruses and nucleopolyhedroviruses);
GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
mitochondrial electron transport inhibitor (METI) I acaricides: fenazaquin, pyridaben, tebufenpyrad, tolfenpyrad, flufenerim;
METI II and III compounds: acequinocyl, fluacyprim, hydramethylnon;
Uncouplers: chlorfenapyr;
oxidative phosphorylation inhibitors: cyhexatin, diafenthiuron, fenbutatin oxide, propargite;
moulting disruptor compounds: cryomazine;
mixed function oxidase inhibitors: piperonyl butoxide;
sodium channel blockers: indoxacarb, metaflumizone;
ryanodine receptor inhibitors: chlorantraniliprole, cyantraniliprole, fluben-diamide, N-[4,6-dichloro-2-[(diethyl-lambda-4-sulfanylidene)carbamoyl]-phenyl]-2-(3-chloro-2-pyridyl)-5-(trifluoromethyl)pyra-zole-3-carboxamide; N-[4-chloro-2-[(diethyl-lambda-4-sulfanylidene)carbamoyl]-6-methyl-phenyl]-2-(3-chloro-2-pyridyl)-5-trifluoromethyl)pyrazole-3-carboxamide; N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-car-boxamide; N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide; N-[4,6-dichloro-2-[(diethyl-lambda-4-sulfanyli-dene)carbamoyl]-phenyl]-2-(3-chloro-2-pyridyl)-5-(difluoromethyl)pyrazole-3-carboxamide; N-[4,6-di-bromo-2-[(di-2-propyl-lambda-4-sulfanyl-idene)carbamoyl]-phenyl]-2-(3-chloro-2-pyridyl)-5-(trifluor-omethyl)pyrazole-3-carboxamide; N-[4-chloro-2-[(di-2-propyl-lambda-4-sulfanylidene)carbamoyl]-6-cyano-phenyl]-2-(3-chloro-2-pyridyl)-5-(trifluoromethyl)pyrazole-3-carboxamide; N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide;
others: benclothiaz, bifenazate, cartap, flonicamid, pyridalyl, pymetrozine, sulfur, thiocyclam, cy-enopyrafen, flupyrazofos, cyflumetofen, amidoflumet, imicyafos, bistrifluron, pyrifluquinazon, 1,1′-[(3S,4R,4aR,6S,6aS,12R,12aS,12bS)-4-[[(2-cyclopropylacetyl)oxy]-methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl] cyclopropaneacetic acid ester; fluensulfone, fluoroalkenyl thioethers; and
P) ribonucleic acid (RNA) and associated compounds including double-stranded RNA (dsRNA), microRNA (miRNA) and small interfering RNA (siRNA); bacteriophages.

18. A method of synergistically enhancing the pesticidal activity of at least one pesticidal active ingredient adapted to control at least one target pest organism comprising:
providing at least one pesticidal active ingredient active for said at least one target pest organism, selecting a synergistically effective concentration of at least one C4-C10 saturated or unsaturated aliphatic acid, or an agriculturally acceptable salt thereof, which is adapted to form a hydrogen bond with said at least one pesticidal active ingredient to form a synergistic pesticidal complex;
preparing a synergistic pesticidal composition comprising said synergistic pesticidal complex; and
applying said synergistic pesticidal composition in a pesticidally effective concentration to control said at least one target pest organism.

19.-30. (canceled)

31. A pesticidal composition comprising a synergistic pesticidal complex, said complex comprising:
one or more pesticidal agents; and
one or more saturated or unsaturated C4-C10 aliphatic acids or agriculturally compatible salts thereof which is adapted to form a hydrogen bond with said at least one pesticidal agent to form the synergistic pesticidal complex,
wherein said synergistic pesticidal complex produces a synergistic effect on the pesticidal activity of the pesticidal composition in comparison to the pesticidal activity of the pesticidal agent alone and are present in a respective synergistically active concentration ratio between about 1:15000 and 15000:1.

32. The pesticidal composition according to claim 31, wherein said synergistically active concentration ratio of said pesticidal agent and said C4-C10 saturated or unsaturated aliphatic acid or an agriculturally compatible salt thereof is between about at least one of: 1:15,000 and 15,000:1; 1:10,000 and 10,000:1, 1:5000 and 5000:1, 1:2500 and 2500:1, 1:1500 and 1500:1, 1:1000 and 1000:1, 1:750 and 750:1, 1:500 and 500:1, 1:400 and 400:1, 1:300 and 300:1, 1:250 and 250:1, 1:200 and 200:1, 1:150 and 150:1, 1:100 and 100:1, 1:90 and 90:1, 1:80 and 80:1, 1:70 and 70:1, 1:60 and 60:1, 1:50 and 50:1, 1:40 and 40:1, 1:30 and 30:1, 1:25 and 25:1, 1:20 and 20:1, 1:15 and 15:1, 1:10 and 10:1, 1:9 and 9:1, 1:8 and 8:1, 1:7 and 7:1, 1:6 and 6:1, 1:5 and 5:1, 1: and 4:1, 1:3 and 3:1, 1:2 and 2:1, 1:1.5 and 1.5:1, and 1.25 and 1.25:1.

33-36. (canceled)
